(19) United States
(12) Patent Application Publication
(10) Pub. No.: US 2006/0224547 A1
(43) Pub. Date: Oct. 5, 2006

(54) Efficient simulation system of quantum algorithm gates on classical computer based on fast algorithm

(76) Inventors: Sergey V. Ulyanov, Polo Didattico E Di Recerca Di Crema (DE); Sergey A. Panfilov, Polo Didattico E Di Recerca Di Crema (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/089,421

(22) Filed: Mar. 24, 2005

(51) Int. Cl. G06F 15/18

(52) U.S. Cl. 706/62

(57) ABSTRACT

An efficient simulation system of quantum algorithm gates for classical computers with a Von Neumann architecture is described. In one embodiment, a Quantum Algorithm is solved using an algorithmic-based approach, wherein matrix elements of the quantum gate are calculated on demand. In one embodiment, a problem-oriented approach to implementing Grover's algorithm is provided with a termination condition determined by observation of Shannon minimum entropy. In one embodiment, a Quantum Control Algorithm is solved by using a reduced number of quantum operations.

### BACKGROUND

1. Field of invention

The present invention relates to efficient simulation of quantum algorithms using classical computers with a Von Neumann architecture.

2. Description of the Related Art

Quantum algorithms (QA) hold great promise for solving many heretofore intractable problems where classical algorithms are inefficient. For example, quantum algorithms are particularly suited to factorization and/or searching problems where the computational complexity increases exponentially when using classical algorithms. Use of quantum algorithms on true quantum computers is, however, rare because there is currently no practical physical hardware implementation of a quantum computer. All quantum computers to date have been too primitive for practical use.

The difference between a classical algorithm and a QA lies in the way that the QA is coded in the structure of the quantum operators. The initial input to the QA is a quantum register loaded with a superposition of initial states. The output of the QA is a function of the problem being solved. In some sense, the QA is given a problem to analyze and the QA returns its qualitative property in quantitative form as an answer. Formally, the problems solved by a QA can be stated as follows:
Input: A function ƒ: [symbol] 0,1 [symbol] ⁿ→ [symbol] 0,1 [symbol] ^{m}
Problem: Find a certain property of ƒ

Thus, the QA studies some qualitative properties of a function. The core of any QA is a set of unitary quantum operators or quantum gates. A quantum gate is a unitary matrix with a particular structure related to the algorithm needed to solve the given problem. The size of this matrix grows exponentially with the number of inputs, making it difficult to simulate a QA with more than 30-35 inputs on a classical computer with a Von Neumann architecture because of the memory required and the computational complexity of dealing with such a large matrix.

### SUMMARY

The present invention solves these and other problems by providing an efficient simulation system of quantum algorithm gates and for classical Von Neumann computers. In one embodiment, a QA is solved using a matrix-based approach. In one embodiment, a QA is solved using an algorithmic-based approach wherein matrix elements of the quantum gate are calculated on demand. In one embodiment, a problem-oriented approach to implementing Grover's algorithm is provided with a termination condition determined by observation of Shannon entropy. In one embodiment, a QA is solved by using a reduced number of operators.

In one embodiment, at least some of the matrix elements of the QA gate are calculated as needed, thus avoiding the need to calculate and store the entire matrix. In this embodiment, the number of inputs that can be handled is affected by: (i) the exponential growth in the number of operations used to calculate the matrix elements; and (ii) the size of the state vector stored in the computer memory.

In one embodiment, the structure of the QA is used to provide an efficient algorithm. In Grover's QSA, the state vector always has one of the two different values: (i) one value corresponds to the probability amplitude of the answer; and (ii) the second value corresponds to the probability amplitude of the rest of the state vector. In one embodiment, two values are used to efficiently represent the floating-point numbers that simulate actual values of the probability amplitudes in the Grover's algorithm. For other QAs, more than two, but nevertheless a finite number of values will exist and such finiteness is used to provide an efficient algorithm.

In one embodiment, the QA is constructed or transformed such that entanglement and interference operators can by bypassed or simplified, and the result is computed based on superposition of the initial states (and deconstructive interference of final output patterns) representing the state of the designed schedule of control gains. In one embodiment, the Deutsch-Jozsa's algorithm, when entanglement is absent, is simulated by using pseudo-pure quantum states. In one embodiment, the Simon algorithm, when entanglement is absent, is simulated by using pseudo-pure quantum states. In one embodiment, an entanglement-free QA is used to optimize an intelligent control system.

### BRIEF DESCRIPTION OF THE FIGURES

FIG. 1 shows memory used versus the number of qubits in a MATLAB 6.0 simulation environment used for modeling quantum search algorithm.

FIG. 2 shows the time required to make a fixed number of iterations as a function of processor clock frequency on a computer with a Pentium III processor.

FIG. 3 shows a family of curves from FIG. 2 for 100 iterations.

FIGS. 4a and 4b show surface plots of the time required for a fixed number of iterations versus the number of qbits using processors of different internal frequency.

FIG. 5 shows a family of curves from FIG. 4 for 10 iterations.

FIG. 6 shows the time for one iteration of 11 qubits, including curves for computations only and computation plus virtual memory operations.

FIG. 7 shows the time for one iteration as a function of the number of qubits.

FIG. 8 shows comparisons of the memory needed for the Shor and Grover algorithms.

FIG. 9 shows the time required for a fixed number of iterations versus the number of qubits and versus the processor clock frequency.

FIG. 10 shows the time required for 10 iterations with different clock frequencies.

FIG. 11 shows the time required for one iteration as a function of the number of qubits.

FIG. 12 shows the time versus number of iterations and versus the number of qbits for the Shor and Grover algorithms.

FIG. 13 shows curves from FIG. 12 for 10 iterations.

FIG. 14 shows the spatial complexity of a quantum algorithm.

FIG. 15 shows the difference between two quantum algorithms due to demands on the processor front side bus.

FIG. 16 shows computational runtime differences between the Shor, Grover, and Deutch-Josza algorithms.

FIG. 17a shows a generalized representation of a QA as a set of sequentially-applied smaller quantum gates.

FIG. 17b shows an alternate representation of a QA.

FIG. 18a shows a quantum state vector set up to an initial value.

FIG. 18b shows the quantum state vector of FIG. 18a after the superposition operator is applied.

FIG. 18c shows the quantum state vector of FIG. 18b after the entanglement operation in Grover's algorithm

FIG. 18d shows the quantum state vector of FIG. 18c after application of the interference operation.

FIG. 19a shows the dynamics of Grover's QSA probabilities of the input state vector.

FIG. 19b shows the dynamics of Grover's QSA probabilities of the state vector after superposition and entanglement.

FIG. 19c shows the dynamics of Grover's QSA probabilities of the state vector after interference.

FIG. 20 shows the Shannon information entropy calculation for the Grover's algorithm with 5 inputs.

FIG. 21 shows spatial complexity of a Grover QA simulation.

FIG. 22 shows temporal complexity of Grover's QSA.

FIG. 23 shows Shannon entropy simulation of a QSA with 7-inputs.

FIG. 24a shows the superposition operator representation algorithm for Grover's QSA.

FIG. 24b shows an entanglement operator representation algorithm for Grover's QSA.

FIG. 24c shows an interference operator representation algorithm for Grover's QSA.

FIG. 24d shows an interference operator representation algorithm for Deutsch-Jozsa's QA.

FIG. 24e shows an entanglement operator representation algorithm for Simon's and Shor's QA.

FIG. 24f shows the superposition and interference operator representation algorithm for Simon's QA.

FIG. 24g shows an interference operator representation algorithm for Shor's QA.

FIG. 25 shows state vector representation algorithm for Grover's quantum search.

FIG. 26 shows a generalized schema of simulation for Grover's QSA.

FIG. 27 shows the superposition block for Grover's QSA.

FIG. 28a shows emulation of the entanglement operator application of Grover's QSA.

FIG. 28b shows emulation of interference operator application of Grover's QSA.

FIG. 28c shows the quantum step block for Grover's quantum search.

FIG. 29 shows the termination block for method 1.

FIG. 30 shows component B for the termination block.

FIG. 31a shows component PUSH for the termination block.

FIG. 31b shows component POP for the termination block.

FIG. 32 shows component C for the termination block.

FIG. 33 shows component D for the termination block.

FIG. 34 shows component E for the termination block.

FIG. 35 shows final measurement emulation.

FIG. 36 shows a generalized schema of simulation for Deutsch-Jozsa's QA.

FIG. 37 shows a quantum block HUD for Deutsch-Jozsa's QA.

FIG. 38 shows a generalized approach for QA simulation.

FIG. 39 shows query processing.

FIG. 40 shows a general structure of Quantum Soft Computing tools.

FIG. 41a is a block diagram of an intelligent nonlinear control system.

FIG. 41b shows a superposition of coefficient gains.

FIG. 42 shows the structure of the design process.

FIG. 43 shows robust KB design with a quantum algorithm.

FIG. 44a shows coefficient gains of a Q-PD controller.

FIG. 44b shows coefficient gains scheduled by a FC trained using Gaussian excitation.

FIG. 44c shows coefficient gains scheduled by a FC trained using non-Gaussian excitation.

FIG. 44d shows control object dynamics.

FIG. 45 shows simulation result of the FIG. 44b, under non-gaussian excitation.

FIG. 46 shows the addition of a new Hadamard operator, as example, between the oracle (entanglement) and the diffusion operators in Grover's QSA.

FIG. 47 shows the steps of QSA2.

FIG. 48 shows one embodiment if a circuit implementation using elementary gates. The probability of finding a solution varies according to the number of matches M≠0 in the superposition.

FIG. 49 shows the probability of success of the QSA1 and QSA2 algorithms after one iteration.

FIG. 50 shows the iterating version of the algorithm QSA1.

FIG. 51 shows the iterating version of the QSA2 algorithm.

FIG. 52 shows the probability of success of the iterative version of the QSA1 algorithm.

FIG. 53 shows the probability of success of the iterative version of the algorithm QSA1 after five iterations.

FIG. 54 shows the probability of success of the iterative version of the QSA2 algorithm.

FIG. 55 shows the probability of success of the iterative version of the QSA2 algorithm after five iterations.

FIG. 56a shows results from different approaches for simulation of Grover's QSA.

FIG. 56b shows results from different approaches for simulation of Deutsch-Jozsa's QA.

FIG. 56c shows results from different approaches for simulation of Simon's and Shor's quantum algorithms.

FIG. 57a shows the optimal number of iterations for different qubit numbers and corresponding Shannon entropy behavior of Grover's QSA simulation.

FIG. 57b shows results of Shannon entropy behavior for different qubit numbers (1-8) in Deutsch-Jozsa's QA.

FIG. 57c shows results of Shannon entropy behavior for different qubit numbers (1-8) in Simon's QA.

FIG. 57d shows results of Shannon entropy behavior for different qubit numbers (1-8) in Shor's QA.

FIG. 58 shows the optimal number of iterations for different database sizes.

FIG. 59 shows simulation results of problem oriented Grover QSA according to approach 4 with 1000 qubits.

FIG. 60 summarizes different approaches for QA simulation.

### DETAILED DESCRIPTION

The simplest technique for simulating a Quantum Algorithm (QA) is based on the direct representation of the quantum operators. This approach is stable and precise, but it requires allocation of operator's matrices in the computer's memory. Since the size of the operators grows exponentially, this approach is useful for simulation of QAs with a relatively small number of qubits (e.g., approximately 11 qubits on a typical desktop computer). Using this approach it is relatively simple to simulate the operation of a QA and to perform fidelity analysis.

In one embodiment, a more efficient fast quantum algorithm simulation technique is based on computing all or part of the operator matrices on an as-needed basis. Using this technique, it is possible to avoid storing all or part of the operator matrices. In this case, the number of qubits that can be simulated (e.g., the number of input qubits, or the number of qubits in the system state register) is affected by: (i) the exponential growth in the number of operations required to calculate the result of the matrix products; and (ii) the size of the state vector that is allocated in computer memory. In one embodiment, using this approach it is reasonable to simulate up to 19 or more qubits on typical desktop computer, and even more on a system with vector architecture.

Due to particularities of the memory addressing and access processes in a typical desktop computer (such as, for example, a Pentium-based Personal Computer), when the number of qubits is relatively small, the compute-on-demand approach tends to be faster than the direct storage approach. The compute-on-demand approach benefits from a study of the quantum operators, and their structure so that the matrix elements can be computed more efficiently.

The study portion of the compute-on-demand approach can, for some QAs lead to a problem-oriented approach based on the QA structure and state vector behavior. For example, in Grover's Quantum Search Algorithm (QSA), the state vector always has one of the two different values: (i) one value corresponds to the probability amplitude of the answer; and (ii) the second value corresponds to the probability amplitude of the rest of the state vector. Using this assumption, it is possible to configure the algorithm using these two different values, and to efficiently simulate Grover's QSA. In this case, the primary limit is a representation of the floating-point numbers used to simulate the actual values of the probability amplitudes. After the superposition operation, these probability amplitudes are very small

$$( \frac{1}{{2}^{n / 2}} ) .$$

Thus, it is possible to simulate Grover's QSA with this approach simulating 1024 qubits or more without termination condition calculation and up to 64 qubits or more with termination condition estimation based on Shannon entropy.

Other QAs do not necessarily reduce to just two values. For those algorithms that reduce to a finite number of values, the techniques used to simplify the Gover QSA can be used, but the maximum number of input qubits that can be simulated will tend to be smaller, because the probability amplitudes of other algorithms have relatively more complicated distributions. Introduction of an external excitation can decrease the possible number of qubits for some algorithms.

In some algorithms, the entanglement and interference operators can be bypassed (or simplified), and the output computed based only on a superposition of the initial states (and deconstructive interference of the final output patterns) representing the state of the designed schedule of control gains. For example, a particular case of Deutsch-Jozsa's and Simon algorithms can be made entanglement free by using pseudo-pure quantum states.

The disclosure that follows begins with a comparative analysis of the temporal complexity of several representative QAs. That analysis is followed by an introduction of the generalized approach in QA simulation and algorithmic representation of quantum operators. Subsequent portions describe the structure representation of the QAs applicable to low level programming on classical computer (PC), generalizations of the approaches and introduction of the general QA simulation tool based on fast problem-oriented QAs. The simulation techniques are then applied to a quantum control algorithm.

1. Spatio-Temporal Complexity of QA Simulation Based on the Full Matrix Approach

I. Spatio-Temporal Complexity of Grover's Quantum Algorithm

1.1. Introduction

Practical realization of quantum search algorithms on classical computers is limited by the available hardware resources. Well-known algorithmic estimations for the number database transactions required by the Grover search algorithm cannot be considered directly on von Neumann computers. Classical versions of QAs depend on the effectiveness and efficiency of the mathematical models used to simulate the quantum-mechanical operations.

Thus, it is useful to analyze quantum algorithms to determine, or at least estimate, time expenses, influence of processor clock frequency, memory requirements, and Shannon entropy behavior of the QA. Evaluating time expenses of the Grover QSA includes evaluating the number of oracle queries (temporal complexity) for a fixed number of iterations of the Grover's QSA as a function of the number of qubits. Evaluating the effect of the central processor clock time includes estimating the influence of the central processor frequency on the time required for making a fixed number of iterations. Runtime does not necessarily scale linearly with processor clock speed due to effects of memory access, cache access, processor wait states, processor pipelines, processor branch estimation, etc. The required physical memory size (spatial complexity) depends on the algorithm and the number of qubits. The Shannon entropy behavior provides insight into the number of iterations required to arrive at a solution, and thus provides insight into the temporal complexity of the QA. The understanding gained from examining the spatio-temproral complexity helps in understanding the computing resources needed to simulate a desired QA with a desired number of qubits.

1.2. Computational Examples

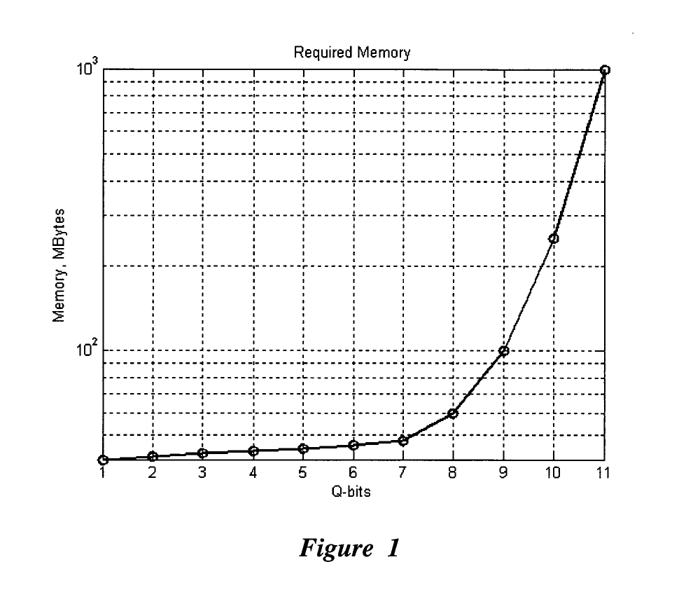

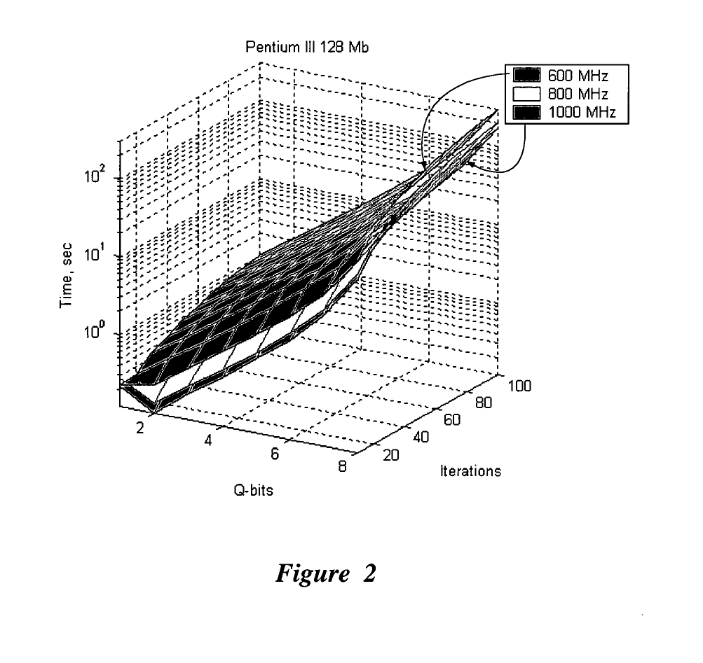

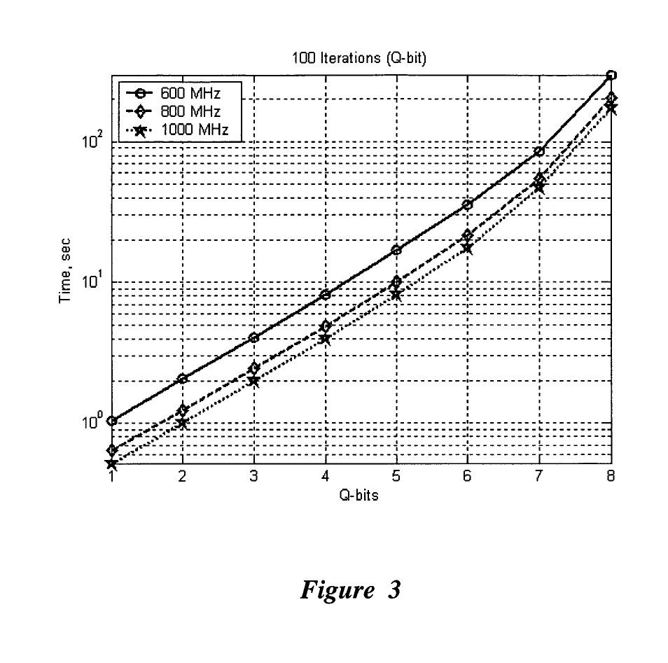

FIG. 1 shows the memory requirements versus number of qubits for a MATLAB 6.0 simulation environment used for modeling a QSA. FIG. 1 shows that 128 MB of memory allows simulation of up to 8 qubits (corresponding to 2⁸ elements in the database). FIG. 2 shows the time required to simulate Grover's QSA versus the number of qubits and versus the number of iterations on a Pentium III computer with 128 MB of main memory and processor clock frequencies of 600, 800, and 1000 MHz. FIG. 3 shows the influence of processor internal frequency on the time required for making 100 iterations (from FIG. 2). As shown in FIG. 3, the runtime does not scale linearly with processor speed.

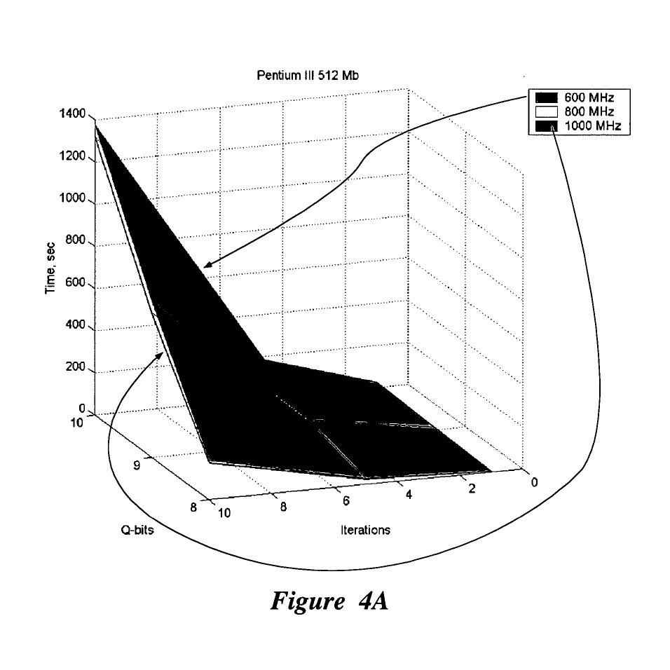

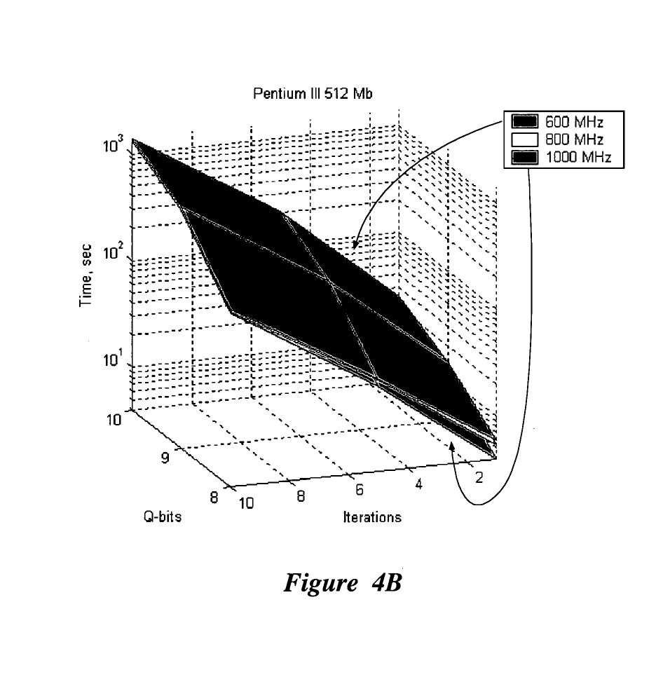

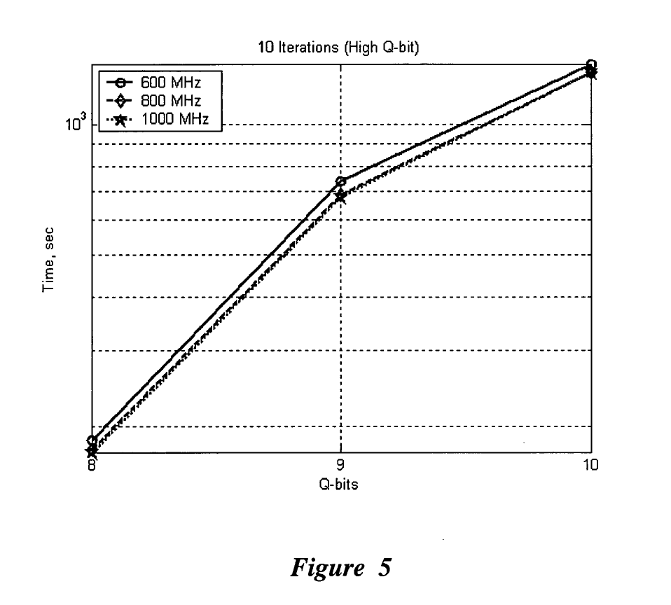

A linear increase of the number of qubits results in an exponential increase in the amount of memory required. In one embodiment, a computer with 512 MB of memory running MATLAB 6.0 is able to simulate 10 qubits before memory limitations begin to dominate. FIGS. 4 and 5 show runtime versus number of iterations and versus number of qubits (from 8 to 10) for the 512 MB hardware configuration.

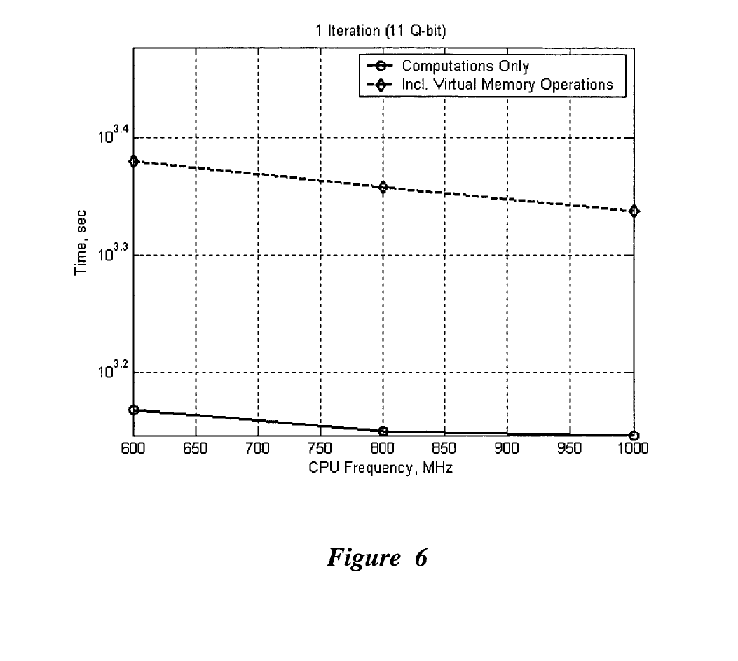

Once the computer physical memory is full, a further increase in the number of qubits causes virtual memory paging and performance degrades rapidly, as shown in FIG. 6. FIG. 6 shows time required for making one iteration of Grover's QSA for 11 qubits on a computer with 512 MB of physical memory—with and without virtual memory operations. As shown in the figure, the time required to perform virtual memory operations accounts for 50-70% of the time required to do calculations only.

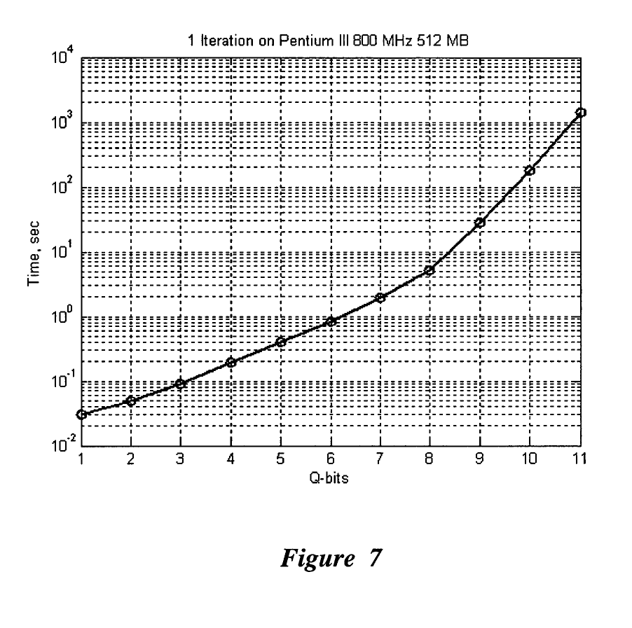

FIG. 7 shows the exponentially increasing time required for making one iteration versus the number of qubits (from 1 to 11) on a computer with 512 MB physical memory and an Intel Pentium III processor running at 800 MHz. Since the time required for making one iteration grows exponentially as the number of qubits increases, it is useful to determine the minimum number of iterations that guarantees a high probability of obtaining a correct answer.

The Shannon entropy can be considered as a criteria for solution of the QA-termination problem. Table 1.1 shows tabulated results of the number of qubits, Shannon entropy, and the number of iterations required.

TABLE 1.1

| Number of | Shannon | Number of |
|---|---|---|
| qubit | entropy | iterations |
| 1 | 2.0 | 1 |
| 2 | 1.0 | 2 |
| 3 | 1.00351 | 7 |
| 4 | 1.0965 | 10 |
| 4 | 1.00721 | 16 |
| 5 | 1.01362 | 5 |
| 6 | 1.05330 | 7 |
| 6 | 1.02879 | 32 |
| 7 | 1.07123 | 9 |
| 7 | 1.00021 | 27 |
| 8 | 1.00002 | 13 |
| 9 | 1.00024 | 18 |
| 10 | 1.00024 | 26 |

The timing results presented above are provided by way of explanation and for trend analysis, and not by way of limitation. Different programming systems would likely yield different absolute values for the measured quantities, but the trends would nevertheless remain. Thus, several observations can be drawn from the data shown in FIGS. 1-7. According to contemporary standards of personal computer hardware, QSAs can be adopted for relatively small databases (up to 2¹¹-2¹² elements). For a system with more than 2 qubits, the correct result calculation correlates with achieving a minimum value of Shannon entropy. Thus, the minimum number of iterations needed to achieve a desired accuracy can be estimated from the number of qubits.

II. Temporal complexity of Grover's quantum algorithm in comparison with Shor's QA

2.1. Introduction

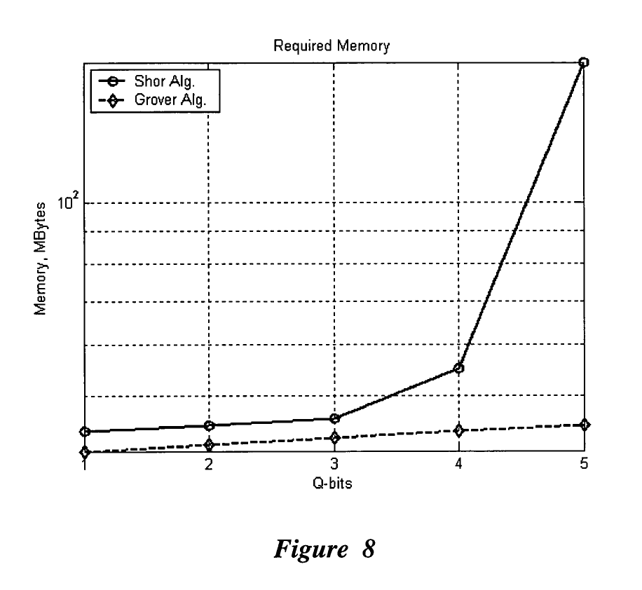

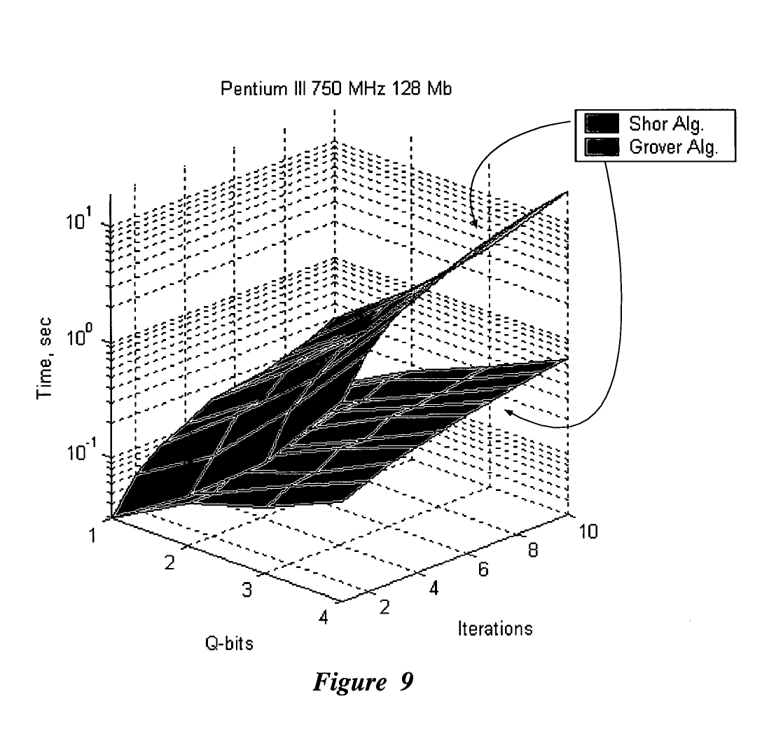

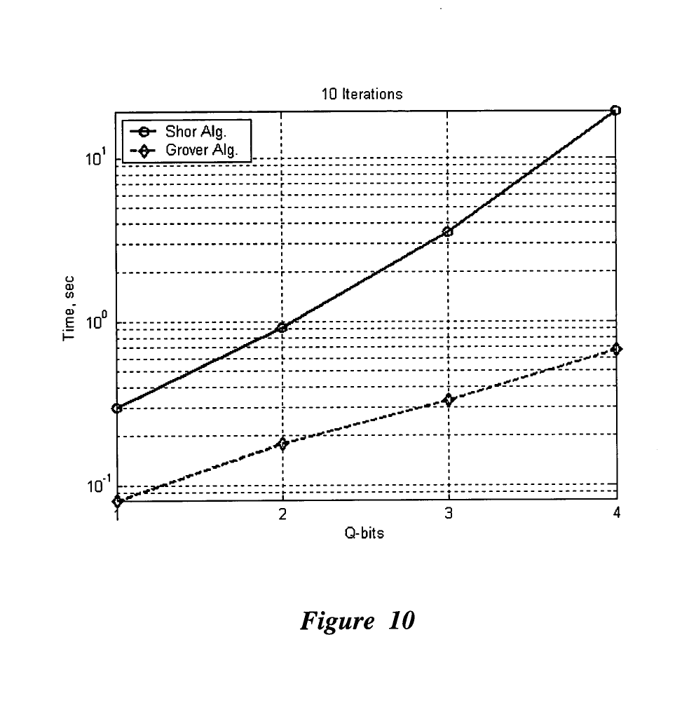

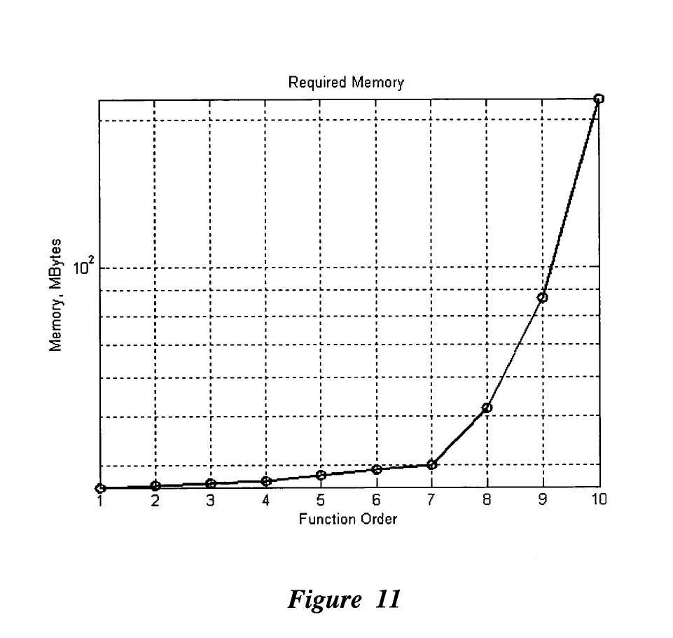

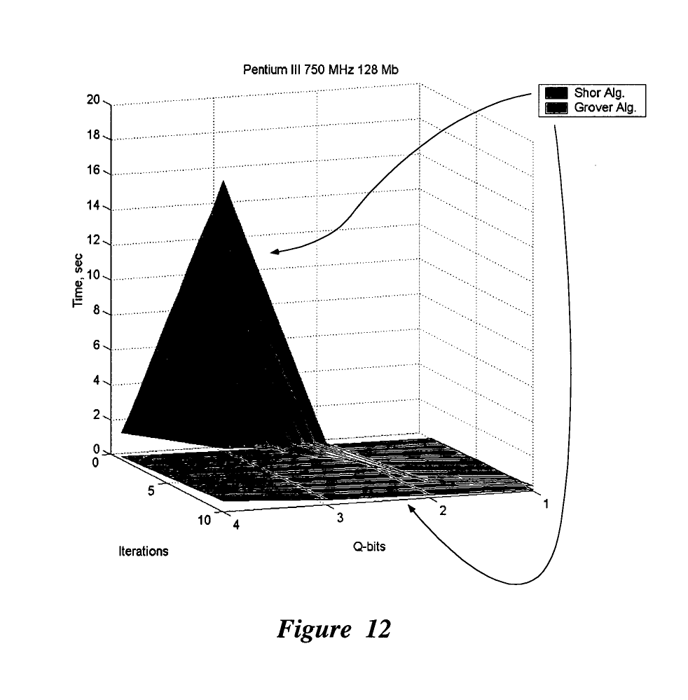

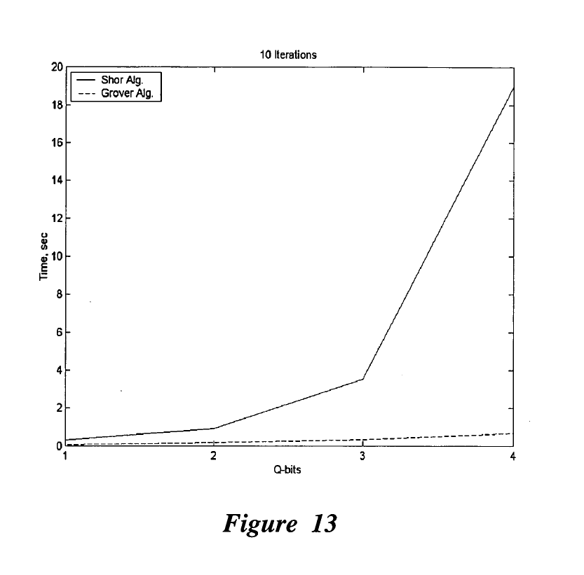

The results in FIGS. 1-7 were obtained by simulating Grover's QSA. FIG. 8 shows a comparison of the memory used by Shor's algorithm as compared to Grover's algorithm for 1 to 5 qubits. As shown in FIG. 8, Shor's algorithm requires considerably more memory. The qualitative properties of functions analyzed by Grover algorithm take Boolean values “true” and “false.” By contrast, Shor's algorithm analyzes functions that can take various values as input parameters. This fact inevitably leads to a considerable increase in the amount of memory required for a given number of qubits. For Shor's algorithm, directly simulating a system with 5 qubits is practical, but a simulation with 6 qubits becomes impractical because the memory requirements are increasing exponentially. FIG. 9 shows the time required to run Shor's algorithm and Grover's algorithm versus the number of qubits and the number of iterations. FIG. 10 corresponds to FIG. 9 where the number of iterations is fixed at 10. FIG. 11 shows an exponential increase in the time required for making one iteration as the number of qubits increases from 1 to 5. FIG. 12 and FIG. 13 shows comparisons of computer hardware requirements of Shor's and Grover's quantum algorithms concerning time of execution.

The comparative analysis of Shor's and Grover's quantum algorithms afforded by FIGS. 8-12 shows that maximum number of qubits that can be simulated in Shor's algorithm is relatively smaller than in Grover's algorithm (for direct simulation). Since realization of Shor's algorithm on classical computers is more demanding to hardware resources than realization of Grover's algorithm, appropriate hardware acceleration for practically significant applications is relatively more important for Shor's algorithm than for Grover's algorithm.

III. Comparative Temporal Complexity of Grover's QA, Shor's QA and Deutsch-Jozsa's QA

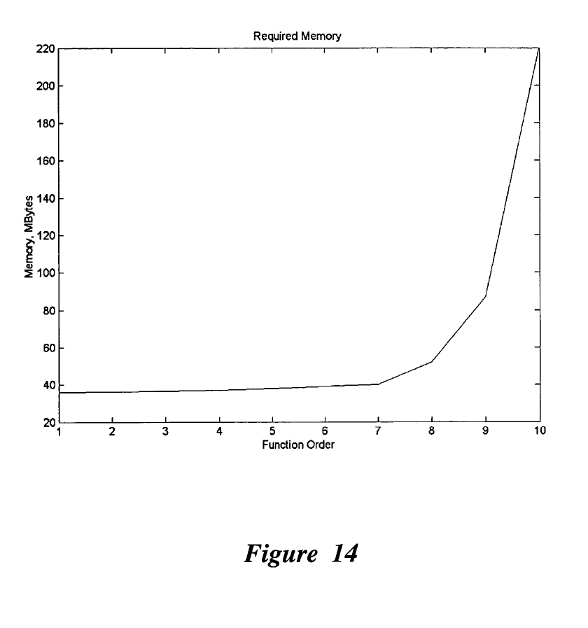

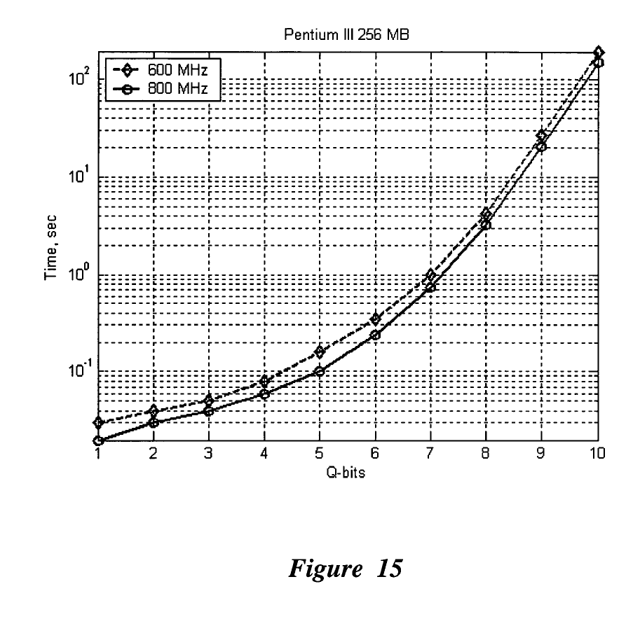

FIG. 14 shows the runtime needed for 10 iterations of the Shor and Grover algorithms on a representative computer versus the number of qubits. The exponential increase shown by Shor's algorithm is much faster than the time increase shown by Grover's algorithm. FIG. 15 shows how the frequency of the processor front side bus (FSB) on a Pentium III processor affects the time needed to make one iteration of a QA.

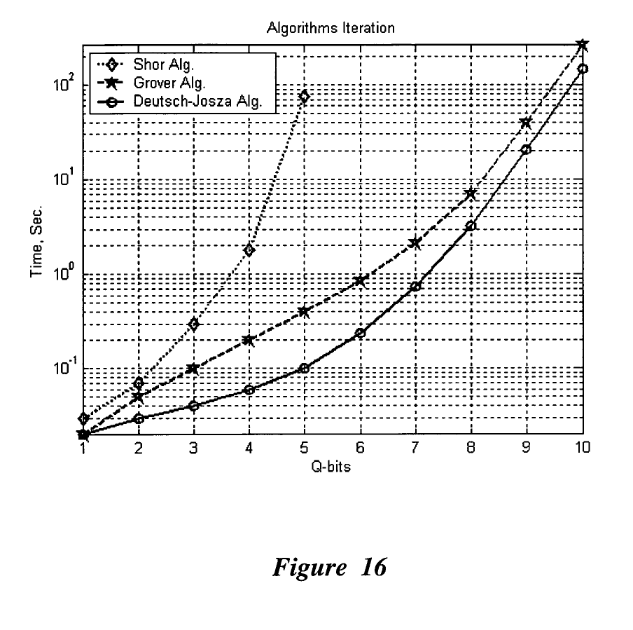

FIG. 16 shows the runtime differences between the Shor, Grover, and Deutsch-Josza quantum algorithms as a function of the number of qubits. As shown in FIG. 16, Shor's algorithm runs considerably slower than either the Grover or the Deutsch-Josza algorithms. This result arises from the structure of Shor's algorithm. In Shor's quantum algorithm, the number of qubits used for measurement is equal to the number of input qubits. This means that running a Shor's algorithm simulation for 5 qubits is the same as running a Grover's algorithm simulation with 9 qubits. Moreover, Shor's algorithm requires twice as much memory in order to store with complex numbers. As shown in FIG. 16, for the tested hardware and software realization of Deutsch-Jozsa algorithm, simulation of systems with more than 11 qubits becomes increasingly impractical.

IV. Information Analysis of Quantum Complexity of QAs: Quantum Query Tree Complexity

The existing QAs described above can be naturally expressed using a black-box model. It is then useful to consider the spatio-temporal complexity of QAs from the quantum query complexity viewpoint. For example, in the case of Simon's problem, one is given a function ƒ: [symbol] 0,1 [symbol] ⁿ→ [symbol] 0,1 [symbol] ⁿ and a promise that there is an s ε [symbol] 0,1 [symbol] ⁿ such that ƒ(i)=ƒ(j)iff i=j⊕s. The goal is to determine whether s=0 or not. Simon's QA yields an exponential speed-up over a classical algorithm. Simon's QA requires an expected number of O (n) applications of ƒ, whereas, every classical randomized algorithm for the same problem must make Ω(√\overline{2ⁿ}) queries.

The function ƒ can be viewed as a black-box X=(x₀, . . . , x_{N-1}) of N=2ⁿ bits, and that an ƒ-application can be simulated by n queries to X. Thus, Simon's problem fits squarely in the black-box setting, and exhibits an exponential quantum-classical separation for this promise-problem. The promise means that Simon's problem ƒ: [symbol] 0,1 [symbol] ⁿ→ [symbol] 0,1 [symbol] ⁿ is partial; i.e., it is not defined on all X ε [symbol] 0,1 [symbol] ⁿ but only on X that correspond to an X satisfying the promise.

Table 1.2 list the quantum complexity of various boolean functions such as OR, AND, PARITY, and MAJORITY

TABLE 1.2
Some quantum complexities

| Function | Exact | Zero-error | Bounde-error |
|---|---|---|---|
| OR_{N}, AND_{N} | N | N | $Θ ( \sqrt{N} )$ |
| PARITY_{N} | $\frac{N}{2}$ | $\frac{N}{2}$ | $\frac{N}{2}$ |
| MAJORITY_{N} | Θ(N) | Θ(N) | Θ(N) |

For example, consider the property OR_{N}(X)=x₀ ν . . . νx_{N-1}. The number of queries required to compute OR_{N}(X) by any classical (deterministic or randomized) algorithm is Θ(N). The lower bound for OR implies a lower bound for the search problem where it is desired to find an i, such that xᵢ=1, if such an i exists. Thus, an exact or zero-error QSA requires N queries, in contrast to Θ(√\overline{N}) queries for the bounded-error case. On the other hand, the number of solutions is r and a solution can be found with probability 1 using

$$O ( \sqrt{\frac{N}{k}} )$$

queries. Grover discovered a QSA that can be used to compute OR_{N} with small error probability using only O(√\overline{N}) queries. In this case of OR_{N}, the function is total; however, the quantum speed-up is only quadratic instead of exponential.

A similar result holds for the order-finding problem, which is the core of Shor's efficient quantum factoring algorithm. In this case, the promise is the periodicity of a certain function derived from the number to be factored.

A boolean function is a function ƒ: [symbol] 0,1 [symbol] ⁿ→ [symbol] 0,1 [symbol] . Note that ƒ is total, i.e., it is defined on all n-bit inputs. For an input x ε [symbol] 0,1 [symbol] ⁿ, xᵢ to denotes its i th bit, so x= [symbol] x₁ . . . xₙ [symbol] . The expression |x| is used to denote the Hamming weight of x (its number of 1's). A more general form of a Boolean function can be defined as ƒ: [symbol] 0,1 [symbol] ⁿ⊃A→B=ƒ(A)⊂ [symbol] 0,1 [symbol] ^{m}, for some integers n, m>0. If S is a set of (indices of) variables, then x^{s} denotes the input obtained by flipping the S-variables in x. The function ƒ is symmetric if ƒ(x) only depends on |x|. Some common symmetric functions are:

$$\begin{matrix}{OR}_{n} ( x ) = 1 iff \vert x \vert \geq 1 ; & ( i ) \\ {AND}_{n} ( x ) = 1 iff \vert x \vert = n ; & ( ii ) \\ {PARITY}_{n} ( x ) = 1 iff \vert x \vert is odd ; & ( iii ) \\ {MAJ}_{n} ( x ) = 1 iff \vert x \vert > \frac{n}{2} . & ( iv )\end{matrix}$$

The quantum oracle model is used to formalize a query to an input x ε [symbol] 0,1 [symbol] ⁿ as a unitary transformation O that maps |i, b, z> to |i, b⊕xᵢ, z> is most some m-qubit basis state, where i takes ┌log n┐ bits, b is one bit. The value z denotes the (m−┌log n┐−1)-bit “workspace” of the quantum computer, which is not affected by the query. Applying the operator O_{ƒ} twice is equivalent to applying the identity operator, and thus O_{ƒ} is unitary (and reversible) as required. The mapping changes the content of the second register (|b>) conditioned on the value of the first register |i>.

The queries are implemented using unitary transformations Oⱼ in the following standard way. The transformation Oⱼ only affects the leftmost part of a basis state: it maps basis state |i, b, z> to |i, b⊕xᵢ, z>. Note that the Oⱼ are all equal. This generalizes the classical setting where a query inputs an i into a black-box, which returns the bit xᵢ. Applying O to the basis state |i,0,z> yields |i,xᵢ,z>, from which the i th bit of the input can be read. Because O has to be unitary, it is specified to map |i,1,z> to |i,1−xᵢ,z>. Note that a quantum computer can make queries in superposition: applying O once to the state

$$\frac{1}{\sqrt{n}} {\sum }_{i = 1}^{n} \vert i , 0 , z 〉 gives \frac{1}{\sqrt{n}} {\sum }_{i = 1}^{n} \vert i , {x}_{i} , z 〉 ,$$

which in some sense contains all bits of the input.

A quantum decision tree has the following form: start with an m-qubit state |\vec{0}> where every bit is 0. Since it is desired to compute a function of X, which is given as a black-box, the initial state of the network is not very important and can be disregarded. Thus, the initial state is assumed to be |\vec{0}> always. Next, apply a unitary transformation U₀ to the state, then apply a query O, then another transformation U₁, etc. A T-query quantum decision tree thus, corresponds to a unitary transformation A=U_{T}OU_{T-1} . . . OU₁OU₀. Here the Uᵢ are fixed unitary transformations, independent of the input x. The final state A|\vec{0}> depends on the input x only via the T applications of O. The output obtained by measuring the final state and outputting the rightmost bit of the observed basis state. Without loss of generality, it can be assumed that there are no intermediate measurements.

A quantum decision tree is said to compute ƒ exactly if the output equals ƒ(x) with probability 1, for all x ε [symbol] 0,1 [symbol] ⁿ. The tree computes ƒ with bounded-error if the output equals ƒ(x) with probability at least

$$\frac{2}{3} ,$$

for all x ε [symbol] 0,1 [symbol] ⁿ.

The function Q_{E} (ƒ) denotes the number of queries of an optimal quantum decision tree that computes ƒ exactly, Q₂ (ƒ) is the number of queries of an optimal quantum decision tree that computes ƒ with bounded-error. Note that the number of queries is counted, not the complexity of the Uᵢ.

Unlike the classical deterministic or randomized decision trees, the QAs are not necessarily trees anymore (the names “quantum query algorithm” or “quantum black-box algorithm” can also be used). Nevertheless, the term “quantum decision tree” is useful, because such QAs generalize classical trees in the sense that they can simulate them as described below.

Consider a T-query deterministic decision tree. It first determines which variable it will query first; then it determines the next query depending upon its history, and so on for T queries. Eventually, it outputs an output-bit depending on its total history. The basis states of the corresponding QA have the form |i, b, h, a>, where i, b is the query-part, h ranges over all possible histories of the classical computation (this history includes all previous queries and their answers), and a is the rightmost qubit, which will eventually contain the output. Let U,map the initial state |\vec{0},0,\vec{0},0> to |i,0,\vec{0},0>, and xᵢ is the first variable that classical tree would query. Now, the QA applies O, which turns the state into |i, xᵢ,\vec{0},0>. Then the algorithm applies a transformation U₁ that maps |i, xᵢ,\vec{0},0> to |j,0,h,0), where h is the new history (which includes i and xᵢ) and xⱼ is the variable that the classical tree would query given the outcome of the previous query. Then when the quantum tree applies O for the second time, it applies a transformation U₂ that updates the workspace and determines the next query, etc. Finally, after T queries, the quantum tree sets the answer bit to 0 or 1 depending on its total history. All operations Uᵢ performed here are injective mappings from basis states to basis states, hence they be extended to permutations of basis states, which are unitary transformations. Thus a T-query deterministic decision tree can be simulated by an exact a T-query quantum decision tree with the same error probability (basically because a superposition can “simulate” a probability distribution). Accordingly,
Q₂(ƒ)≦R₂(ƒ)≦D(ƒ)≦n and Q₂(ƒ)≦Q_{E}(ƒ)≦D(ƒ)≦n for all ƒ.

If ƒ is non-constant and symmetric, then
D(ƒ)=(1−o(1))n; (i)
R₂(ƒ)=Θ(n); (ii)
Q_{E}(ƒ)=Θ(n); (iii)
Q₂(ƒ)=Θ(√{overscore (n(n−Γ(ƒ)))}), (iv)
where Γ(ƒ)=min [symbol] |2k−n+1|:ƒₖ≠ƒₖ₊₁ [symbol] is quantity measure of length of the interval around hamming weight

$$\frac{n}{2}$$

where ƒₖ is constant. The function ƒ flips value if the hamming weight of the input changes from k to k+1 (this Γ(ƒ) is a number that is low if ƒ flips for inputs with hamming weight close to

$$\frac{n}{2} ) .$$

This can be compared with the classical bounded-error query complexity of such functions, which is Θ(n). Thus, Γ(ƒ) characterizes the speed-up that QAs give for all total functions.

Unlike classical decision trees, a quantum decision tree algorithm can make queries in a quantum superposition, and therefore, may be intrinsically faster than any classical algorithm. The quantum decision tree model can also be referred to as the quantum black-box model.

Let Q(ƒ) be the quantum decision tree complexity of ƒ with error-bounded probability by

$$\frac{1}{3} .$$

It is possible to derive a general lower bound for Q(ƒ) in terms of Shannon entropy S^{Sh} (ƒ) defined as follows. For any ƒ, define the entropy of ƒ, S^{Sh}(ƒ), to be the Shannon entropy of ƒ(X), where X is taken uniformly random from A:

$${S}^{Sh} ( f ) = - {\sum }_{y ∈ B} {p}_{y} {log}_{2} {p}_{y} ,$$

where p_{y}=Pr_{xε}_{_{R}}_{A}[ƒ(x)=y]. For any ƒ,

$$Q ( f ) = Ω ( \frac{{S}^{Sh} ( f )}{log n} ) . \qquad ( 1 \text{.} 1 )$$

In this case, the computation process can be viewed as a process of communication. To make a query, the algorithm sends the oracle ┌log n┐ bits, which are then returned by the oracle. The first ┌log n┐ bits specify the location of the input bit being queried and the remaining one bit allows the oracle to write down the answer. The QA runs on

$$\frac{1}{\sqrt{\vert A \vert}} {\sum }_{x ∈ A} {\vert x 〉}_{X} {\vert y 〉}_{Y} ,$$

where X(Y) denotes the qubits that hold the input (intermediate results of computing), respectively. It is useful to now consider the von Neumann entropy, S^{vN(t)}(ƒ), of the density matrix ρ_{Y} after t th query. If the QA computes ƒ in T queries, at the end of computation, one expect to have a vector close to

$${{\frac{1}{\sqrt{\vert A \vert}} {\sum }_{x ∈ A} \vert x 〉}_{X} \vert f ( x ) 〉}_{Y} .$$

For the initial (pure) state, S^{vN(0)}(ƒ)=0. By using Holevo's theorem, one can show that S^{vN(T)}(ƒ)≈S^{Sh}(ƒ). Furthermore, by the sub-additivity of the von Neumann entropy
|S^{vN(t+1)}(ƒ)−S^{vN(t)}(ƒ)|=O(log n) for any t with 0≦t≦T−1 .

Therefore,

$$T = Ω ( \frac{{S}^{Sh} ( f )}{log n} ) .$$

This bound is tight.

This means one quantum query can get log n bits of information, while any classical query get no more than 1 bit of information. This power of getting ω(1) bits of information from a query is not useful in computing total functions, which are functions that are defined on every string in [symbol] 0,1 [symbol] ⁿ, in the sense that each quantum query can only yield O(1) bits of information on average.

For this more general case, for any total function ƒ,
Q(ƒ)=Ω(S^{Sh}(ƒ)). (1.2)

Thus, the minimum of Shannon entropy in the final solution output of the QA means its has minimal quantum query complexity. The interrelations in Eqs (1.1) and (1.2) between quantum query complexity and Shannon entropy are used in the solution of QA-termination problem (see below in Section 3). As mentioned above, the number of queries is counted, not the complexity of the Uᵢ. The complexity of a quantum operator Uᵢ and its interrelations with the temporal complexity of a QA is considered below.

The matrix-based approach can be efficiently realized for a small number of input qubits. The matrix approach is used above as a useful tool to illustrate complexity issues associated with QA simulation on classical computer.

2. Algorithmic Representation of the Quantum Operators and Quantum Algorithms

2.1. Structure of QA Gate System Design

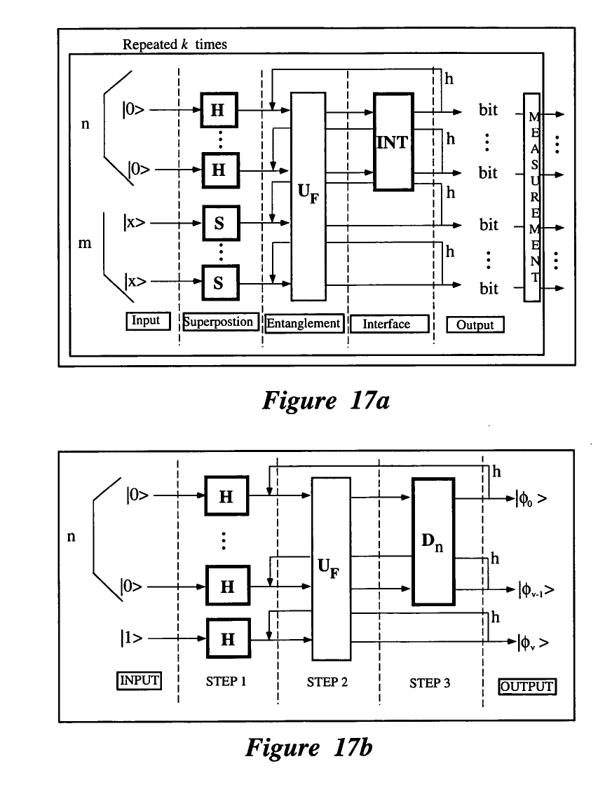

As shown in FIG. 17a, a QA simulation can be represented as a generalized representation of a QA as a set of sequentially-applied smaller quantum gates. From the structural point of view, each QA is based on a particular set of quantum gates, but generally speaking, each particular set can be divided into superposition operators, entanglement operators, and interference operators.

This division into superposition operators, entanglement operators, and interference operators permits a generalization of the design of a simulation and allows creation of a classical tool to simulate QAs. Moreover, local optimization of QA components according to specific hardware realization makes it possible to develop appropriate hardware accelerators for QA simulation using classical gates.

2.2. Generalized Approach in QA Simulation

In general, any QA can be represented as a circuit of smaller quantum gates as shown in FIGS. 17a-b. The circuit shown in the FIG. 17a is divided into five general layers: input, superposition, entanglement, interference, output.

Layer 1: Input. The quantum state vector is set up to an initial value for this concrete algorithm. For example, input for Grover's QSA is a quantum state |φ₀> described as a tensor product

$$\begin{matrix}\begin{matrix}\vert {ϕ}_{0} 〉 = {a}_{1} \vert 0 〉 ⊗ … ⊗ \vert 0 〉 ⊗ \vert 0 〉 + {a}_{2} \vert 0 〉 ⊗ … ⊗ \vert 0 〉 ⊗ \vert 1 〉 + \\ {a}_{3} \vert 0 〉 ⊗ … ⊗ \vert 1 〉 ⊗ \vert 0 〉 + … + {a}_{n} \vert 1 〉 ⊗ … ⊗ \vert 1 〉 ⊗ \vert 1 〉 \\ = 1 \vert 0 〉 ⊗ … ⊗ \vert 0 〉 ⊗ \vert 1 〉 \\ = \vert 0 …01 〉 ,\end{matrix} & ( 2.1 ) \\ where \vert 0 〉 = ( \begin{matrix}1 \\ 0\end{matrix} ) ; \vert 1 〉 = ( \begin{matrix}0 \\ 1\end{matrix} ) ; & \end{matrix}$$

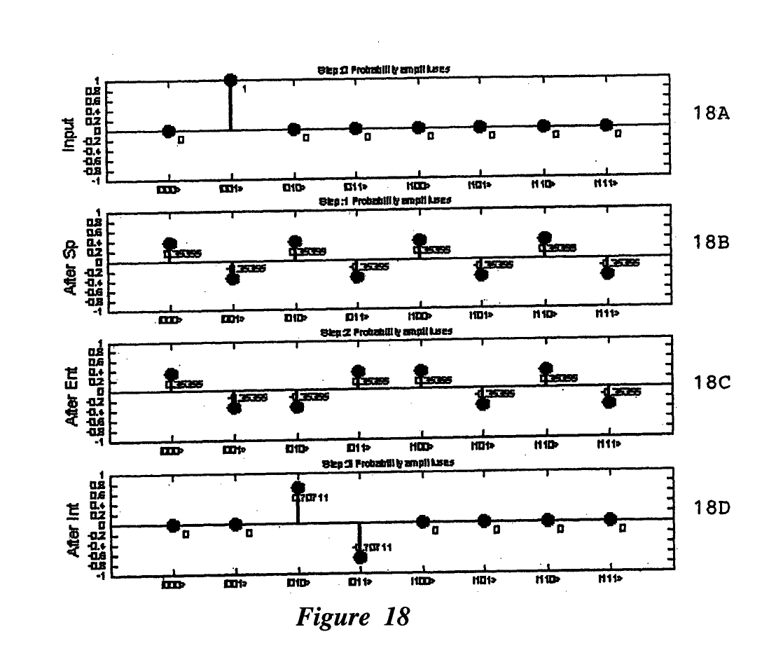

\textcircled{×} denotes Kronecker tensor product operation. Such a quantum state can be presented as shown on the FIG. 18a.

The coefficients aᵢ in the Eq. (2.1) are called probability amplitudes. Probability amplitudes can take negative and/or complex values. However, the probability amplitudes must obey the following constraint:

$${\sum }_{i} {a}_{i}^{2} = 1 \qquad ( 2.2 )$$

The actual probability of the arbitrary quantum state aᵢ |i> to be measured is calculated as a square of its probability amplitude value pᵢ=|aᵢ|².

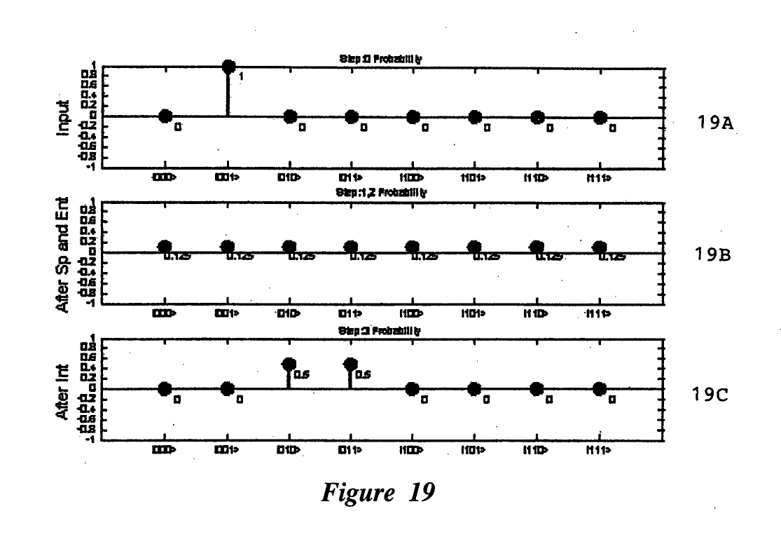

Layer 2: Superposition. The state of the quantum state vector is transformed by the Walsh-Hadamard operator so that probabilities are distributed uniformly among all basis states. The result of the superposition layer of Grover's QSA is shown in FIG. 18b as a probability amplitude representation, and also in FIG. 19b as a probability representation.

Layer 3: Entanglement. Probability amplitudes of the basis vector corresponding to the current problem are flipped while rest basis vectors left unchanged. Entanglement is typically provided by controlled-NOT (CNOT) operations. FIGS. 18c and 19c show results of entanglement from the application of the operator to the state vector after superposition operation. An entanglement operation does not affect the probability of the state vector to be measured. Rather, entanglement prepares a state, which cannot be represented as a tensor product of simpler state vectors. For example, consider state φ₁ shown in the FIG. 18b and state φ₂ presented on the FIG. 18c:

$$\begin{matrix}{ϕ}_{1} = 0.35355 ( \vert 000 〉 - \vert 001 〉 + \vert 010 〉 - \vert 011 〉 + \vert 100 〉 - \vert 101 〉 + \\ \vert 110 〉 - \vert 111 〉 ) \\ = 0.35355 ( \vert 00 〉 + \vert 01 〉 + \vert 10 〉 \vert 11 〉 ) ( \vert 0 〉 - \vert 1 〉 )\end{matrix}$$

$$\begin{matrix}{ϕ}_{2} = 0.35355 ( \vert 000 〉 - \vert 001 〉 - \vert 010 〉 + \vert 011 〉 + \vert 100 〉 - \vert 101 〉 + \\ \vert 110 〉 - \vert 111 〉 ) \\ = 0.35355 ( \vert 00 〉 - \vert 01 〉 + \vert 10 〉 + \vert 11 〉 ) \vert 0 〉 - 0.35355 ( \vert 00 〉 + \\ \vert 01 〉 + \vert 10 〉 + \vert 11 〉 ) \vert 1 〉\end{matrix}$$

As shown above, the description of state φ₁ can be presented as a tensor product of simpler states, while state φ₂ (in the measurement basis [symbol] |0>,|1 [symbol] ) cannot.

Layer 4: Interference. Probability amplitudes are inverted about the average value. As a result, the probability amplitude of states “marked” by entanglement operation will increase. FIGS. 18d and 19d show the results of interference operator application. FIG. 18d shows probability amplitudes and FIG. 19d shows probabilities.

Layer 5: Output. The output layer provides the measurement operation (extraction of the state with maximum probability), followed by interpretation of the result. For example, in the case of Grover's QSA, the required index is coded in the first n bits of the measured basis vector.

Since the various layer of the QA are realized by unitary quantum operators, simulation of quantum operators depend on simulation of such unitary operators. Thus, in order to develop an efficient, simulation, it is useful to understand the nature of the QAs basic quantum operators.

2.3. Basic QA Operators

The superposition, entanglement and interference operators are now considered from the simulation viewpoint. In this case, the superposition operators and the interference operators have more complicated structure and differ from algorithm to algorithm. Thus, it is first useful to consider the entanglement operators, since they have a similar structure for all QAs, and differ only by the function being analyzed.

In general, the superposition operator is based on the combination of the tensor products Hadamard H operators

$$H = \frac{1}{\sqrt{2}} [ \begin{matrix}1 & 1 \\ 1 & - 1\end{matrix} ]$$

with identity operator I:

$$I = [ \begin{matrix}1 & 0 \\ 0 & 1\end{matrix} ] .$$

For most QAs the superposition operator can be expressed as

$$Sp = ( {{⊗}^{n}}_{i = 1} H ) ⊗ ( {{⊗}^{m}}_{i = 1} S ) , \qquad ( 2.3 )$$

where n and m are the numbers of inputs and of outputs respectively. The operator S depends on the algorithm and can be either the Hadamard operator H or the identity operator I. The numbers of outputs m as well as structures of the corresponding superposition and interference operators are presented in Table 2.1 for different QAs.

TABLE 2.1
Parameters of superposition and interference operators
of main quantum algorithms

| Algorithm | Superposition | m | Interference |
|---|---|---|---|
| Deutsch's | H [symbol] I | 1 | H [symbol] H |
| Deutsch- | ⁿH [symbol] H | 1 | ⁿH [symbol] I |
| Jozsa's | | | |
| Grover's | ⁿH [symbol] H | 1 | Dₙ [symbol] I |
| Simon's | ⁿH [symbol] ⁿI | n | ⁿH [symbol] ⁿI |
| Shor's | ⁿH [symbol] ⁿI | n | QFTₙ [symbol] ⁿI |

Superposition and interference operators are often constructed as tensor powers of the Hadamard operator, which is called the Walsh-Hadamard operator. Elements of the Walsh-Hadamard operator can be obtained as

$${[ {}^{n} H ]}_{i , j} = \frac{{( - 1 )}^{i * j}}{{2}^{n / 2}} [ {}^{n - 1} H ] = \frac{1}{{2}^{n / 2}} ( \begin{matrix}{}^{( n - 1 )} H & {}^{( n - 1 )} H \\ {}^{( n - 1 )} H & - {}^{( n - 1 )} H\end{matrix} ) , \qquad ( 2.4 )$$

where i=0,1, j=0,1, H denotes Hadamard matrix of ordder 2.

The rule in Eq. (2.4) provides way to speed up of the classical simulation of the Walsh-Hadamard operators, because the elements of the operator can be obtained by the simple replication described in Eq. (2.4) from the elements of the ⁿ⁻¹H order operator. For example, consider the superposition operator of Deutsch's algorithm, n=1, m=1, S=I:

$$\begin{matrix}{[ Sp ]}_{i , j}^{Deutsch} = \frac{{( - 1 )}^{i * j}}{{2}^{1 / 2}} ⊗ I \\ = \frac{1}{\sqrt{2}} ( \begin{matrix}{( - 1 )}^{0 * 0} I & {( - 1 )}^{0 * 1} I \\ {( - 1 )}^{1 * 0} I & {( - 1 )}^{1 * 1} I\end{matrix} ) \\ = \frac{1}{\sqrt{2}} [ \begin{matrix}I & I \\ I & - I\end{matrix} ]\end{matrix} \qquad ( 2.5 )$$

As a further example, consider the superposition operator of Deutsch-Jozsa's and of Grover's algorithm, for the case n=2, m=1, S=H:

$$\begin{matrix}{[ Sp ]}^{Deutsch \text{-} Jozsa ' s , Grover ' s} = {}^{2} H ⊗ H \\ = ( \frac{1}{\sqrt{8}} ) {}^{3} H \\ = \frac{1}{\sqrt{8}} ( \begin{matrix}{}^{2} H & {}^{2} H \\ {}^{2} H & - {}^{2} H\end{matrix} ) \\ = \frac{1}{\sqrt{8}} ( \begin{matrix}H & H & H & H \\ H & - H & H & - H \\ H & H & - H & - H \\ H & - H & - H & H\end{matrix} ) ,\end{matrix} \\ where H = ( \begin{matrix}1 & 1 \\ 1 & - 1\end{matrix} ) \qquad ( 2.6 )$$

For yet another example, the superposition operator of Simon's and of Shor's algorithms, n=2, m=2, S=I can be expressed as:

$$\begin{matrix}{[ Sp ]}_{i , j}^{Simon , Shor} = {}^{2} H ⊗ {}^{2} I \\ = \frac{1}{2} ( \begin{matrix}( - 1 ) {}^{0 * 0} H & ( - 1 ) {}^{1 * 0} H \\ ( - 1 ) {}^{1 * 0} H & ( - 1 ) {}^{1 * 1} H\end{matrix} ) ⊗ {}^{2} I \\ = \frac{1}{2} ( \begin{matrix}H & H \\ H & - H\end{matrix} ) ⊗ {}^{2} I \\ = \frac{1}{2} ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) ⊗ {}^{2} I \\ = \frac{1}{2} ( \begin{matrix}{}^{2} I & {}^{2} I & {}^{2} I & {}^{2} I \\ {}^{2} I & - {}^{2} I & {}^{2} I & - {}^{2} I \\ {}^{2} I & {}^{2} I & - {}^{2} I & {-}^{2} I \\ {}^{2} I & {-}^{2} I & - {}^{2} I & {}^{2} I\end{matrix} )\end{matrix}$$

Interference operators are calculated for each algorithm according to the parameters listed in Table 2.1. The interference operator is based on the interference layer of the algorithm, which is different for various algorithms, and from the measurement layer, which is the same or similar for most algorithms and includes the m^{th} tensor power of the identity operator.

The interference operator of Deutsch's algorithm includes the tensor product of two Hadamard transformations, and can be calculated using Eq. (2.4) with n=2 as:

$$\begin{matrix}{[ {Int}^{Deutsch} ]}_{i , j} = {}^{2} H = \frac{{( - 1 )}^{i * j}}{{2}^{2 / 2}} \\ = \frac{1}{2} ( \begin{matrix}( - 1 ) {}^{0 * 0} H & ( - 1 ) {}^{0 * 1} H \\ ( - 1 ) {}^{1 * 0} H & ( - 1 ) {}^{1 * 1} H\end{matrix} ) \\ = \frac{1}{2} ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} )\end{matrix} \qquad ( 2.7 )$$

In Deutsch's algorithm, the Walsh-Hadamard transformation in the interference operator is used also for the measurement basis.

The interference operator of Deutsch-Jozsa's algorithm includes the tensor product of the n^{th} power of the Walsh-Hadamard operator with an identity operator. In general form, the block matrix of the interference operator of Deutsch-Jozsa's algorithm can be written as from the n−1 order matrix as:

$$\begin{matrix}[ {Int}^{Deutsch \text{-} Jozsa ' s} ] = {}^{n} H ⊗ I \\ = \frac{1}{{2}^{n / 2}} ( \begin{matrix}{}^{( n - 1 )} H & {}^{( n - 1 )} H \\ {}^{( n - 1 )} H & - {}^{( n - 1 )} H\end{matrix} ) ⊗ I ,\end{matrix} \\ where H = ( \begin{matrix}1 & 1 \\ 1 & - 1\end{matrix} ) , \qquad ( 2.8 )$$

Interference operator of Deutsch-Jozsa's algorithm, n=2, m=1:

$$\begin{matrix}[ {Int}^{Deutsch \text{-} Jozsa ' s} ] = {}^{2} H ⊗ I \\ = \frac{1}{2} ( \begin{matrix}H & H \\ H & - H\end{matrix} ) ⊗ I \\ = \frac{1}{2} ( \begin{matrix}I & I & I & I \\ I & - I & I & - I \\ I & I & - I & - I \\ I & - I & - I & I\end{matrix} ) .\end{matrix}$$

The interference operator of Grover's algorithm can be written as a block matrix of the following form:

$$\begin{matrix}{[ {Int}^{Grover} ]}_{i , j} = {D}_{n} ⊗ I \\ = ( \frac{1}{{2}^{n / 2}} - {}^{n} I ) ⊗ I \\ = ( - 1 + \frac{1}{{2}^{n / 2}} ) ⊗ I {\vert}_{i = j} ,\end{matrix} \\ ( \frac{1}{{2}^{n / 2}} ) ⊗ I {\vert}_{i \neq j} = \frac{1}{{2}^{n / 2}} \{ \begin{matrix}- I , i = j \\ I , i \neq j\end{matrix} \qquad ( 2.9 )$$

where i=0, . . . , 2ⁿ−1, j=0, . . . , 2ⁿ−1, Dₙ refers to diffusion operator

$${[ {D}_{n} ]}_{i , j} = \frac{{( - 1 )}^{1 AND ( i = j )}}{{2}^{n / 2}} .$$

For example, the interference operator for Grover's QSA, when n=2, m=1 is:

$$\begin{matrix}{[ {Int}^{Grover} ]}_{i , j} = {D}_{2} ⊗ I \\ = ( \frac{1}{{2}^{2 / 2}} - {}^{2} I ) ⊗ I \\ = ( - 1 + \frac{1}{2} ) ⊗ I {\vert}_{i = j} ,\end{matrix} \\ \frac{1}{2} ⊗ I {\vert}_{i \neq j} = \frac{1}{2} ( \begin{matrix}- I & I & I & I \\ I & - I & I & I \\ I & I & - I & I \\ I & I & I & - I\end{matrix} ) \qquad ( 2.10 )$$

As the number of qubits increases, the gain coefficient will become smaller. The dimension of the matrix increases according to 2ⁿ, but each element can be extracted using Eq. (2.9), without allocation of the entire operator matrix.

The interference operator of Simon's algorithm is prepared in the same manner as the superposition (as well as superposition operators of Shor's algorithm) and can be described as follows from Eq. (2.3) and Eq. (2.6):

$${[ {Int}^{Simon} ]}_{( i , j )} = {}^{n} H ⊗ {}^{m} I = \frac{{( - 1 )}^{( i * j )}}{{2}^{n / 2}} {}^{( n - 1 )} H ⊗ {}^{m} I , \\ where H = ( \begin{matrix}1 & 1 \\ 1 & - 1\end{matrix} )$$

In general, the interference operator of Simon's algorithm coincides with the interference operator of Deutsch-Jozsa's algorithm Eq. (2.8), but for each block of the operator matrix includes m tensor products of the identity operator.

The Interference operator of Shor's algorithm uses the Quantum Fourier Transformation operator (QFT), calculated as:

$${[ {QFT}_{n} ]}_{i , j} = \frac{1}{{2}^{n / 2}} {ⅇ}^{J ( i * j ) \frac{2 π}{{2}^{n}}} , \qquad ( 2.11 )$$

where: J=√\overline{−1}, i=0, . . . , 2ⁿ−1 and, j=0, . . . , 2ⁿ−1.

When n=1 then:

$$\begin{matrix}{QFT}_{n} {\vert}_{n = 1} = \frac{1}{{2}^{\frac{1}{2}}} ( \begin{matrix}{ⅇ}^{J * ( 0 * 0 ) 2 π / {2}^{1}} & {ⅇ}^{J * ( 0 * 1 ) 2 π / {2}^{1}} \\ {ⅇ}^{J * ( 1 * 0 ) 2 π / {2}^{1}} & {ⅇ}^{J * ( 1 * 1 ) 2 π / {2}^{1}}\end{matrix} ) \\ = \frac{1}{\sqrt{2}} ( \begin{matrix}1 & 1 \\ 1 & - 1\end{matrix} ) = H\end{matrix} \qquad ( 2.12 )$$

Eq. (2.11) can also be presented in harmonic form using the Euler formula:

$${[ {QFT}_{n} ]}_{i , j} = \frac{1}{{2}^{\frac{n}{2}}} ( cos ( ( i * j ) \frac{2 π}{{2}^{n}} ) + J sin ( ( i * j ) \frac{2 π}{{2}^{n}} ) ) \qquad ( 2.13 )$$

For some applications, the harmonic form of Eq (2.13) is preferable.

In general, entanglement operators are part of a QA when the information about the function being analyzed is coded as an input-output relation. Thus, it is useful to develop a general approach for coding binary functions into corresponding entanglement gates. Consider the arbitrary binary function: ƒ: [symbol] 0,1 [symbol] ⁿ→ [symbol] 0,1 [symbol] ^{m}, such that:
ƒ(x₀, . . . , Xₙ₋₁)=(y₀, . . . , yₘ₋₁)

In order to create unitary quantum operator, which performs the same transformation, first transform the irreversible function ƒ into a reversible function F, as follows:
F: [symbol] 0,1 [symbol] ^{m+n}→ [symbol] 0,1 [symbol] ^{m+n},
such that: F(x₀, . . . , xₙ₋₁, y₀, . . . , yₘ₋₁)==(x₀, . . . , xₙ₋₁, ƒ(x₀, . . . , xₙ₋₁)⊕(y₀, . . . , Yₘ₋₁)) where ⊕ denotes addition modulo 2.

For the reversible function F, it is possible to design an entanglement operator matrix using the following rule:

$${[ {U}_{F} ]}_{{i}^{B} , {j}^{B}} = 1 iff F ( {j}^{B} ) = {i}^{B} , i , j ∈ [ {\underbrace{0 , … , 0}}_{n + m} ; {\underbrace{1 , … , 1}}_{n + m} ; ] ,$$

where B denotes binary coding. The resulting entanglement operator is a block diagonal matrix, of the form:

$${U}_{F} = ( \begin{matrix}{M}_{0} & & 0 \\ & ⋰ & \\ 0 & & {M}_{{2}^{n} - 1}\end{matrix} ) \qquad ( 2.14 )$$

Each block Mᵢ,i=0, . . . , 2ⁿ−1 includes m tensor products of I or of C operators, and can be obtained as follows:

$${M}_{i} = {{⊗}_{k = 0}}^{m - 1} \{ \begin{matrix}I , & iff F ( i , k ) = 0 \\ C , & iff F ( i , k ) = 1\end{matrix} , \qquad ( 2.15 )$$

where C represents the NOT operator, defined as:

$$C = ( \begin{matrix}0 & 1 \\ 1 & 0\end{matrix} ) .$$

The entanglement operator is a sparse matrix. Using sparse matrix operations it is possible to accelerate the simulation of the entanglement. Each row or column of the entanglement operation has only one position with non-zero value. This is a result of the reversibility of the function F.

For example, consider the entanglement operator for a binary function with two inputs and one output: ƒ: [symbol] 0,1 [symbol] ²→ [symbol] 0,1 [symbol] ¹, such that: ƒ(x)=1|ₓ₌₀₁0|_{x≠01}. The reversible function F in this case is:

F: [symbol] 0,1 [symbol] ³→ [symbol] 0,1 [symbol] ³, such that:

$$\begin{matrix}( x , y ) & ( x , f ( x ) ⊕ y ) \\ 00 \text{,} 0 & 00 \text{,} 0 ⊕ 0 = 0 \\ 00 \text{,} 1 & 00 \text{,} 0 ⊕ 1 = 1 \\ 01 \text{,} 0 & 01 \text{,} 1 ⊕ 0 = 1 \\ 01 \text{,} 1 & 01 \text{,} 1 ⊕ 1 = 0 \\ 10 \text{,} 0 & 10 \text{,} 0 ⊕ 0 = 0 \\ 10 \text{,} 1 & 10 \text{,} 1 ⊕ 0 = 1 \\ 11 \text{,} 0 & 11 \text{,} 0 ⊕ 0 = 0 \\ 11 \text{,} 1 & 11 \text{,} 1 ⊕ 0 = 1\end{matrix}$$

The corresponding entanglement block matrix can be written as:

$$〈 00 \vert 〈 01 \vert 〈 10 \vert 〈 11 \vert$$

$${U}_{F} = \begin{matrix}\vert 00 〉 \\ \vert 01 〉 \\ \vert 10 〉 \\ \vert 11 〉\end{matrix} ( \begin{matrix}I & 0 & 0 & 0 \\ 0 & C & 0 & 0 \\ 0 & 0 & I & 0 \\ 0 & 0 & 0 & I \end{matrix} )$$

FIG. 18c shows the result of the application of this operator in Grover's QSA. Entanglement operators of Deutsch and of Deutsch-Jozsa's algorithms have the general form shown in the above equation.

As a further example, consider the entanglement operator for a binary function with two inputs and two outputs: ƒ: [symbol] 0,1 [symbol] ²→ [symbol] 0,1 [symbol] ², such that: ƒ(x)=10|_{x=01,11}00|_{x≠01,11} and

$$〈 00 \vert 〈 01 \vert 〈 10 \vert 〈 11 \vert$$

$${U}_{F} = \begin{matrix}\vert 00 〉 \\ \vert 01 〉 \\ \vert 10 〉 \\ \vert 11 〉\end{matrix} ( \begin{matrix}I ⊗ I & 0 & 0 & 0 \\ 0 & C ⊗ I & 0 & 0 \\ 0 & 0 & I ⊗ I & 0 \\ 0 & 0 & 0 & C ⊗ I\end{matrix} )$$

The entanglement operators of Shor's and of Simon's algorithms have the general form shown in the above equation.

2.4. Results of Classical QA Gate Simulation

Analyzing the quantum operators described in Section 2.2 above leads to the following simplifications for increasing the performance of classical QA simulations:
a) All quantum operators are symmetrical around main diagonal matrices.
b) The state vector is a sparse matrix.
c) Elements of the quantum operators need not be stored, but rather can be calculated when necessary using Eqs. (2.6), (2.12), (2.14) and (2.15);
d) The termination condition can be based on the minimum of Shannon entropy of the quantum state, calculated as:

$$H = - {\sum }_{i = 0}^{{2}^{m + n}} {p}_{i} log {p}_{i} \qquad ( 2.16 )$$

Calculation of the Shannon entropy is applied to the quantum state after the interference operation. The minimum of Shannon entropy in Eq. (2.16) corresponds to the state when there are few state vectors with high probability (states with minimum uncertainty are intelligent states).

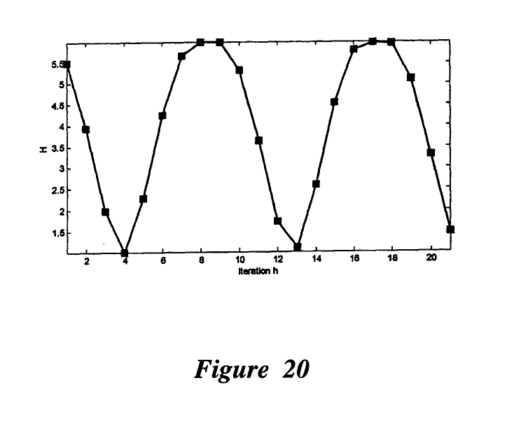

Selection of an appropriate termination condition is important since QAs are periodical. FIG. 20 shows results of the Shannon information entropy calculation for the Grover's algorithm with 5 inputs. FIG. 20 shows that for five inputs of the Grover's QSA an optimal number of iterations, according to minimum of the Shannon entropy criteria for successful result, is exactly four. With more iterations, the probability of obtaining a correct answer will decrease and the algorithm may fail to produce a correct answer. The theoretical estimation for 5 inputs gives π/4√\overline{2⁵}=4.44 iterations. The Shannon entropy-based termination condition provides the number of iterations. More detailed description of the information-based termination condition is presented in Section 2.5.

Simulation results of a fast Grover QSA are summarized in Table 2.2. The number of iterations for the fast algorithm is estimated according to the termination condition based on minimum of Shannon entropy of the quantum intelligent state vector.

TABLE 2.2
Temporal complexity of Grover's QSA simulation on
1.2 GHz computer with two CPUs

Temporal complexity, seconds

| | | Approach 1 | Approach 2 |
|---|---|---|---|
| n | Number of iterations h | (one iteration) | (h iterations) |
| 10 | 25 | 0.28 | ˜0 |
| 12 | 50 | 5.44 | ˜0 |
| 14 | 100 | 99.42 | ˜0 |
| 15 | 142 | 489.05 | ˜0 |
| 16 | 201 | 2060.63 | ˜0 |
| 20 | 804 | — | ˜0 |
| 30 | 25.375 | — | 0.016 |
| 40 | 853.549 | — | 4.263 |
| 50 | 26.353.589 | — | 12.425 |

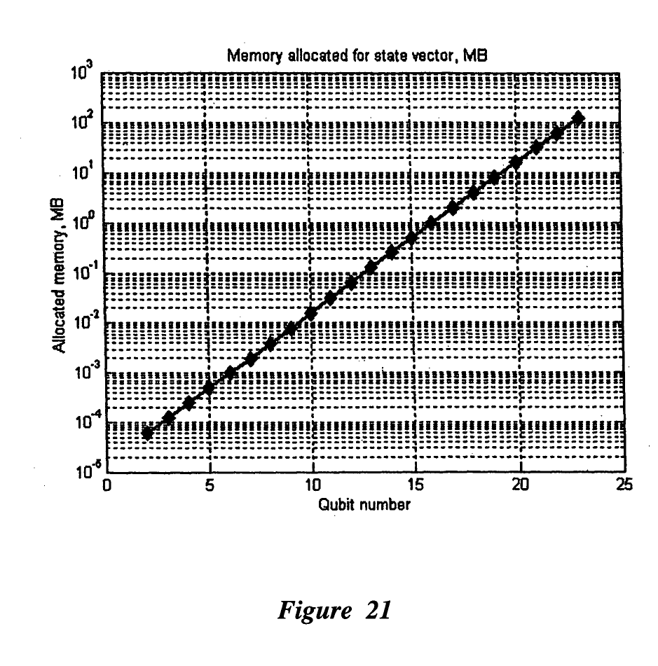

The following approaches were used in the simulations listed in Table 2.2. In Approach 1, the quantum operators are applied as matrices, elements of quantum operator matrices are calculated dynamically according to Eqs. (2.6), (2.12), (2.14) and (2.15). As shown in FIG. 21, the classical hardware limit of this approach to simulation on a desktop computer is around 20 or more qubits, caused by an exponential temporal complexity.

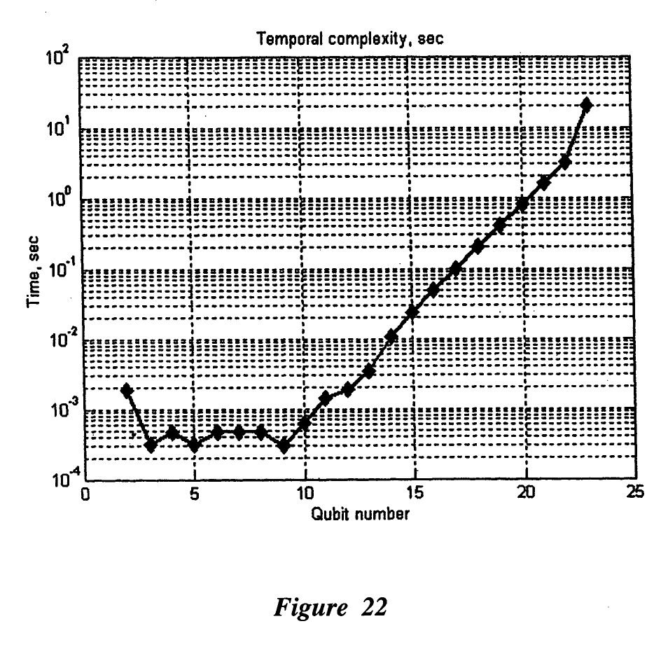

In Approach 2, the quantum operators are replaced with classical gates. Product operations are removed from the simulation as described above in Section 2.2. The state vector of probability amplitudes is stored in compressed form (only different probability amplitudes are allocated in memory). FIG. 22 shows that with the second approach, it is possible to perform classical efficient simulation of Grover's QSA on a desktop computer with a relatively large number of inputs (50 qubits or more). FIG. 22 shows that with allocation of the state vector in computer memory, this approach permits simulation 26 qubits on a conventional PC with 1 GB of RAM. By contrast, FIG. 21 shows memory required for Grover's algorithm simulation when the entire state vector is stored in memory. Adding one qubit doubles the computer memory needed for simulation of Grover's QSA when state vector is allocated completely in memory.

2.5. Information Criteria for Solution of the QSA-Termination Problem

Quantum algorithms come in two general classes: algorithms that rely on a Fourier transform, and algorithms that rely on amplitude amplification. Typically, the algorithms includes a sequence of trials. After each trial, a measurement of the system produces a desired state with some probability determined by the amplitudes of the superposition created by the trial. Trials continue until the measurement gives a solution, so that the number of trials and hence, the running time are random.

The number of iterations needed, and the nature of the termination problem (i.e., determiming when to stop the iterations) depends in art on the information dynamics of the algorithm. An examination of the dynamics of Grover's QSA algorithm starts by preparing all m qubits of the quantum computer in the state |s>=|0 . . . 0>. An elementary rotation in the direction of the sought state |x₀> with property ƒ(x₀)=1 is achieved by the gate sequence:

$$Q = - [ \underbrace{( {I}_{s} {H}^{⊗ 2 m} ) \cdot {I}_{{x}_{0}}}_{k times} ] \cdot {H}^{⊗ 2 m} , \qquad ( 2.17 )$$

where the phase inversion Iₛ with respect to the initial state |s> is defined by Iₛ|S>=−|S>,1ₛ|S>=|S>(x≠s). The controlled phase inversion Iₓ_{₀} with respect to the sought state |x₀> is defined in an analogous way. Because the state |x₀> is not known explicitly but only implicitly through the property ƒ(x₀)=1, this transformation is performed with the help of the quantum oracle. This task can be achieved by preparing the ancillary of the quantum oracle in the state

$$\vert {a}_{0} \text{〉} = \frac{1}{\sqrt{2}} ( \vert 0 〉 - \text{\vert} 1 \text{〉} \text{)}$$

as the unitary and Hermitian transformation: U_{F}:|x,a>→|x,ƒ(x)⊕a>. Thus, |x> is an arbitrary element of the computational basis and |a> is the state of an additional ancillary qubit. As a consequence, one obtains the required properties for the phase inversion Iₓ_{₀}, namely:

$$\vert x , f ( x ) ⊕ {a}_{0} \text{〉} ≡ \vert x , 0 ⊕ {a}_{0} \text{〉} = \frac{1}{\sqrt{2}} [ \vert x , 0 〉 - \text{\vert} x , 1 \text{〉} ] = \text{\vert} x , {a}_{0} , for x \neq {x}_{0} \\ \vert x , f ( x ) ⊕ {a}_{0} \text{〉} ≡ \vert x , 1 ⊕ {a}_{0} \text{〉} = \frac{1}{\sqrt{2}} [ \vert x , 1 〉 - \text{\vert} x , 0 \text{〉} ] = - \text{\vert} x , {a}_{0} , for x \neq {x}_{0}$$

In order to rotate the initial state |s> into the state |x₀> one can perform a sequence of n such rotations and a final Hadamard transformation at the end, i.e., |s_{fin}>=HQⁿ|sᵢₙ>. The optimal number n of repetitions of the gate Q in Eq. (2.17) is approximately given by

$$n = \frac{π}{4 arcsin ( {2}^{- \frac{m}{2}} )} - \frac{1}{2} \approx \frac{π}{4} \sqrt{{2}^{m}} , ( {2}^{m} •1 ) . \qquad ( 2.18 )$$

The matrix Dₙ, which is called the diffusion matrix of order n, is responsible for interference in this algorithm. It plays the same role as QFTₙ (Quantum Fourier Transform) in Shor's algorithm and of ⁿH in Deutsch-Jozsa's and Simon's algorithms. This matrix is defined as

$${[ {D}_{n} ]}_{i , j} = \frac{{( - 1 )}^{1 AND ( i = j )}}{{2}^{n / 2}} , \qquad ( 2.19 )$$

where i=0, . . . , 2ⁿ−1, j=0, . . . , 2ⁿ−1 n is a number of inputs.

The gate equation of Grover's QSA circuit is the following:
G^{Grover}=[(Dₙ\hat{×}I)·U_{F}]^{h}·(ⁿ⁺¹H) (2.20)

The diagonal matrix elements in Grover's QSA-operators (as shown, for example, in Eq. (2.21 ) below) are connected to a database state to itself and the off-diagonal matrix elements are connected to a database state and to its neighbors in the database. The diagonal elements of the diffusion matrix have the opposite sign from the off-diagonal elements.

The magnitudes of the off-diagonal elements are roughly equal, so it is possible to write the action of the matrix on the initial state (see Table2.3).

TABLE 2.3
Diffusion matrix definition

| Dₙ | \|0 . . . 0> | \|0 . . . 1> | . . . | \|i> | . . . | \|1 . . . 0> | \|1 . . . 1> |
|---|---|---|---|---|---|---|---|
| \|0 . . . 0> | −1 + 1/2ⁿ⁻¹ | 1/2ⁿ⁻¹ | . . . | 1/2ⁿ⁻¹ | . . . | 1/2ⁿ⁻¹ | 1/2ⁿ⁻¹ |
| \|0 . . . 1> | 1/2ⁿ⁻¹ | −1 + 1/2ⁿ⁻¹ | . . . | 1/2ⁿ⁻¹ | . . . | 1/2ⁿ⁻¹ | 1/2ⁿ⁻¹ |
| . . . | . . . | . . . | . . . | . . . | . . . | . . . | . . . |
| \|i> | 1/2ⁿ⁻¹ | 1/2ⁿ⁻¹ | . . . | −1 + 1/2ⁿ⁻¹ | . . . | 1/2ⁿ⁻¹ | 1/2ⁿ⁻¹ |
| . . . | . . . | . . . | . . . | . . . | . . . | . . . | . . . |
| \|1 . . . 0> | 1/2ⁿ⁻¹ | 1/2ⁿ⁻¹ | . . . | 1/2ⁿ⁻¹ | . . . | −1 + 1/2ⁿ⁻¹ | 1/2ⁿ⁻¹ |
| \|1 . . . 1> | 1/2ⁿ⁻¹ | 1/2ⁿ⁻¹ | . . . | 1/2ⁿ⁻¹ | . . . | 1/2ⁿ⁻¹ | −1 + 1/2ⁿ⁻¹ |

For example:

$$( \begin{matrix}- a & b & b & b & b & b \\ b & - a & b & b & b & b \\ b & b & - a & b & b & b \\ b & b & b & - a & b & b \\ b & b & b & b & - a & b \\ b & b & b & b & b & - a\end{matrix} ) ( \begin{matrix}1 \\ 1 \\ - 1 \\ 1 \\ 1 \\ 1\end{matrix} ) \frac{1}{\sqrt{N}} = ( \begin{matrix}- a + ( N - 3 ) b \\ - a + ( N - 3 ) b \\ + a + ( N - 1 ) b \\ - a + ( N - 3 ) b \\ - a + ( N - 3 ) b \\ - a + ( N - 3 ) b\end{matrix} ) \frac{1}{\sqrt{N}} , where a = 1 - b , b = \frac{1}{{2}^{n - 1}} . \qquad ( 2.21 )$$

If one of the states is marked, i.e., has its phase reversed with respect to that of the others, the multimode interference conditions are appropriate for constructive interference to the marked state, and destructive interference to the other states. That is, the population in the marked bit is amplified. The form of this matrix is identical to that obtained through the inversion about the average procedure in Grover's QSA. This operator produces a contrast in the probability density of the final states of the database of

$${\frac{1}{N} [ a + ( N - 1 ) b ]}^{2}$$

for the marked bit versus

$${\frac{1}{N} [ a - ( N - 3 ) b ]}^{2}$$

for the unmarked bits; where N is the number of bits in the data register.

Grover's algorithm gate in Eq, (2.20) is optimal and it is, thus, an efficient search algorithm. Thus, software based on the Grover algorithm can be used for search routines in a large database.

Grover's QSA includes a number of trials that are repeated until a solution is found. Each trial has a predetermined number of iterations, which determines the probability of finding a solution. A quantitative measure of success in the database search problem is the reduction of the information entropy of the system following the search algorithm. Entropy S^{Sh}(Pᵢ) in this example of a single marked state is defined as

$${S}^{Sh} ( {P}_{i} ) = - {\sum }_{i = 1}^{N} {P}_{i} log {P}_{i} , \qquad ( 2.22 )$$

where Pᵢ is the probability that the marked bit resides in orbital i. In general, the Von Neumann entropy is not a good measure for the usefulness of Grover's algorithm. For practically every value of entropy, there exist states that are good initializers and states that are not. For example,

$$S ( {ρ}_{( n - 1 ) - mix} ) = {log}_{2} N - 1 = S ( {ρ}_{( \frac{1}{{log}_{2} N} ) - pure} ) ,$$

but when initialized in ρ₍ₙ₋₁₎₋ₘᵢₓ, the Grover algorithm is not good at guessing the market state. Another example may be given using pure states H|0><0|H and H|1><1|H. With the first, Grover finds the marked state with quadratic speed-up. The second is practically unchanged by the algorithm.

The information intelligent measure ℑ_{T}(|ψ>) of the state |ψ> with respect to the qubits in T and to the basis B= [symbol] |i₁>\textcircled{×} . . . \textcircled{×}|iₙ> [symbol] is

$${𝔍}_{T} ( \vert ψ 〉 ) = 1 - \frac{{S}_{T}^{Sh} ( \vert ψ 〉 ) - {S}_{T}^{VN} ( \vert ψ 〉 )}{\vert T \vert} . \qquad ( 2.23 )$$

The intelligence of the QA state is maximal if the gap between the Shannon and the Von Neumann entropy in Eq. 2.23 for the chosen resultant qubit is minimal. Information QA-intelligent measure ℑ_{T}(|ψ>) and interrelations between information measures S_{T}^{Sh}(|ψ>)≧S_{T}^{VN}(|ψ>) are used together with entropic relations of the step-by-step natural majorization principle for solution of the QA-termination problem. From Eq. (2.17) it can be seen that for pure states

$$max {𝔍}_{T} ( \vert ψ 〉 ) ↦ 1 - min ( \frac{{S}_{T}^{Sh} ( \vert ψ 〉 ) - {S}_{T}^{VN} ( \vert ψ 〉 )}{\vert T \vert} ) ↦ min {S}_{T}^{Sh} ( \vert ψ 〉 ) , {S}_{T}^{VN} ( \vert ψ 〉 ) = 0 , \qquad ( 2.24 )$$

From Eq.(2.17) the principle of Shannon entropy minimum is described as follows.

According to Eq. (1.2), the Shannon entropy shows the lower bound of quantum complexity of the QA. It means that the criterion in Eq. (2.24) includes both metrics for design of an intelligent QSA: (i) minimal quantum query complexity; and (ii) optimal termination of the QSA with a successful search solution.

The Shannon information entropy is used for optimization of the termination problem of Grover's QSA. A physical interpretation of the information criterion begins with an information analysis of Grover's QSA based on using of Eq. (2.23). Eq (2.23) gives a lower bound on the amount of entanglement needed for a sucessful search and of the computational time. A QSA that uses the quantum oracle calls [symbol] Oₛ [symbol] as I−2|s><s| calls the oracle at least

$$T \geq ( \frac{1 - {P}_{e}}{2 π} + \frac{1}{π log N} ) \sqrt{N}$$

times to achieve a probability of error Pₑ. The information system includes the N-state data register. Physically, when the data register is loaded, the information is encoded as the phase of each orbital. The orbital amplitudes carry no information. While state-selective measurement gives as result only amplitudes, the information is hidden from view, and therefore, the entropy of the system is maximum: Sᵢₙᵢₜ^{Sh}(Pᵢ)=−log(1/N)=log N. The rules of quantum measurement ensure that only one state will be detected each time.

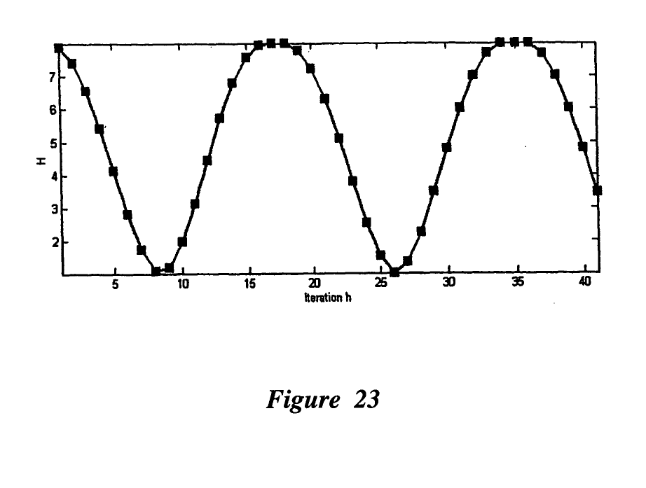

If the algorithm works perfectly, the marked state orbital is revealed with unit efficiency, and the entropy drops to zero. Otherwise, unmarked orbitals may occasionally be detected by mistake. The entropy reduction can be calculated from the probability distribution, using Eq. (2.22). The minimum Shannon entropy criteria is used for successful termination of Grover's QSA and realized in this case in digital circuit implementation. P FIG. 23 shows the results of entropy analysis for Grover's QSA according to Eq. (2.16), for the case where n=7, ƒ(x₀)=1. FIG. 23 shows that minimum Shannon entropy is achieved on the 8^{th} iteration (the minimum value of the Shannon entropy is 1). A theoretical estimation for this case is

$$\frac{π}{4} \sqrt{{2}^{7}} \approx 9$$

iterations. On the ninth iteration, the probability of the correct answer already becomes smaller, and as a result, measurement of the wrong basis vector may happen.

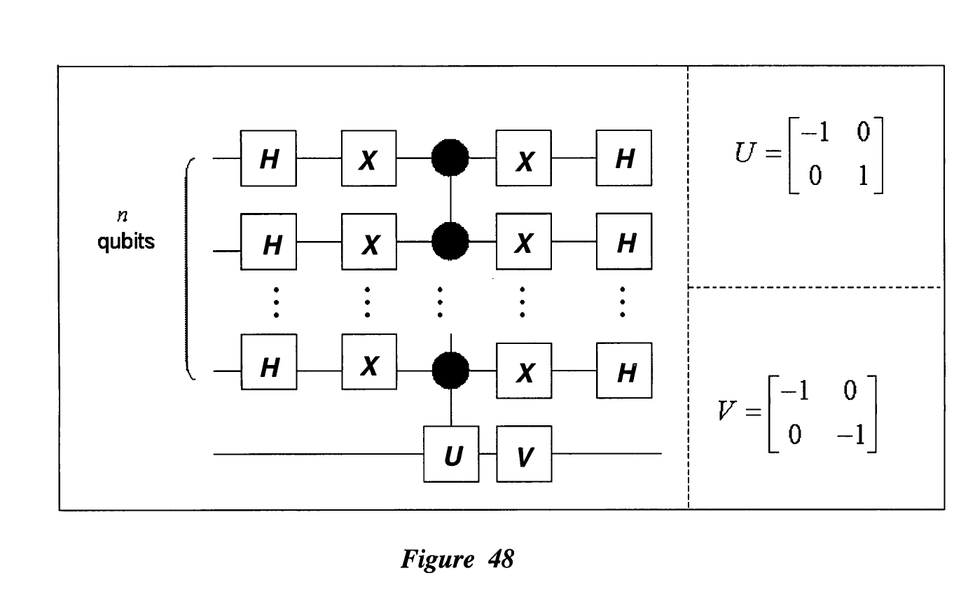

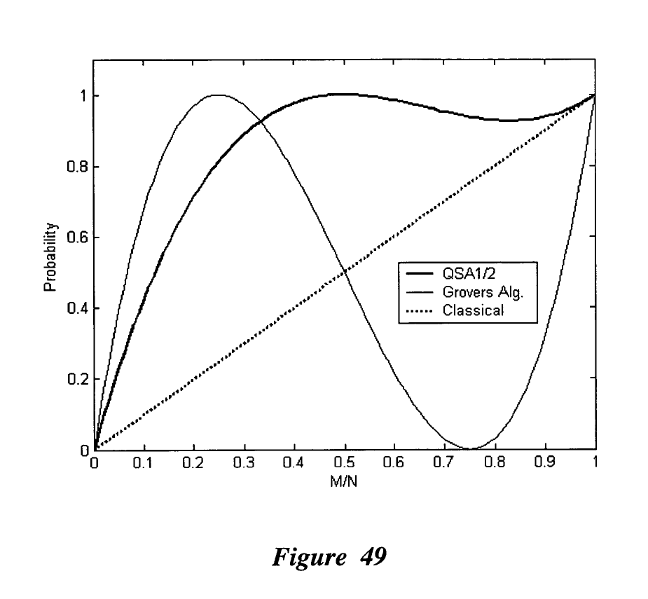

Application of the Shannon entropy termination condition is presented below in Section 6 (see FIGS. 48 and 49) for different input qubit numbers of Grover's QSA. The role of majorization and its relationship to Shannon entropy is discussed below.

Majorization describes what it means to say that one probability distribution is more disordered than another. In the quantum mechanical context, majorization provides an elegant way to compare two probability distributions or two density matrices. The step-by-step majorization is found in the known instance of efficient QA's, namely in the QFT, in Grover's QSA, in Shor's QA, in the hidden affine function problem, in searching by quantum adiabatic evolution and in deterministic quantum walks algorithm in continuous time solving a classical hard problem. Moreover, majorization has found many applications in classical computer science like stochastic scheduling, optimal Huffman coding, greedy algorithms, etc. Majorization is a natural ordering on probability distributions. One probability distribution is more uneven than another one when the former majorizes the later. Majorization implies an entropy decrease, thus the ordering concept introduced by majorization is more restrictive and powerful than that associated with the Shannon entropy.

The notion of ordering from majorization is more severe than the one quantified by the standard Shannon entropy. If one probability distribution majorizes another, a set of inequalities must hold to constrain the former probabilities with respect to the latter. These inequalities lead to entropy ordering, but the converse is not necessarily true. In quantum mechanics, majorization is at the heart of the solution of a large number of quantum information problems. In QA analysis, the problem distribution associated with the quantum state in the computational basis is step-by-step majorized until it is maximally ordered. Then a measurement provides the solution with high probability. The way such a detailed majorization emerges in both algorithmic families (as Grover's and Shor's QA's, and phase-estimation QA) is intrinsically different. The analyzed instance of QA's support a step-by-step Majorization Principle.

Grover's algorithm is an instance of the principle where majorization works step by step until the optimal target state is found. Extensions of this situation are also found in algorithms based in quantum adiabatic evolution and the family of quantum phase-estimation algorithms, including Shor's algorithm. In a QA, the time arrow is a majorization arrow.

Majorization is often defined as a binary relation noted by [symbol] on vectors in [symbol] ^{d}. Notations are fixed by introducing the following basic definitions:

For x,y ε [symbol] ^{d},

$$x ≺ y iff \{ \begin{matrix}{\sum }_{i = 1}^{k} {x}_{[ i ]} \leq {\sum }_{i = 1}^{k} {y}_{[ i ]} , & k = 1 , … , d - 1 \\ {\sum }_{i = 1}^{d} {x}_{[ i ]} \leq {\sum }_{i = 1}^{d} {y}_{[ i ]} & \end{matrix}$$

where [z_{[1]} . . . z_{[d]}]:=sort_{↓} (z) denotes the descendingly sorted (non-increasing) ordering of zε [symbol] ^{d}. If it exists, the least element x₁ (greatest element x_{g}) of a partial order like majorization is defined by the condition x₁ [symbol] x, ∀xε [symbol] ^{d}(x [symbol] x_{g}, ∀x ε [symbol] ^{d})

For example, consider two vectors x, y εR^{d} such that

$${\sum }_{i = 1}^{d} {x}_{i} = {\sum }_{i = 1}^{d} {y}_{i} = 1 ,$$

whose components represent two different probabilistic distributions. Three definitions of majorization are given in the table below:

| | |
|---|---|
| Definition 1 | $x = {\sum }_{j} {p}_{j} {P}_{j} y$ |
| Definition 2 | ${\sum }_{i = 1}^{k} {x}_{i} \leq {\sum }_{i = 1}^{k} {y}_{i} , k = 1 , … , d$ |
| Definition 3 | x = Dy |

Definition 1 says that distribution y majorizes distribution x, written x [symbol] y, if and only if, there exists a set of permutation matrices Pⱼ and probabilities pⱼ such that

$$x = {\sum }_{j} {p}_{j} {P}_{j} y .$$

Because the probability distribution x can be obtained from y by means of a probabilistic sum, the definition given above provides the intuitive notion that the x distribution is more disordered than y.

An alternative and usually more practical definition of majorization can be stated in terms of a set of inequalities to be held between two distributions as described in Definition 2 above. Consider the components of the two vectors sorted in decreasing order, written as (z₁, . . . z_{d})≡z^{↓}. Then, y^{↓} majorizes x^{↓} if and only if the following relations are satisfied:

$${\sum }_{i = 1}^{k} {x}_{i} \leq {\sum }_{i = 1}^{k} {y}_{i} , k = 1 , … , d .$$

Probability sums, such as the ones appearing in the previous expression are referred to as “cumulants”.

According to Definition 3 above, a real d×d matrix D=(Dᵢⱼ) is said to be double stochastic if it has non-negative entries, and each row and column of D sums to 1. Then y majorizes x if and only if, there is a double stochastic matrix D such that x=Dy. Complementarily, the probability distribution x minorizes distribution y if and only if, y majorizes x.

A powerful relation involving majorization and common Shannon entropy

$${S}^{Sh} ( x ) = - {\sum }_{i = 1}^{d} {x}_{i} log {x}_{i}$$

of probability distribution x is that: If x [symbol] y, then −S^{Sh}(y)≧−S^{Sh}(x). This is a particular case of a more general result, stated in the following weak form:

$$x ≺ y ⇒ F ( x ) < F ( y ) , where F ( x ) ≡ {\sum }_{i} f ( {x}_{i} ) ,$$

for any convex function ƒ:R→R This result can be extended to the domain of operator functionals.

$$ρ ≺ σ ⇒ F ( ρ ) < F ( σ ) , wher e F ( ρ ) ≡ {\sum }_{i} f ( {λ}_{i} ) ,$$

and λᵢ are the eigenvalues of ρ, for any convex function ƒ:R→R

In particular, it follows that the von Neumann entropy S^{vN}(ρ)=S^{Sh}(λ(ρ)) also obeys ρ [symbol] σ [symbol] −S^{vN}(ρ)≦−S^{vN}(σ).

Thus, if one probability distribution or one density operator is more disordered than another in the sense of majorization, then it is also more disordered according to the Shannon or the von Neumann entropies, respectively.

As the two previous theorems show, there are many other functions that also preserve the majorization relation. Any such function, called Schur-convex, can in a sense be used as a measure of order. The majorization relation is a stronger notion of disorder, giving more information than any Schur-convex function. The Shannon and the von Neumann entropies quantify the order in some limiting conditions, namely when many copies of a system are considered.

There is a majorization principle underlying the way QA's work. Denote by |Ψₘ> the pure state representing the state of the register in a quantum computer at an operating stage labeled by m=0,1, . . . , M−1, where M is the total number of steps of algorithm, and let N be the dimension of the Hilbert space. Also, denote as [symbol] |i> [symbol] ᵢ₌₁^{N} the basis in which the final measurement is performed in the algorithm, one can naturally associate a set of sorted probabilities [p^{m}_{[x]}], x=0,1, . . . ,2ⁿ−1 to this quantum state of n qubits in the following way: decompose the register state in the computational basis i.e.,
|Ψₘ>:=Σₓ₌₀²^{ⁿ}⁻¹c^{m}ₓ|x>
with [symbol]
|x>:=|x₀s₁ . . . xₙ₋₁> [symbol] ₓ₌₀²^{ⁿ}⁻¹
denoting basis states in digital or binary notation, respectively and
x:=Σⱼ₌₀ⁿ⁻¹xⱼ2^{j}.

The sorted vectors to which majorization theory applies are precisely
[p^{m}_{[x]}]:=[|c^{m}_{[x]}|²]=[|<x|ψₘ>|²],
where x=1, . . . , N, which corresponds to the probabilities of all the possible outcomes if the computation is stopped at stage m and a measurement is performed.

Thus, in a QA, one deals with probability densities defined in [symbol] ₊^{d}, with d=2ⁿ. With these ingredients, the main result can be stated as follows: in the QAs known so far, the set of sorted probabilities [p_{[x]}^{m}] associated with the quantum register at each step m are majorized by the corresponding probabilities of the next step

$$[ {p}_{[ x ]}^{m} ] ≺ [ {p}_{[ x ]}^{m + 1} ] , \{ \begin{matrix} ∀ m = 0 , 1 , … , M - 2 \\ x = 0 , 1 , … , {2}^{n} - 1\end{matrix} , or \\ {p}^{( m )} ≺ {p}^{( m + 1 )} , {p}^{( m )} = [ {p}_{[ x ]}^{m} ] .$$

Majorization works locally in a QA, i.e., step by step, and not just globally (for the initial and final states). The situation given in the above equation is a step-by-step verification, as there is a net flow of probability directed to the values of highest weight, in such a way that the probability distribution will be steeper as time flows.

In physical terms, this can be stated as a very particular constructive interference behavior, namely, a constructive interference that has to satisfy the constraints given above step-by-step. The QA builds up the solution at each time step by means of this very precise reordering of probability distribution.

The majorization is checked on a particular basis. Step-by-step majorization is a basis-dependent concept. The preferred basis is the basis defined by the physical implementation of the quantum computation or computational basis. The principle is rooted in the physical possibility to arbitrarily stop the computation at any time and perform a measurement. The probability distribution associated with this physically meaningful action obeys majorization and the QA-stopping problem can be solved by the principle of minimum of Shannon entropy.

Working with probability amplitudes in the basis [symbol] |i> [symbol] ᵢ₌₁^{N}, the action of a particular unitary gate at step m makes the amplitudes evolve to step m+1 in the following way:

$${c}_{i}^{m + 1} = {\sum }_{j = 1}^{N} {U}_{ij} {c}_{j}^{m} ,$$

where Uᵢⱼ are the matrix elements in the chosen basis of the unitary evolution operator (namely, the propagator from step m to step m+1 ). Inverting the evolution gives

$${c}_{i}^{m} = {\sum }_{j = 1}^{N} {A}_{ij} {c}_{j}^{m + 1} ,$$

where Aᵢⱼ are the matrix elements of the inverse unitary evolution (which is unitary as well).Taking the square modulus

$${\vert {c}_{i}^{m} \vert}^{2} = {\sum }_{j} {\vert {A}_{ij} \vert}^{2} {\vert {c}_{i}^{m + 1} \vert}^{2} + interference terms .$$

Should the interference terms disappear, majorization would be verified in a “natural” way between steps m and m+1 because the initial probability distribution could be obtained from the final one only by the action of a doubly stochastic matrix with entries |Aᵢⱼ|². This is so-called “natural majorization”: majorization, which naturally emerges from the unitary evolution due to the lack of interference terms when making the square modulus of the probability amplitudes. There will be “natural minorization” between steps m and m+1 if and only if there is “natural majorization” between time steps m+1 and m.

Grover's QSA follows a step-by-step majorization. More concretely, each time Grover's operator is applied, the probability distribution obtained from the computational basis obeys the above constraints until the searched state is found. Furthermore, because of the possibility of understanding Grover's quantum evolution as a rotation in a two-dimensional Hilbert space the QA follows a step-by-step minorization when evolving far away from the marked state, until the initial superposition of all possible computational states is obtained again. The QA behaves such that majorization is present when approaching the solution, while minorization appears when escaping from it. A cycle of majorization and minorization emerges in the process proceeds through enough evolutions, due to the rotational nature of Grover's operator.

Grover's algorithm is an instance of the principle where majorization works step-by-step until the optimal target state is found. Extensions of this situation are also found in algorithms based in quantum adiabatic evolution and the family of quantum phase-estimation algorithms, including Shor's algorithm.

Grover's algorithm can conveniently be used as a starting point for majorization analysis of various quantum algorithms. This QA efficiently solves the problem of finding a target item in a large database. The algorithm is based on a kernel that acts symmetrically on the subspace orthogonal to the solution. This is clear from its construction
K:=UₛU_{y0}
Uₛ:=2|s><s|−1, U_{y0}:=1−2|y₀><y_{0|}
where |s>:=1/√\overline{N}Σₓ|x> and |y₀> is a searched item. The set of probabilities to obtain any of the N possible states in a database is majorized step-by-step along with the evolution of Grover's algorithm when starting from a symmetric state until the maximum probability of success is reached.

Shor's QA is analyzed inside of the broad family of quantum phase-estimation algorithms. A step-by-step majorization appears under the action of the last QFT when considered in the usual Coppersmith decomposition. The result relies on the fact that those quantum states that can be mixed by a Hadamard operator coming from the decomposition of the QFT only differ by a phase all along the computation. Such a property entails as well the appearance of natural majorization, in the way presented above. Natural majorization is relevant for the case of Shor's QFT. This particular algorithm manages step-by-step majorization in the most efficient way. No interference terms spoil the majorization introduced by the natural diagonal terms in the unitary evolution.

For efficient termination of QAs that give the highest probability of successful result, the Shannon entropy is minimal for the step m+1. This is the principle of minimum Shannon entropy for termination of a QA with the successful result. This result also follows from the principle of QA maximum intelligent state. For this case:

$$max {J}_{T} ( \vert ψ 〉 ) = 1 - min \frac{{H}_{T}^{Sh} ( \vert ψ 〉 )}{\vert T \vert} ,$$

S_{T}^{vN}(|ψ>)=0 (for pure quantum state). Thus, the principle of maximal intelligence of QAs include as particular case the principle of minimum Shannon entropy for QA-termination problem solution.
3. The Structure and Acceleration Method of Quantum Algorithm Simulation

The analysis of the quantum operator matrices that was carried out in the previous sections forms the basis for specifying the structural patterns giving the background for the algorithmic approach to QA modeling on classical computers. The allocation in the computer memory of only a fixed set of tabulated (pre-defined) constant values instead of allocation of huge matrices (even in sparse form) provides computational efficiency. Various elements of the quantum operator matrix can be obtained by application of an appropriate algorithm based on the structural patterns and particular properties of the equations that define the matrix elements. Each representation algorithm uses a set of table values for calculating the matrix elements. The calculation of the tables of the predefined values can be done as part of the algorithm's initialization.

3.1. Algorithmic Representation of the Grover's QA

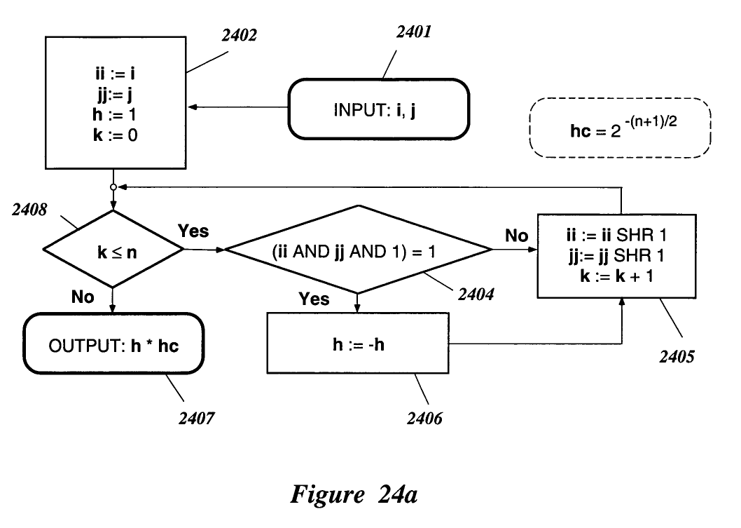

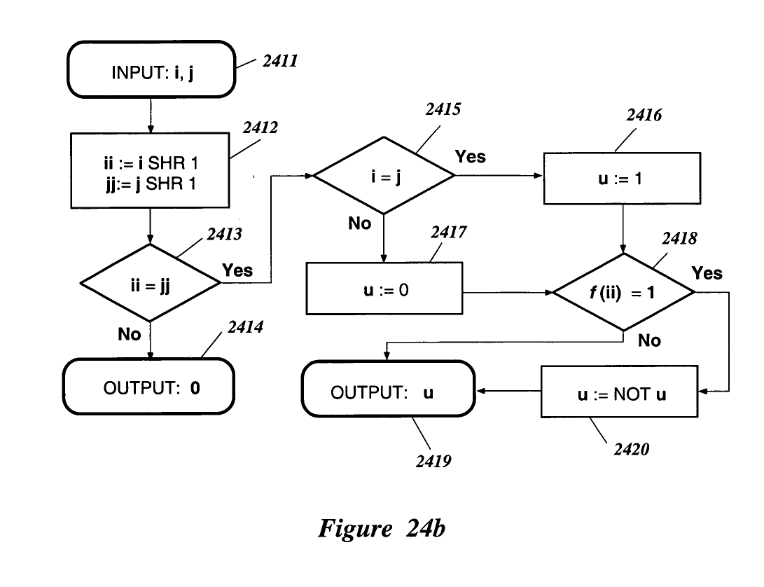

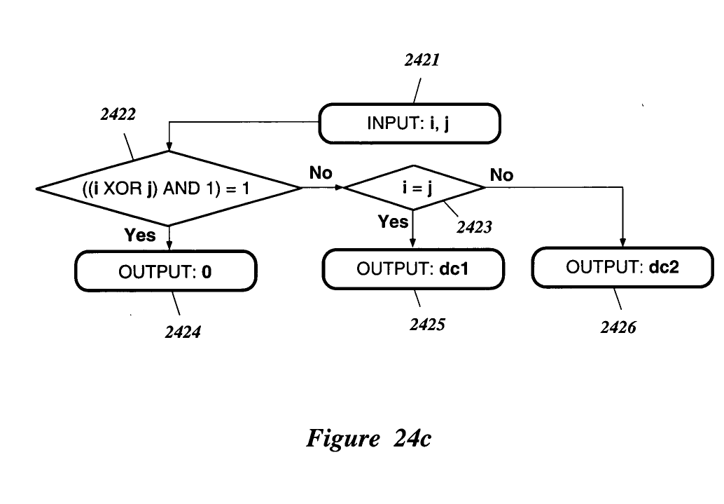

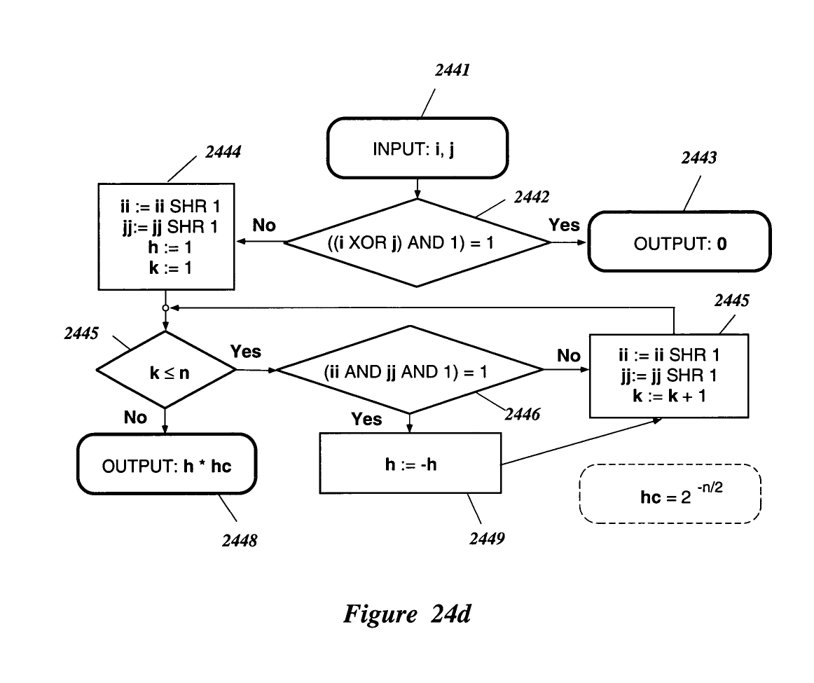

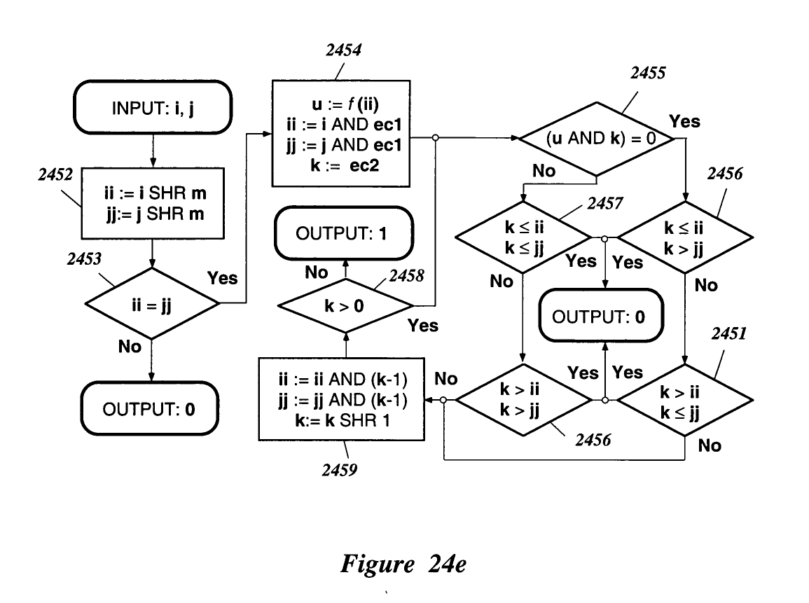

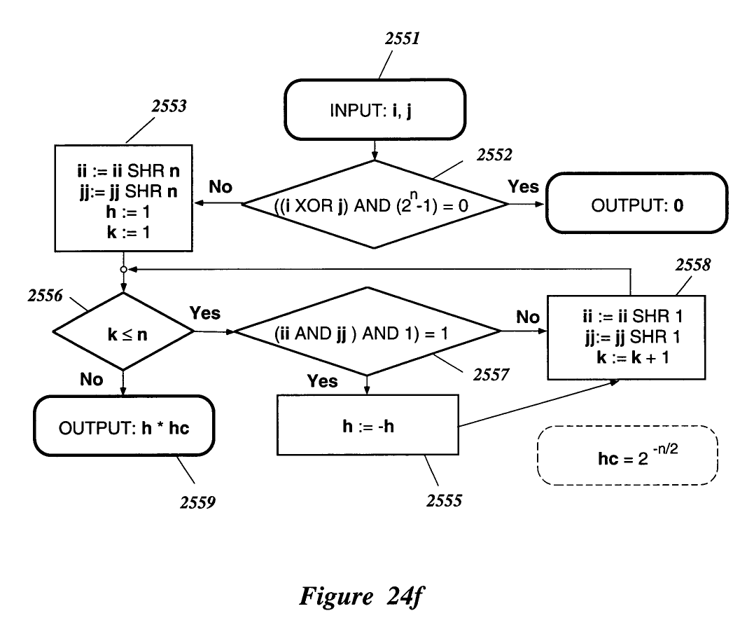

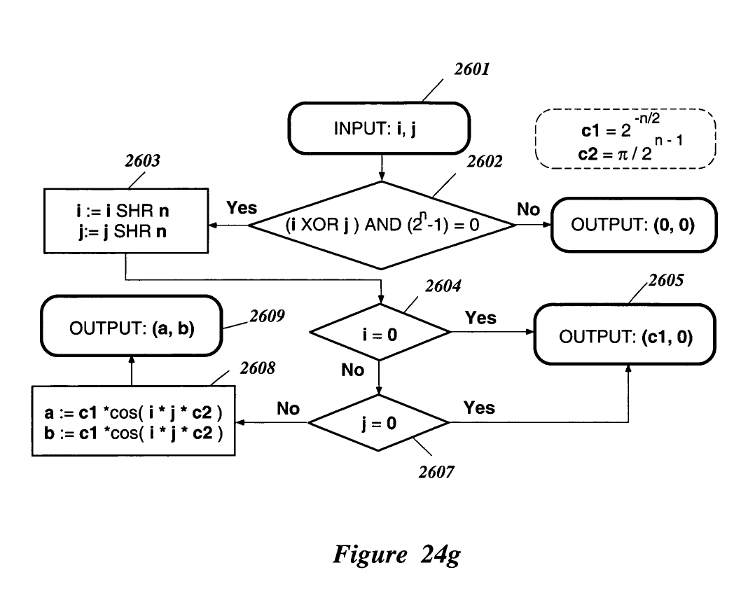

FIGS. 24a-c are flowcharts showing realization of such an approach for simulation of superposition (FIG. 24a), entanglement (FIG. 24b) and interference (FIG. 24c) operators in Grover's QSA. Here n is a number of qubit, i and j are the indexes of a requested element, hc=2^{-(n+1)/2}, dc1=2¹⁻ⁿ−1 and dc2=2¹⁻ⁿ are the table values.

In FIG. 24a, in a block 2401, the i,j values are specified and provided to an initialization block 2402 where loops control variables ii :=i, jj:=0, and k:=0 are initialized, and calculation variable h:=1 is initialized. The process then proceeds to a decision block 2403. In the block 2403, if k is less than or equal to n, then the process advances to a decision block 2404; otherwise, the process advances to an output block 2407 where the output h*hc is computed (where hc=2^{-(n+1)/2}). In the decision block 2404, if (ii and jj and 1)=1, then the process advances to a block 2406; otherwise, the process advances to a block 2405. In the block 2406, the process sets h:=−h and advances to the block 2405. In the block 2405, the process sets ii:=ii SHR 1, jj:=jj SHR 1, and k:=k+1 (where SHR is a shift right operation), and then the process returns to the decision block 2403.

In FIG. 24b, the inputs i, j in an input block 2411 are provided to an initialization block 2412 which sets ii:=i SHR 1, and jj:=SHR 1 and then advances to a decision block 2413. In the decision block 2413, if ii==jj, then the process advances to a decision block 2415, otherwise, the process advances to an output block 2414 which outputs 0. In the decision block 2415, if i=j, then the process advances to a block 2416; otherwise, the process advances to a block 2417. In the block 2416, the process sets u:=1 and then advances to a decision block 2418. In the block 2417, the process sets u:=0 and advances to the decision block 2418. In the decision block 2418, if f(ii)=1, then the process advances to a block 2420; otherwise, the process advances to an output block that outputs u. The block 2420 sets u:=NOT u and advances to the output block 2419.

In FIG. 24c, if ((i XOR j) AND 1)=1 then the process outputs 0; otherwise, the process advances to a decision block 2423. In the decision block 2423, if i=j then the process outputs dc1, otherwise the process outputs dc2, where dc1=2¹⁻ⁿ−1 and dc2=2¹⁻ⁿ.

As described above, the superposition and entanglement operators for Deutsch-Jozsa's QA are the same with superposition and entanglement operators for Grover's QSA (FIG. 24a, FIG. 24b, respectively). The interference operator representation algorithm for Deutsch-Jozsa's QA is shown in FIG. 24d, where hc=2^{-n/2}.

The entanglement operator for the Simon QA is shown in FIG. 24e. Here m is an output dimension, ec1=2^{m}−1 and ec2=2^{m-1} are the table values. In FIG. 24e, the inputs i,j are provided to an initialization block 2452 that sets ii:=i SHR m and jj :=SHR m. The process then advances to a decision block 2453. In the decision block 2453, if ii=jj then the process advances to a block 2454; otherwise, the process outputs 0. In the block 2454, the process sets u:=f(ii), ii:=i AND ec1, jj:=j AND ec1, and k:=ec2; after which the process advances to a decision block 2455. In the decision block 2455, if (u AND k)=0, then the process advances to a decision block 2456; otherwise, the process advances to a decision block 2457. In the decision block 2456, if k<=ii, and k>jj, then the process outputs 0; otherwise, the process advances to a decision block 2451. In the decision block 2457, if k<=ii AND k<=jj, then the process outputs 0; otherwise, the process advances to a decision block 2456. In the decision block 2451, if k>ii AND k<=jj, then the process outputs 0; otherwise, the process advances to a block 2459. In the decision block 2456, if k>ii AND k>jj then the process outputs 0; otherwise, the process advances to the block 2459. In the block 2459, the process sets ii:=jj AND (k−1), jj:=jj AND (k=1), and k:=K SHR 1, after which, the process advances to a decision block 2458. In the decision block 2458, if k>0, then the process loops back to the block 2455; otherwise, the process outputs 1.

Superposition and interference operators for the Simon QA are identical (see Table 2.1) and are shown by flowchart in FIG. 24f. In FIG. 24f, the inputs i,j are provided to a decision block 2552. In the decision block 2552, if ((i XOR j) AND (2ⁿ⁻¹⁾=0) then the process advances to a block 2553; otherwise, the process outputs 0. In the block 2553, the process sets ii:=i SHR n, jj :=j SHR n, h:=1, and k:=1, and then advances to a decision block 2556. In the decision block 2556, if k<=n, then the process advances to a decision block 2557; otherwise, the process outputs h*hc. In the decision block 2557, if (((ii AND jj) AND 1)=1) then the process sets J:=−h and advances to a block 2558; otherwise, the process advances directly to the block 2558. In the block 2558, the process sets ii:=SHR 1, jj :=jj SHR 1, k:=k+1 and then loops back to the decision block 2556.

FIG. 24g is a flowchart showing calculation of the interference operator from the Shor QA. The Shor interference operator is relatively more complex, as explained above. Superposition and entanglement operators for the Shor algorithm are the same as the Simon's QA operators shown in FIG. 24f and FIG. 24e. The Shor interference operator is based on the Quantum Fourier Transformation (QFT) with table values c1=2^{-n/2} and c2=π/2ⁿ⁻¹.

In FIG. 24g, the inputs i,j are provided to a decision block 2602. In the decision block 2602, if ((i XOR j) AND (2ⁿ−1))=0 then the process advances to a block 2603; otherwise, the process outputs the complex number (0,0). In the block 2603, the process sets i:=i SHR n, and j :=j SHR n, and then advances to a decision block 2604. In the decision block 2604, if i=0, then the process outputs the complex number (c1,0); otherwise, the process advances to a decision block 2607. In the decision block 2607, if j=0, then the process outputs the complex number (c1,0); otherwise, the process advances to a block 2608, In the block 2608, the process sets a:=c1*cos(i*j*c2), and b:=c1*sin(i*j*c2), and the outputs (a,b).

The time required for calculating the elements of an operator's matrix during a process of applying a quantum operator is generally small in comparison to the total time of performing a quantum step. Thus, the time burden created by exponentially-increasing memory usage tends to be less, or at least similar to, the time burden created by computing matrix elements as needed. Moreover, since the algorithms used to compute the matrix elements tend to be based on fast bit-wise logic operations, the algorithms are amenable to hardware acceleration.

Table 3.1 shows comparisons of the traditional and as-needed matrix calculation (when the memory used for the as-needed algorithm (Memory*) denotes memory used for storing the quantum system state vector.

TABLE 3.1
Different approaches comparison: Standard (matrix based)
and algorithmic based approach

| | |
|---|---|
| Standard | Calculated Matrices |

| Qubits | Memory, MB | Time, s | Memory* | Time, s |
|---|---|---|---|---|
| 1 | 1 | 0.03 | ≈0 | ≈0 |
| 8 | 18 | 5.4 | 0.008 | 0.0325 |
| 11 | 1048 | 1411 | 0.064 | 2.3 |
| 16 | — | — | 2 | 4573 |
| 24 | — | — | 512 | 3 * 10⁸ |
| 64 | — | — | — | — |

The results shown in Table 3.1 is based on the results of testing the software realization of Grover QSA simulator on a personal computer with Intel Pentium III 1 GHz processor and 512 Mbytes of memory. One iteration of the Grover QSA was performed.

Table 3.1 shows that significant speed-up is achieved by using the algorithmic approach as compared with the prior art direct matrix approach. The use of algorithms for providing the matrix elements allows considerable optimization of the software, including the ability to optimize at the machine instructions level. However, as the number of qubits increases, there is an exponential increase in temporal complexity, which manifests itself as an increase in time required for matrix product calculations.

Use of the structural patterns in the quantum system state vector and use of a problem-oriented approach for each particular algorithm can be used to offset this increase in temporal complexity. By way of explanation, and not by way of limitation, the Grover algorithm is used below to explain the problem-oriented approach to simulating a QA on a classical computer.

3.2. Problem-Oriented Approach Based on Structural Pattern of QA State Vector.

Let n be the input number of qubits. In the Grover algorithm, half of all 2ⁿ⁻¹ elements of a vector making up its even components always take values symmetrical to appropriate odd components and, therefore, need not be computed. Odd 2ⁿ elements can be classified into two categories:

The set of m elements corresponding to truth points of input function (or oracle); and

The remaining 2ⁿ−m elements.

The values of elements of the same category are always equal.

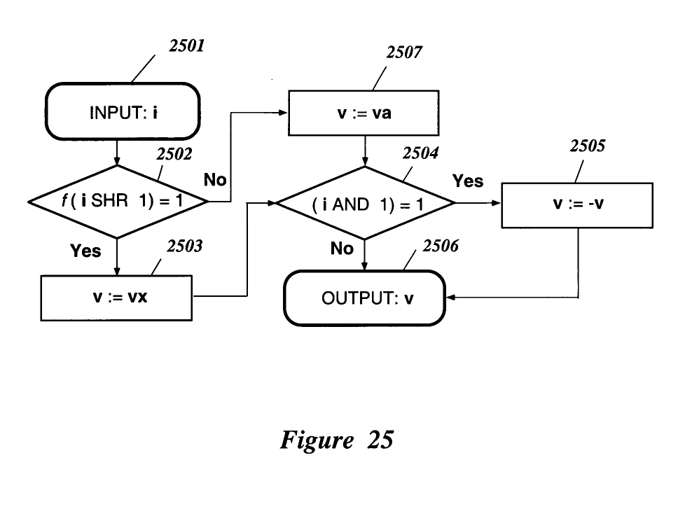

As discussed above, the Grover QA only requires two variables for storing values of the elements. Its limitation in this sense depends only on a computer representation of the floating-point numbers used for the state vector probability amplitudes. For a double-precision software realization of the state vector representation algorithm, the upper reachable limit of q-bit number is approximately 1024. FIG. 25 shows a state vector representation algorithm for the Grover QA. In FIG. 25, i is an element index, ƒ is an input function, vx and va corresponds to the elements' category, and v is a temporal variable. The input i is provided to a decision block 2502. In the decision block 2502, if ƒ(i SHR 1)=1, then the process proceeds to a block 2503; otherwise, the process proceeds to a block 2507. In the block 2503, the process sets v:=vx and then advances to a decision block 2504. In the block 2507, the process sets v:=va and then advances to the decision block 2504. In the decision block 2504, if (i AND 1)=1), then the process outputs −v; otherwise, the process outputs v. Thus, the number of variables used for representing the state variable is constant.

A constant number of variables for state vector representation allows reconsideration of the traditional schema of quantum search simulation. Classical gates are used not for the simulation of appropriate quantum operators with strict one-to-one correspondence but for the simulation of a quantum step that changes the system state. Matrix product operations are replaced by arithmetic operations with a fixed number of parameters irrespective of qubit number.

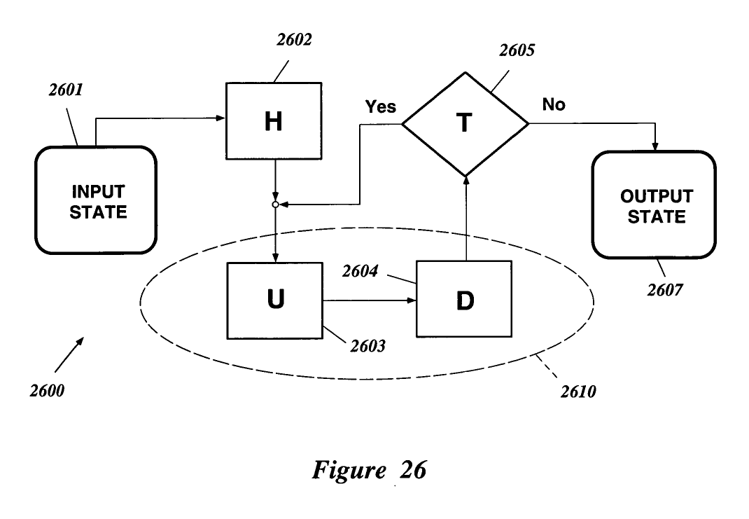

FIG. 26 shows a generalized schema for efficient simulation of the Grover QA built upon three blocks, a superposition block H 2602, a quantum step block UD 2610 and a termination block T 2605. FIG. 26 also shows an input block 2601 and an output block 2607. The UD block 2610 includes a U block 2603 and a D block 2604. The input state from the input block 2601 is provided to the superposition block 2602. A superposition of states from the superposition block 2602 is provided to the U block 2603. An output from the U block 2603 is provided to the D block 2604. An output from the D block 2604 is provided to the termination block 2605. If the termination block terminates the iterations, then the state is passed to the output block 2607; otherwise, the state vector is returned to the U block 2603 for another iteration.

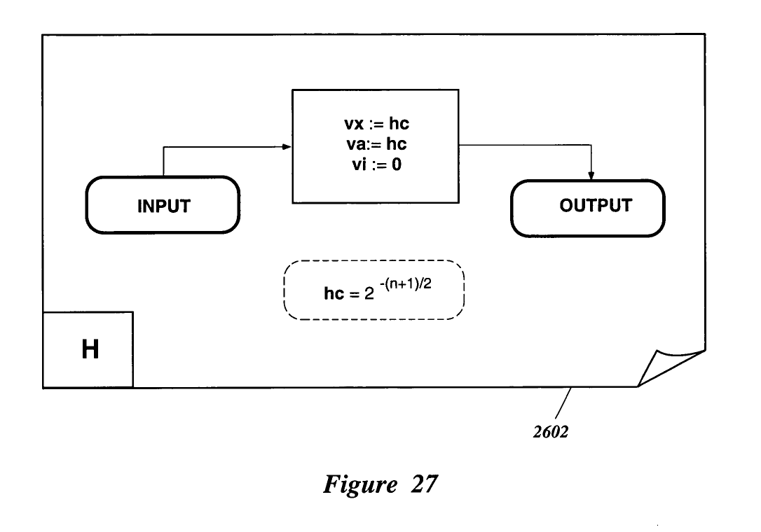

As shown in FIG. 27, the superposition block H 2602 for Grover QSA simulation changes the system state to the state obtained traditionally by using n+1 times the tensor product of Walsh-Hadamard transformations. In the process shown in FIG. 27, vx:=hc, va:=hc, and vi:=0., where hc=2^{-(n+1)/2} is a table value.

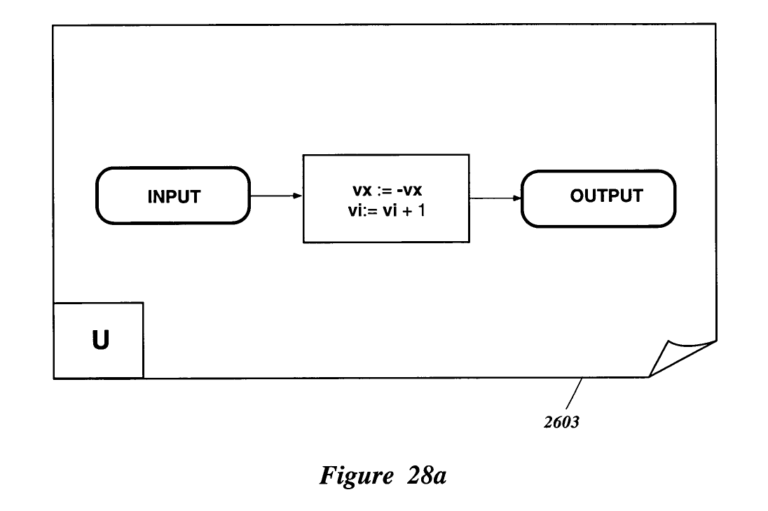

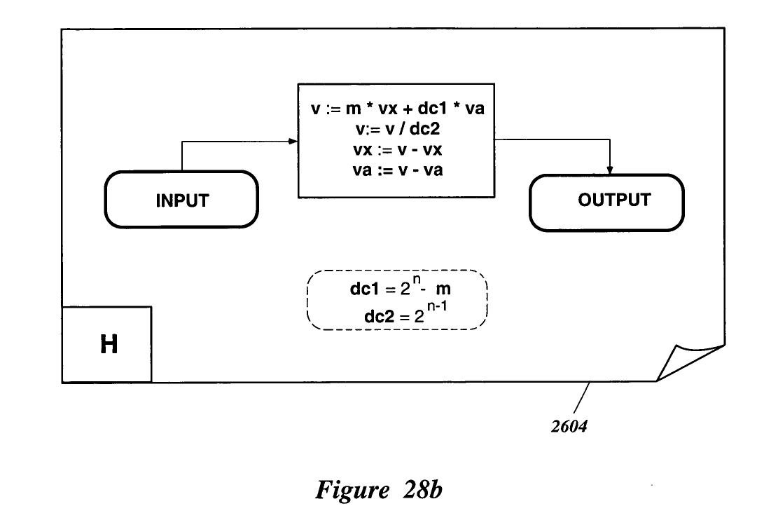

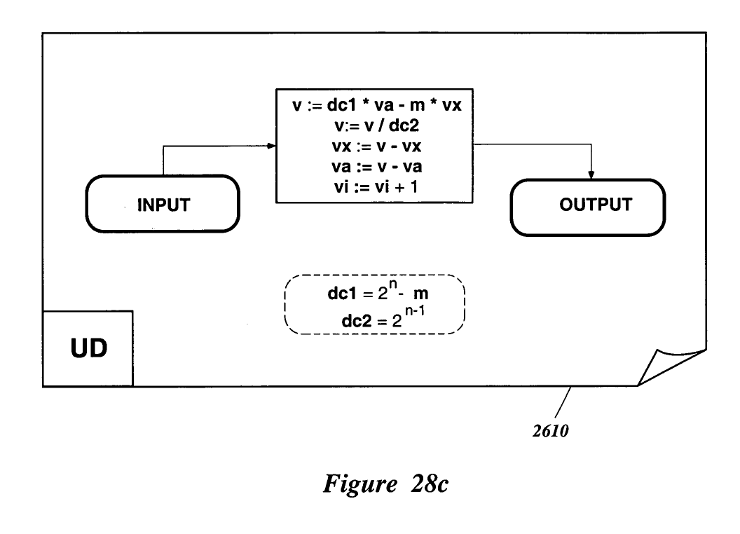

The quantum step block UD 2610 that emulates the entanglement and interference operators is shown on FIGS. 28a-c. The UD block 2610 reduces of the temporal complexity of the quantum algorithm simulation to linear dependence on the number of executed iterations. The UD block 2610 uses ore-calculated table values dc1=2ⁿ−m and dc2=2ⁿ⁻¹. In the U block 2603 shown in FIG. 28a, vx:=−vx and vi:=vi+1. In the D block 2604 shown in FIG. 28b, v:=m*vx+dc1*va, v:=v/dc2, vx:=v=vx, and va:=v−va in the UD block shown in FIG. 28c, v:=dc1*va=m*vx, v:=v/dc2, vx:=v+vx, va:=v−va, and vi:=vi+1.

The termination block T 2605 is general for all quantum algorithms, independently of the operator matrix realization. Block T 2605 provides intelligent termination condition for the search process. Thus, the block T 2605 controls the number of iterations through the block UD 2610 by providing enough iterations to achieve a high probability of arriving at a correct answer to the search problem. The block T 2605 uses a rule based on observing the changing of the vector element values according to two classification categories. The T block 2605 during a number of iterations, watches for values of elements of the same category monotonically increase or decrease while values of elements of another category changed monotonically in reverse direction. If after some number of iteration the direction is changed, it means that an extremum point corresponding to a state with maximum or minimum uncertainty is passed. The process can proceed here using direct values of amplitudes instead of considering Shannon entropy value, thus, significantly reducing the required number of calculations for determining the minimum uncertainty state that guarantees the high probability of a correct answer. The Termination algorithm realized in the block T 2605 can use one or more of five different termination models:
Model 1: Stop after a predefined number of iterations;
Model 2: Stop on the first local entropy minimum;
Model 3: Stop on the lowest entropy within a predefined number of iterations;
Model 4: Stop on a predefined level of acceptable entropy; and/or
Model 5: Stop on the acceptable level or lowest reachable entropy within the predefined number of iterations.

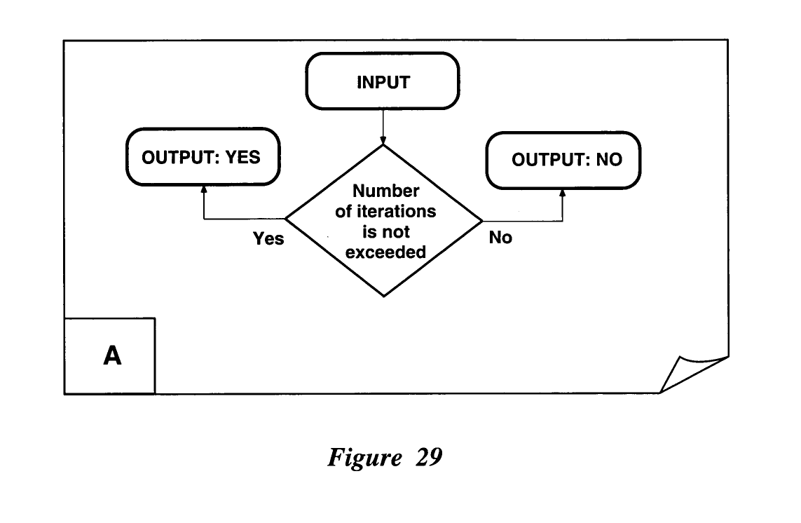

Note that models 1-3 do not require the calculation of an entropy value. FIGS. 29-31 show the structure of the termination condition blocks T 2605.

Since time efficiency is one of the major demands on such termination condition algorithm, each part of the termination algorithm is represented by a separate module, and before the termination algorithm starts, links are built between the modules in correspondence to the selected termination model by initializing the appropriate functions' calls.

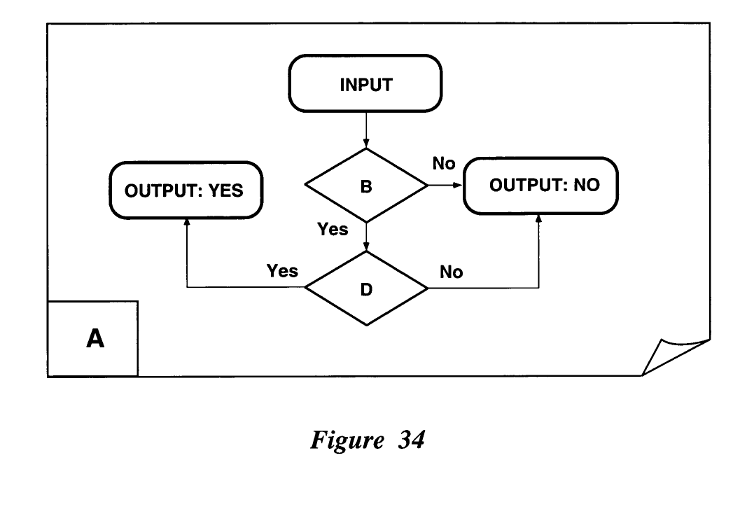

Table 3.2 shows components for the termination condition block T 2605 for the various models. Flow charts of the termination condition building blocks are provided in FIGS. 29-34

TABLE 3.2
Termination block construction

| Model | T | B′ | C′ |
|---|---|---|---|
| 1 | A | — | — |
| 2 | B | PUSH | — |
| 3 | C | A | B |
| 4 | D | — | — |
| 5 | C | A | E |

The entries A, B, PUSH, C, D, E, and PUSH in Table 5 correspond to the flowcharts in FIGS. 29, 30, 31, 32, 33, 34 respectively.

In model 1, only one test after each application of quantum step block UD is needed. This test is performed by block A. So, the initialization includes assuming A to be T, i.e., function calls to T are addressed to block A. Block A is shown in FIG. 29. As shown in FIG. 29, the A block checks to see if the maximum number of iterations has been reached, if so, then the simulation is terminated, otherwise, the simulation continues.

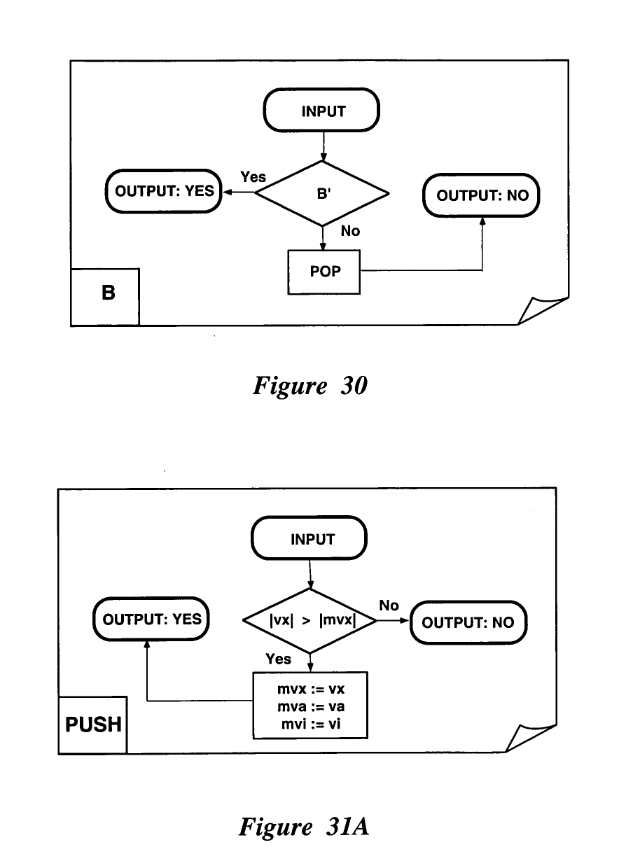

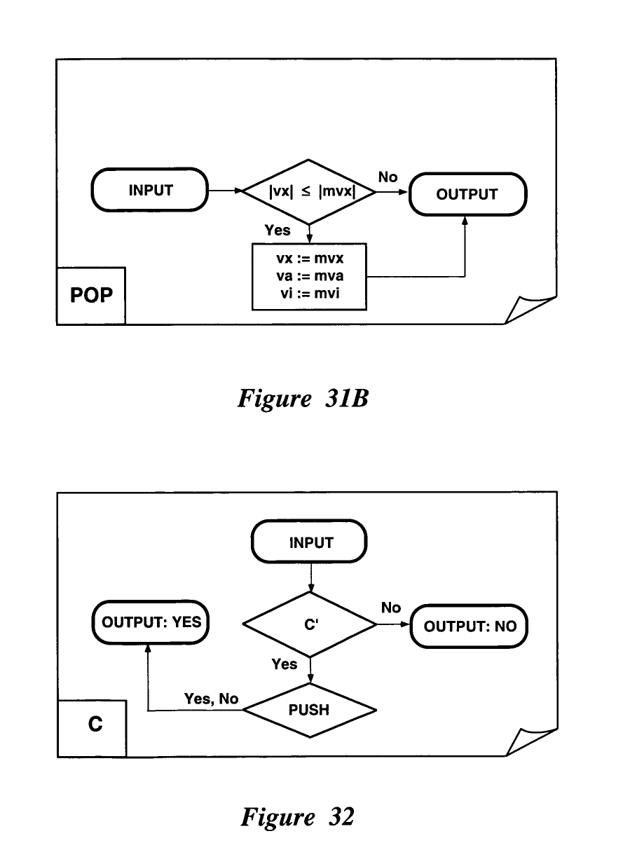

In model 2, the simulation is stopped when the direction of modification of categories' values are changed. Model 2 uses comparison of the current value of vx category with value mvx that represents this category value obtained in previous iteration:
(i) If vx is greater than mvx, its value is stored in mvx, the vi value is stored in mvi, and the termination block proceeding to the next quantum step.
(ii) If vx is less than mvx, it means that the vx maximum is passed and the process needs to set the current (final) value of vx :=o mvx, vi :=mvi, and stop the iteration process. So, the process stores the maximum of vx in mvx and the appropriate iteration number vi in mvi. Here block B, shown in FIG. 30 is used as the main block of the termination process. The block PUSH, shown in the FIG. 31a is used for performing the comparison and for storing the vx value in mvx (case a). A POP block, shown in FIG. 31b is used for restoring the mvx value (case b). In the PUSH block of FIG. 31a, if |vx|>|mvx|, then mvx:=vx, mva:=va, mvi:=vi, and the block returns true; otherwise, the block returns false. In the POP block of FIG. 31b, if |vx|<=|mvx|, then vx:=mvx, va:=mva, and vi:=mvi.

The model 3 termination block checks to see that a predefined number of iterations is not exceeded (using block A in FIG. 29):
(i) If the check is successful, then the termination block compares the current value of vx with mvx. If mvx is less than, it sets the value of mvx equal to vx and the value of mvi equal to vi. If mvx is less using the PUSH block, then perform the next quantum step.
(ii) If the check operation fails, then (if needed) the final value of vx equal to mvx, vi equal to mvi (using the POP block) and the iterations are stopped.

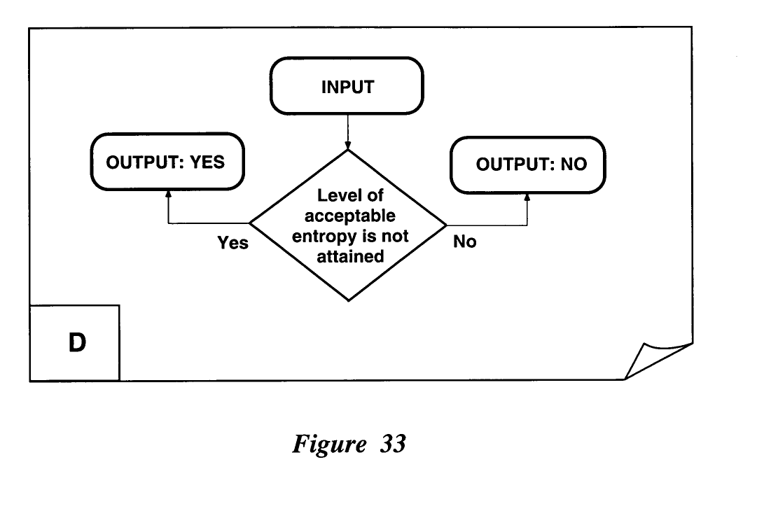

The model 4 termination block uses a single component block D, shown in FIG. 33. The D block compares the current Shannon entropy value with a predefined acceptable level. If the current Shannon entropy is less than the acceptable level, then the iteration process is stopped; otherwise, the iterations continue.

The model 5 termination block uses the A block to check that a predefined number of iterations is not exceeded. If the maximum number is exceeded, then the iterations are stopped. Otherwise, the D block is then used to compare the current value of the Shannon entropy with the predefined acceptable level. If acceptable level is not attained, then the PUSH block is called and the iterations continue. If the last iteration was performed, the POP block is called to restore the vx category maximum and appropriate vi number and the iterations are ended.

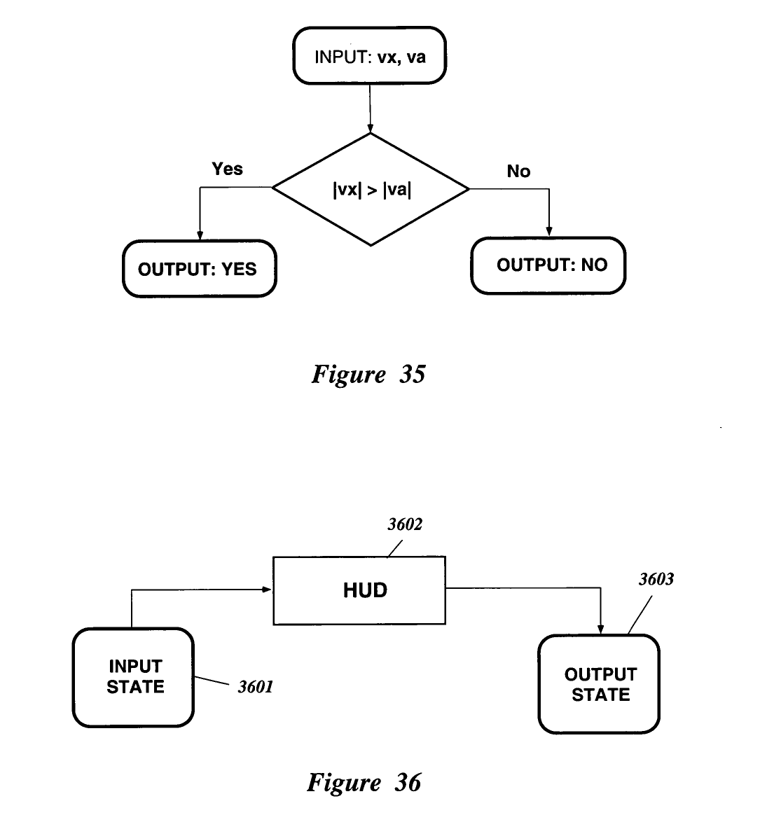

FIG. 35 shows measurement of the final amplitudes in the output state to determine the success or failure of the search. If |vx|>|va|, then the search was successful; otherwise, the search was not successful.

Table 3.3 lists results of testing the optimized version of Grover QSA simulator on personal computer with Pentium 4 processor at 2 GHz.

TABLE 3.3
High probability answers for Grover QSA

| Qbits | Iterations | Time |
|---|---|---|
| 32 | 51471 | 0.007 |
| 36 | 205887 | 0.018 |
| 40 | 823549 | 0.077 |
| 44 | 3294198 | 0.367 |
| 48 | 13176794 | 1.385 |
| 52 | 52707178 | 5.267 |
| 56 | 210828712 | 20.308 |
| 60 | 843314834 | 81.529 |
| 64 | 3373259064 | 328.274 |

The theoretical boundary of this approach is not the number of qubits, but the representation of the floating-point numbers. The practical bound is limited by the front side bus frequency of the personal computer.

Using the above algorithm, a simulation of a 1000 qubit Grover QSA requires only 96 seconds for 10⁸ iterations.

The above approach can be used for simulation of the Deutsch-Jozsa's QA. The general schema of Deutsch-Jozsa's QA simulation is shown on FIG. 36, where an input state 3601 is provided to a quantum HUD block 3602 which generates an output state 3603.

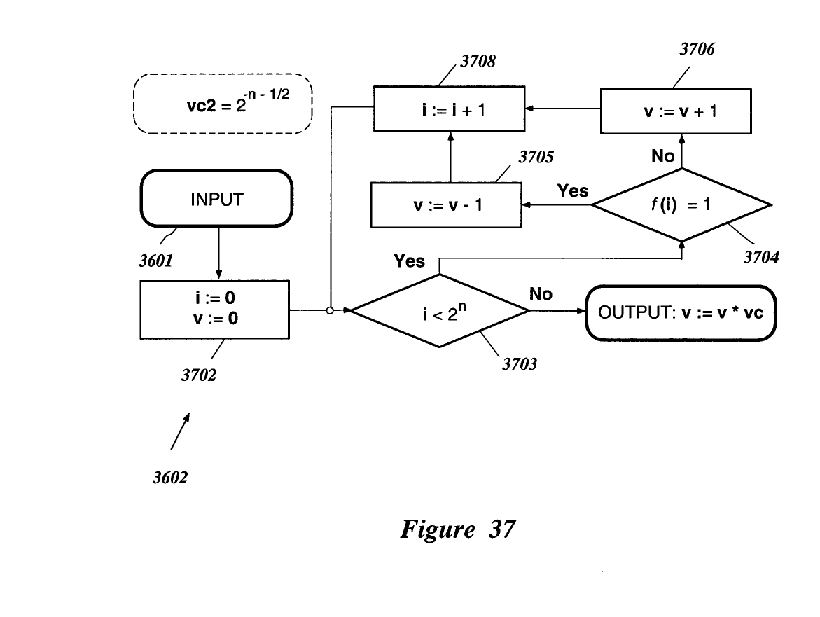

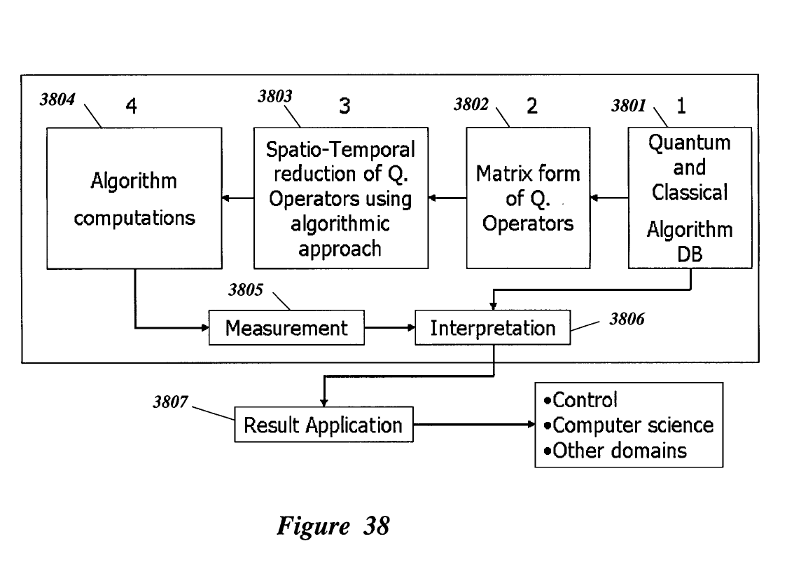

The structure of the HUD block 3602 is shown in FIG. 37, where the input 3601 is provided to an initialization block 3702. The initialization block 3702 sets i:=0 and v:=0, and then the process advances to a decision block 3703. In the decision block 3703, if i<2ⁿ, then the process advances to a decision block 3704; otherwise, the process advances to an output block which outputs v:=v*vc, where vc=2^{-n-1/2}.

The quantum block HUD 2610 is applied only once to obtaining of the final state. Here v represents the vector |0..00> amplitude, ƒ is an input function of order n, vc=2^{-n-1/2} is a table value. After applying the block HUD, the value of v is considered in correspondence with Table 3.4.

TABLE 3.4
Possible answers for Deutsch-Jozsa's problem

| Value of v | Answer |
|---|---|
| 0 | f is balanced |
| $\frac{1}{\sqrt{2}}$ | f is constant 0 |
| $- \frac{1}{\sqrt{2}}$ | f is constant 1 |
| Otherwise | f is something else |

4. General Software and Hardware Approach in QC Based on Fast Algorithm Simulation

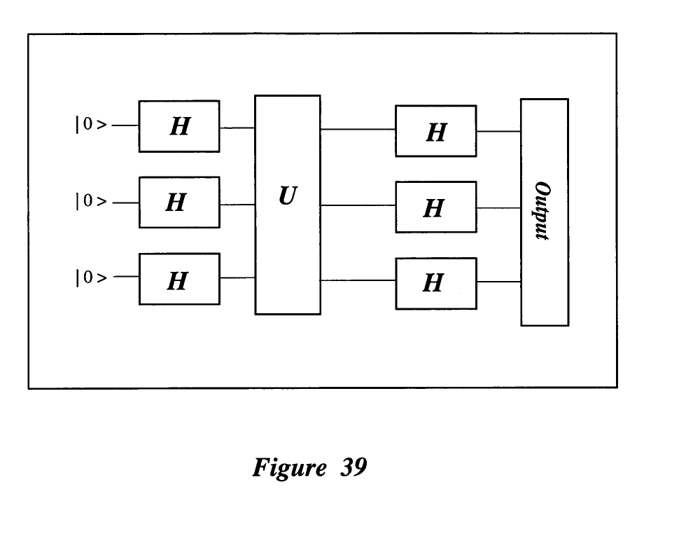

The structure of the generalized approach in QA simulation is shown in FIG. 39. From the available database of the QAs, its matrix representation is extracted. Then matrix operators are replaced with developed algorithmic or problem-oriented corresponding approaches, thus spatio-temporal characteristics of the algorithm will improve.

The simulation is then performed, and after obtaining final state vector, the measurement takes place in order to extract the result. Final results can be obtained by having the information about the algorithm and results of the measurement. After interpretation, results can be applied in the selected field of applications.

5. Simulation of Quantum Algorithms with Reduced Number of Quantum Operators: Application of Entanglement-Free Quantum Control Algorithm for Robust KB Design of FC

The simulation techniques described above for simulating quantum algorithms on classical computers permit design of new QAs, such as, for example, entanglement-free quantum control algorithms. The simulation of a QA can be made more efficient by arranging the QA to be entanglement-free. In one embodiment, the entanglement-free algorithm is used in the context of soft computing optimization for the design process of a robust Knowledge Base (KB) for a Fuzzy Controller (FC).

5.1. Models of Entanglement-Free Algorithms and Classical Efficient Simulation of Quantum Strategies without Entanglement.

Entanglement-free quantum speed-up algorithms are useful for many applications, including, but not limited to, simulation results in the robust KB-FC design process. The explanation of the entanglement-free quantum efficient algorithm begins with a statement of the following problem: Given an integer N function ƒ: x→mx+b, where x, m,b εZ_{N}, find m. The classical analysis reveals that no information about m can be obtained with only one evolution of the function ƒ. Conversely, given the unitary operator U_{ƒ} acting in a reversible way in the Hilbert space Hil_{N}\textcircled{×}Hil_{N} such that
U_{ƒ}|x>|y>=|x>|y+ƒ(x)>, (5.1)
(where the sum is to be interpreted as modulus N). A QA can be used to solve this problem with only one query to U_{ƒ}.

A QA structure for solving the above problem is described as follows. Take N=2ⁿ, being n the number of qubits. The QA for efficiently solving the above problem includes the following operations:
1. Prepare two registers of n qubits in the state |0 . . . >|ψ₁>εH_{N}\textcircled{×}H_{N}, where |ψ₁>=QFT(N)⁻¹|1>, and QFT(N)⁻¹ denotes the inverse quantum Fourier transform in a Hilbert space of dimension N.
2. Apply QFT (N) over the first register.
3. Apply U_{ƒ} over the whole quantum state.
4. Apply QFT(N)⁻¹ over the first register.
5. Measure the first register and output the measured value.

This QA leads to the solution of the problem. The analysis raises two observations concerning the way both entanglement and majorization behave in the computational process. In the first step of the algorithm, the quantum state is separable, noting that the QFT (and its inverse) are applied on a well-defined state in the computational basis leads to a perfectly separable state. Actually, this separability holds also step-by-step when the decomposition for the QFT is considered, such as the Coppersmith's decomposition. That is, the quantum state |0 . . . 0>|ψ₁> is un-entangled.

The second step of the algorithm corresponds to a QFT in the first register. This action leads to a step-by-step minorization of the probability distribution of the possible outcomes while it does not create any entanglement. Moreover, natural minorization is at work due to the absence of interference terms.

It can be verified that the quantum state

$$\vert {ψ}_{1} 〉 = \frac{1}{\sqrt{N}} {\sum }_{j = 0}^{N - 1} {ⅇ}^{- 2 π \frac{i}{N}} \vert j 〉 \qquad ( 5.2 )$$

is an eigenstate of the operator |y>→|y+ƒ(x)) with eigenvalue e^{2πiƒ(x)/N}.

After the third step, the quantum state reads

$$\frac{1}{\sqrt{N}} {\sum }_{j = 0}^{N - 1} {ⅇ}^{2 π i \frac{f ( x )}{N}} \vert {ψ}_{1} 〉 = \frac{{ⅇ}^{2 π i \frac{b}{N}}}{\sqrt{N}} {\underbrace{( {\sum }_{x = 0}^{N - 1} {ⅇ}^{2 π i \frac{mx}{N}} )}}_{First Register} \vert {ψ}_{1} 〉 \qquad ( 5.3 )$$

The probability distribution of possible outcomes has not been modified, thus not affecting majorization. Furthermore, the pure quantum state of the first register in Eq.(5.3) can be written as QFT (N) m) (up to a phase factor), so this step has not created any entanglement among the qubits of the system.

In the fourth step of the algorithm, the action of the operator QFT(N)⁻¹ over the first register leads to the state e^{2πib/N}|m>|ψ₁>.

A subsequent measurement in the computational basis over the first register provides the desired solution.

The inverse QFT naturally majorizes step-by-step the probability distribution attached to the different outputs. However, the separability of the quantum state still holds step-by-step.

The QA is more efficient than any of its possible classical counterparts, as it only needs a single query to the unitary operator U_{ƒ} to obtain the solution. One can summarize this analysis of majorization for the present QA as follows: The entanglement-free efficient QA for finding a hidden affine function shows a majorization cycle based on the action of QFT(N) and QFT(N)⁻¹.

It follows that there can exist a quantum computational speed-up without the use of entanglement. In this case, no resource increases exponentially. Yet, a majorization cycle is present in the process, which is rooted in the structure of both the QFT and the quantum state.

Quantum mechanics affects game theory, and game theory can be used to show classical-quantum strategy without entanglement. For certain games, a suitable quantum strategy is able to beat any classical strategy. It is possible to demonstrate design of quantum strategies without entanglement using two simple examples of entanglement-free games: the PQ-game and the card game.

Consider, for example, the penny flipping game PQ PEANY FLIP game. The game is penny flipping, where player P places a penny head up in a box, after which player Q, then player P, and finally player Q again, can choose to flip the coin or not, but without being able to see it. If the coin ends up being head up, player Q wins, otherwise player P wins. The winning (or cheating, depending upon one's perspective) quantum strategy of Q now involves putting the penny into a superposition of head up and down. Since player P is allowed to interchange only up and down he is not able to change that superposition, so Q wins the game by rotating the penny back to its initial state.

Q produces a penny and asks P to place it in a small box, head up. Then Q, followed by P, followed by Q, reaches into box, without looking at the penny, and either flips it over or leaves it as it is. After Q's second turn they open the box and Q wins if the penny is head up.

Q wins every time they play, using the following quantum game gate:

$$\vert {ψ}_{fin} 〉 = {\underbrace{H}}_{Q strategy} \cdot {\underbrace{{σ}_{x} ( {I}_{2} )}}_{P strategy} \cdot {\underbrace{H}}_{Q strategy} {\underbrace{\vert 0 〉}}_{Initial state}$$

and the following quantum strategy:

| Initial state and | | |
|---|---|---|
| strategy | Player strategy | Result of operation |
| $\vert 0 〉$ | ${⟶}_{H}^{Q}$ | $\frac{1}{\sqrt{2}} ( \vert 0 〉 + \vert 1 〉 )$ |
| Classical strategy | ${⟶}_{{σ}_{x} ( or {I}_{2} )}^{P}$ | $\frac{1}{\sqrt{2}} ( \vert 1 〉 + \vert 0 〉 ) or \frac{1}{\sqrt{2}} ( \vert 0 〉 + \vert 1 〉 )$ |
| Quantum strategy | ${⟶}_{H}^{Q}$ | $\vert 0 〉$ |

Here 0 denotes “head” and 1 denotes “tail”, and

$${σ}_{x} = ( \begin{matrix}0 & 1 \\ 1 & 0\end{matrix} ) ≡ NOT$$

implements P's possible action of flipping the penny over. Q's quantum strategy of putting the penny into the equal superposition of “head” and “tail” on his first turn means that whether P flips the penny over or not, it remains in an equal superposition which Q rotates back to “head” by applying the Hadamard transformation H again, since

$$H = {H}^{- 1} and \frac{1}{\sqrt{2}} ( \vert 1 〉 + \vert 0 〉 ) = \frac{1}{\sqrt{2}} ( \vert 0 〉 + \vert 1 〉 ) .$$

After measurement, Q receives the state |0>. The second application of the Hadamard transformation plays the role of constructive interference. So when they open the box, Q always wins without using entanglement.

If Q were restricted to playing classically, i.e., to implementing only σₓ or I₂ on his turns, an optimal strategy for both players would be to flip the penny over or not with equal probability on each turn. In this case, Q would win only half the time, so he does substantially better by playing quantum mechanically.

Now, consider the interesting case of a classical-quantum card game without entanglement. In the classical game, one player A can always win with the probability

$$\frac{2}{3} .$$

But if the other player B performs quantum strategy, he can increase his winning probability from

$$\frac{1}{3}$$

to

$$\frac{1}{2} .$$

In this case, B is allowed to apply quantum strategy and the original unfair game turns into a fair and zero-sum game, i.e., the unfair classical game becomes fair in the quantum world. In addition, this strategy does not use entanglement.

The classical model of the card game is explained as follows. A has three cards. The first card has one circle on both sides, the second has one dot on both sides, and the third card has one circle on one side and one dot on the other. In the first step, A puts the three cards into a black box. The cards are randomly placed in the box after A shakes it. Both players cannot see what happens in the box. In the second step, B takes one card from the box without flipping it. Both players can only see the upper side of the card. A wins one coin if the pattern of the down side is the same as that of the upper side and loses one coin when the patterns are different. It follows that A has a

$$\frac{2}{3}$$

probability of winning and B only has a

$$\frac{1}{3}$$

chance of winning. B is in a disadvantageous situation and the game is unfair to him. Any rational player will not play the game with A because the game is unfair. In order to attract B to play with him, before the original second step, A allows B to have one chance to operate on the cards. That is, B has one step query on the box. In the classical world, B can only attain one card information after the query. Because the card is in the box, so what B knows is only one upper side pattern of the three cards. Except for this, he knows nothing about the three cards in the black box. So in the classical field, even having this one step query, B still will be in a disadvantaged state and the game is still unfair.

Now consider the quantized approach to the card game. In the quantum field, the whole game is changed. The game turns into a fair zero-sum game and both players are in equal situation. Consider first the case when A uses the classical strategy and B uses the quantum strategy. In the first step, A puts the cards in the box and shakes the box, that is, he prepares the initial state randomly. The card state is |0> if the pattern in the upper side is circle and |1> if it is dot. So the upper sides of the three cards in the box can be described as |r>=|r₀>|r₁>|r₂>, where r₀, r₁, r₂ ε [symbol] 0,1 [symbol] , which means |r₀>, |r₁>, r₂> are all eigenstate superpositions of |0> and |1>.

After the first step of the game, A gives the black box to B. Because A thinks in classical way, in his mind B cannot get information about all upper side patterns of the three cards in the box. So A can still win with higher probability. But what B uses is quantum strategy: He replaces the classical one step query with one step quantum query. The following shows how B queries the box.

Assume that B has a quantum machine that applies an unitary operator U on its three input qubits and gives three output qubits. This machine depends on the state |r> in the box that A gives B. The explicit expression of U and its relation with |r> is as following U=U₀\textcircled{×}U₁\textcircled{×}U₂ where

$${U}_{k} = \{ \begin{matrix} {I}_{2} = ( \begin{matrix}1 & 0 \\ 0 & 1\end{matrix} ) if {r}_{k} = 0 \\ {σ}_{x} = ( \begin{matrix}1 & 0 \\ 0 & - 1\end{matrix} ) if {r}_{k} = 1\end{matrix} = ( \begin{matrix}1 & 0 \\ 0 & exp \{ ⅈπ {r}_{k} \}\end{matrix} ) .$$

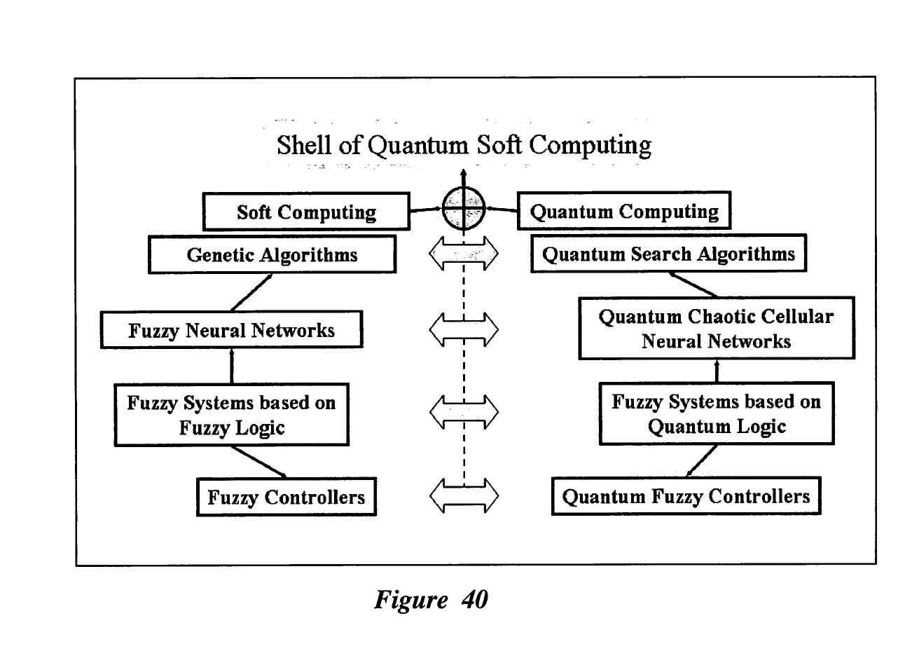

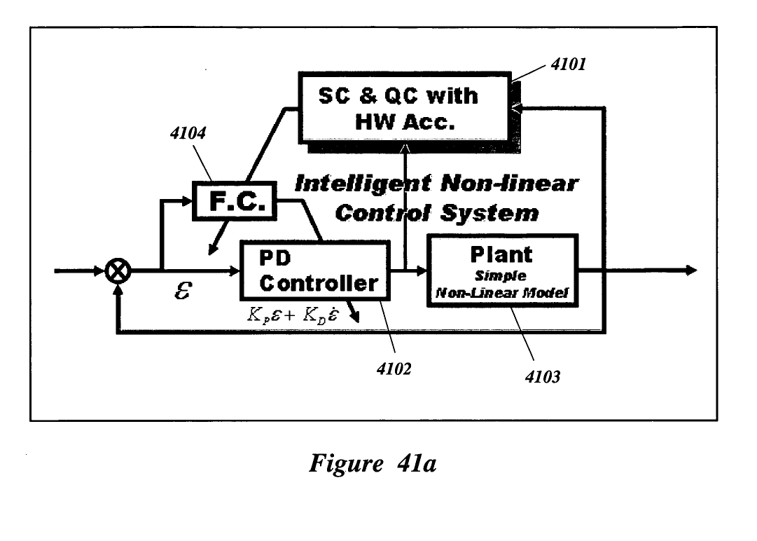

The processing of the query is shown in FIG. 40. After the process, the output state is
|ψ_{fin}>=(H\textcircled{×}H{circle around (×H)U(H\textcircled{×}H\textcircled{×}H)|000>=(HU₀H)|0>(HU₁H)|0>(HU₂H)|0>.

Because

$$H {U}_{k} H = \frac{1}{2} ( \begin{matrix}1 & 1 \\ 1 & - 1\end{matrix} ) ( \begin{matrix}1 & 0 \\ 0 & {ⅇ}^{ⅈπ {r}_{k}}\end{matrix} ) ( \begin{matrix}1 & 1 \\ 1 & - 1\end{matrix} ) = \frac{1}{2} ( \begin{matrix}1 + {ⅇ}^{ⅈπ {r}_{k}} & 1 - {ⅇ}^{ⅈπ {r}_{k}} \\ 1 - {ⅇ}^{ⅈπ {r}_{k}} & 1 + {ⅇ}^{ⅈπ {r}_{k}}\end{matrix} ) . \\ So$$

$$H {U}_{k} H \vert 0 〉 = \frac{1 + {ⅇ}^{ⅈπ {r}_{k}}}{2} \vert 0 〉 + \frac{1 - {ⅇ}^{ⅈπ {r}_{k}}}{2} \vert 1 〉 = \{ \begin{matrix}\vert 0 〉 if {r}_{k} = 0 \\ \vert 1 〉 if {r}_{k} = 1\end{matrix} = \vert {r}_{k} 〉$$

From the above equation, it follows that B can obtain the complete information about the upper patterns of all the three cards through one query. There are only two possible kinds of output states in the black box, which is |0>|0>|1> or |1>|1>|0>, that is two circles and one dot on the upper side or two dots and one circle. Assume that the state of the cards after the first step is two circles and one dot, i.e., |0>|0>|1>. After the one-step query, B knows the complete information about the upper patterns, but has no individual information about which upper pattern corresponds to which card. Then he takes one card out of the box to see what pattern is on the upper side. If B finds out that he is in a disadvantage situation, the upper pattern of the card is dot (|1>), he refuses to play with A in this turn because he knows the down side is dot definitely. Otherwise if the upper side pattern is circle (|0>), then he knows that the down side pattern is circle |0> or dot |1>. So he continues his turn because the probability of winning is

$$\frac{1}{2} .$$

B will continue the game because he has probability

$$\frac{1}{2}$$

to win. Hence, the game becomes fair and is also zero-sum.

One of the reasons why the quantum strategies in games are better than classical strategies is that the initial state is maximally entangled. The quantum strategy in the card game applied by B includes no entanglement and is still better than the classical strategy.

The initial state input to the quantum machine is |0>|0>|0>, which is separable. After the Hadamard transformation, the state is

$$\frac{1}{\sqrt{{2}^{3}}} ( \vert 0 〉 + \vert 1 \text{〉)} ⊗ ( \vert 0 〉 + \vert 1 \text{〉} \text{)} ⊗ ( \vert 0 〉 + \vert 1 〉 ) .$$

Performed by U, the state becomes

$$\frac{1}{\sqrt{{2}^{3}}} ( \vert 0 〉 + {ⅇ}^{ⅈ π {r}_{0}} \vert 1 \text{〉} \text{)} ⊗ ( \vert 0 〉 + {ⅇ}^{ⅈ π {r}_{1}} \vert 1 \text{〉} \text{)} ⊗ ( \vert 0 〉 + {ⅇ}^{ⅈ π {r}_{2}} \vert 1 〉 ) .$$

And the states, after the second Hadamard transformation, are in the output state |r₀>r₁>r₂>. The state is described by the tensor products of the states of the individual qubits, so it is unentangled. And because the operators (H and U) are also tensor products of the individual local operators on these qubits, in this quantum game there is no entanglement applied.

Entanglement is important for static games (such as the Prisoner's Dilemma) but may not be necessary in dynamic games (such as the PQ-game and the card game). In static games, each player can only control his qubit and his operation is local. So in the classical world, the operation of one player cannot have influence on others in the operational process. But in the quantum field, through entanglement, the strategy used by one player can influence not only himself, but also his opponents. In dynamic games, players can control all qubits at any step. So, as in QAs, in dynamic games, players can use quantum strategies without entanglement to solve problems, even entangled quantum strategies can be re-described with other quantum strategies without entanglement.

Thus, if B is given a quantum strategy (e.g., a quantum query) against his classical opponent A, the classical opponent cannot always win with high probability. Both players are on equal footing and the game is a fair zero-sum game. The quantum game includes no entanglement and quantum-over-classical strategy is achieved using only interference. Thus, quantum strategy can still be powerful without entanglement.

In general, the PQ game can be described as follows:

| Definition | Main operations |
|---|---|
| (i) | A Hilbert space H (the possible states of the game) with |
| | N = dim H |
| (ii) | An initial state ψ₀ ∈ H |
| (iii) | Subset Qᵢ ⊂ U (N), i ∈ {1, . . ., k + 1} - the elements of Qᵢ are |
| | the moves Q chooses among on turn i |
| (iv) | Subset Pᵢ ⊂ S_{N}, i ∈ {1, . . ., k}, where S_{N} is the permutation |
| | group on N elements - the elements of Pᵢ are the moves |
| | P chooses among on turn i |
| (v) | A projection operator Π on H (the subspace W_{Q} fixed by Π |
| | consists of the winning states for Q) |

Since only P and Q play, these are two-player games; they are zero-sum since when Q wins, P loses, and vice versa. A pure quantum strategy for Q is a sequence uᵢ ε Qᵢ. A pure (classical) strategy for P is a sequence sᵢ ε Pᵢ, while a mixed (classical) strategy for P is a sequence of probability distributions ƒᵢ:Pᵢ→[0,1]. If both Q and P play pure strategies, the corresponding evolution of the PQ-game is described by quantum game gate:

$$\vert {ψ}_{fin} \text{〉} = {\prod }_{k} {u}_{k + 1} {s}_{k} {u}_{k} \text{\vert} {ψ}_{i n} \text{〉} .$$

After Q's last move, the state of the game is measured with Π. According to the rules of quantum mechanics, the players observe the eigenvalue 1 with probability Tr(ψ^{†}Πψ); this is lo the probability that the state is projected into W_{Q} and Q wins. More generally, if P plays a mixed strategy, the corresponding evolution of the PQ-game is described by

$${ρ}_{f} = {u}_{k + 1} ( {\sum }_{{s}_{k} ∈ {P}_{k}} {f}_{k} ( {s}_{k} ) {s}_{k} {u}_{k} … {u}_{2} ( {\sum }_{{s}_{1} ∈ {P}_{1}} {f}_{1} ( {s}_{1} ) {s}_{1} {u}_{1} {ρ}_{0} {u}_{1}^{†} {s}_{1}^{†} ) {u}_{2}^{†} … {u}_{k}^{†} {s}_{k}^{†} ) {u}_{k + 1}^{†} ,$$

where ρ₀=|ψ₀>\textcircled{×}<ψ₀^{†}|. Again, after Q's last move ρ_{ƒ} is measured with Π; the probability that ρ_{ƒ} is projected into W_{Q}\textcircled{×}W_{q}^{†} and Q wins is Tr (Πρ_{ƒ}). 1 5 An equilibrium state is a pair of strategies, one for P and one for Q, such that neither player can improve his probability of winning by changing his strategy while the other does not. In general, unlike the simple case of the PQ-game, W_{Q}=W_{Q}( [symbol] sᵢ [symbol] ) or W_{Q}=W_{Q}( [symbol] ƒᵢ [symbol] ), i.e., the conditions for Q's win can depend on P's strategy. There are mixed/quantum equilibria at which Q does better than he would at any mixed/mixed equilibrium; there are some QAs, which outperform classical ones.
5.2. Interrelations Between QAs and Quantum Games Structures.

A QA for an oracle problem can be understood as a quantum strategy for a player in a two-player zero-sum game in which the other player is constrained to play classically. This correspondence can be formalized and the following development gives examples of games (and hence, oracle problems) for which the quantum player can do better than that would be possible classically. In the general case, entanglement (or some replacement resource) is required. However, an efficient quantum search of a “sophisticated” database requires no entanglement at any time step. A quantum-over-classical reduction in the number of queries is achieved using only interference, not entanglement, within the usual model of quantum computation.

TABLE 5.1
Oracle functions

| Number | Title of oracle | Type | Definition |
|---|---|---|---|
| 1 | The phase oracle | P_{f} | $\vert x 〉 \vert b 〉 \to exp \{ \frac{2 π if ( x ) \cdot b}{{2}^{n}} \} \vert x 〉 \vert b 〉$ |
| 2 | The standard oracle | S_{f} | $\vert x 〉 \vert b 〉 \to \vert x 〉 \vert b ⊕ f ( x ) 〉$ |
| 3 | The minimal (an erasing) oracle | M_{f} | $\vert x 〉 \to \vert f ( x ) 〉$ |

Returning to the quantum oracle evaluation of multi-valued Boolean functions discussed in section 3, consider a multi-valued function F that is one-to-one and where the size of its domain and range is the same. The problem can be formulated as follows: Given an oracle
ƒ(a, x): [symbol] 0,1 [symbol] ⁿ× [symbol] 0,1 [symbol] ⁿ→ [symbol] 0,1 [symbol]
and a fixed (but hidden) value a₀, obtain the value of a₀ by querying the oracle ƒ(a₀, x). The algorithm evaluates the multi-valued Boolean function F through oracle calls and the main goal is to minimize the number of such oracle calls (the query complexity) using a quantum mechanism.

Query complexity is one of the issues in quantum computation, especially in proving lower bounds of QAs with oracles. Generally speaking, there are two popular techniques to derive quantum lower bounds: (i) polynomials; and (ii) adversary methods. For the bounded error case, evaluations of AND and OR functions need Θ(√\overline{N}) number of queries, while parity and majority functions at least

$$\frac{N}{2}$$

and Θ(N), respectively. Alternatively, define

$$F ( {x}_{0} , … , {x}_{N - 1} ) = \{ \begin{matrix}a if {x}_{a} = 1 and {x}_{j} = 0 for all j \neq a \\ undefined otherwise\end{matrix}$$

then evaluating this function F is the same as Grover's QSA. Moreover, if one defines

$$F ( {x}_{0} , … , {x}_{N - 1} ) = \{ \begin{matrix}a if {x}_{a} = a \cdot i ( mod 2 ) for all 0 \leq i \leq N - 1 \\ undefined otherwise\end{matrix}$$

then this is the same as the so-called Bernstein-Varzirani problem. Some lower bounds are easier to obtain using the quantum adversary method than the polynomials one. The lower bound of a bounded-error quantum query complexity of read-once functions is Ω(√\overline{N}).

Quantum evaluation assumes that it is possible to obtain the value of variable xᵢ only through an oracle O (i). Since both functions are one-to-one, and their domain and range are of the same size, it is possible to formulate the problem as follows.

Let n be an integer ≧1 and N=2ⁿ. Then, given an oracle defined as a function
ƒ(a,x): [symbol] 0,1 [symbol] ⁿ× [symbol] 0,1 [symbol] ⁿ→ [symbol] 0,1 [symbol]
such that ƒ(a,x)≠ƒ(a₂,x) for some x if a₁≠a₂, and a fixed (and hidden) value a, it is desired to obtain the value a, using the oracle ƒ(a, x).

For the Grover QSA, the definition

$$f ( x , a ) = \{ \begin{matrix}1 \\ 0 ,\end{matrix} \begin{matrix}if x = a \\ otherwise\end{matrix} ,$$

completely specifies the problem. This oracle is sometimes called the exactly quantum (EQ) oracle and is denoted by EQₐ(x). Table 5.2 shows the case ƒ(x, a)=EQₐ(x) for n=4.

As can be seen from Table 5.2, ƒ(a, x) is given by a truth-table of size N×N, where each row gives the function F of the previous definition. For example, F (1, 0, . . . , 0)=0000 from the first row of the Table 5.2. If the hidden value a is 0010 for example, the oracle returns value 1 only when it is queried with x=0010 .

For the Bernstein-Vazirani problem, the similar definition is given as
ƒ(a, x)=a·x(mod 2),

which is called the inner product (IP) oracle and denoted by IPₐ (x). Its truth-table for n=4 is given in Table 5.3.

TABLE 5.2

| | x | | | |
|---|---|---|---|---|
| a | $\begin{matrix}0 & 0 & 0 & 0 \\ 0 & 0 & 0 & 0 \\ 0 & 0 & 1 & 1 \\ 0 & 1 & 0 & 1\end{matrix}$ | $\begin{matrix}0 & 0 & 0 & 0 \\ 1 & 1 & 1 & 1 \\ 0 & 0 & 1 & 1 \\ 0 & 1 & 0 & 1\end{matrix}$ | $\begin{matrix}1 & 1 & 1 & 1 \\ 0 & 0 & 0 & 0 \\ 0 & 0 & 1 & 1 \\ 0 & 1 & 0 & 1\end{matrix}$ | $\begin{matrix}1 & 1 & 1 & 1 \\ 1 & 1 & 1 & 1 \\ 0 & 0 & 1 & 1 \\ 0 & 1 & 0 & 1\end{matrix}$ |
| $\begin{matrix}0 & 0 & 0 & 0 \\ 0 & 0 & 0 & 1 \\ 0 & 0 & 1 & 0 \\ 0 & 0 & 1 & 1\end{matrix}$ | $( \begin{matrix}1 & 0 & 0 & 0 \\ 0 & 1 & 0 & 0 \\ 0 & 0 & 1 & 0 \\ 0 & 0 & 0 & 1\end{matrix} ) ≡ I$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ |
| $\begin{matrix}0 & 1 & 0 & 0 \\ 0 & 1 & 0 & 1 \\ 0 & 1 & 1 & 0 \\ 0 & 1 & 1 & 1\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $( \begin{matrix}1 & 0 & 0 & 0 \\ 0 & 1 & 0 & 0 \\ 0 & 0 & 1 & 0 \\ 0 & 0 & 0 & 1\end{matrix} ) ≡ I$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ |
| $\begin{matrix}1 & 0 & 0 & 0 \\ 1 & 0 & 0 & 1 \\ 1 & 0 & 1 & 0 \\ 1 & 0 & 1 & 1\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $( \begin{matrix}1 & 0 & 0 & 0 \\ 0 & 1 & 0 & 0 \\ 0 & 0 & 1 & 0 \\ 0 & 0 & 0 & 1\end{matrix} ) ≡ I$ | $\begin{matrix}0 & 0 & 0 & 0 \\ 0 & 0 & 0 & 0 \\ 0 & 0 & 0 & 0 \\ 0 & 0 & 0 & 0\end{matrix}$ |
| $\begin{matrix}1 & 1 & 0 & 0 \\ 1 & 1 & 0 & 1 \\ 1 & 1 & 1 & 0 \\ 1 & 1 & 1 & 1\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $\begin{matrix}0 & 0 & 0 & 0 \\ 0 & 0 & 0 & 0 \\ 0 & 0 & 0 & 0 \\ 0 & 0 & 0 & 0\end{matrix}$ | $( \begin{matrix}1 & 0 & 0 & 0 \\ 0 & 1 & 0 & 0 \\ 0 & 0 & 1 & 0 \\ 0 & 0 & 0 & 1\end{matrix} ) ≡ I$ |

The above assumed that the domain of the Boolean function has the same size as its range. More general cases, e.g., the size of the range is larger than the domain, will be mentioned briefly below.

The quantum query complexity is a function of the number of oracle calls needed to obtain the hidden value a. The query complexity for the EQ-oracle is Θ(√\overline{N}), while only O(1) for the IP-oracle. A difference exist between the EQ- and IP-oracles. The difference can be shown by comparing their truth-tables given in Tables 5.21 and 5.32, where Table 5.3 shows a truth-table for

$$f ( x , a ) = {IP}_{a} = \{ a \cdot x = {\sum }_{i} {a}_{i} \cdot {x}_{i} ( mod 2 ) \} , n = 4.$$

One can immediately see

TABLE 5.3
x

| | | | | |
|---|---|---|---|---|
| a | $\begin{matrix}0 & 0 & 0 & 0 \\ 0 & 0 & 0 & 0 \\ 0 & 0 & 1 & 1 \\ 0 & 1 & 0 & 1\end{matrix}$ | $\begin{matrix}0 & 0 & 0 & 0 \\ 1 & 1 & 1 & 1 \\ 0 & 0 & 1 & 1 \\ 0 & 1 & 0 & 1\end{matrix}$ | $\begin{matrix}1 & 1 & 1 & 1 \\ 0 & 0 & 0 & 0 \\ 0 & 0 & 1 & 1 \\ 0 & 1 & 0 & 1\end{matrix}$ | $\begin{matrix}1 & 1 & 1 & 1 \\ 1 & 1 & 1 & 1 \\ 0 & 0 & 1 & 1 \\ 0 & 1 & 0 & 1\end{matrix}$ |
| $\begin{matrix}0 & 0 & 0 & 0 \\ 0 & 0 & 0 & 1 \\ 0 & 0 & 1 & 0 \\ 0 & 0 & 1 & 1\end{matrix}$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ |
| $\begin{matrix}0 & 1 & 0 & 0 \\ 0 & 1 & 0 & 1 \\ 0 & 1 & 1 & 0 \\ 0 & 1 & 1 & 1\end{matrix}$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}1 & 1 & 1 & 1 \\ 1 & 0 & 1 ⌉ & 0 \\ 1 & ⌊ 1 & 0 & 0 \\ 1 & 0 & 0 & 1\end{matrix} )$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}1 & 1 & 1 & 1 \\ 1 & 0 & 1 ⌉ & 0 \\ 1 & ⌊ 1 & 0 & 0 \\ 1 & 0 & 0 & 1\end{matrix} )$ |
| $\begin{matrix}1 & 0 & 0 & 0 \\ 1 & 0 & 0 & 1 \\ 1 & 0 & 1 & 0 \\ 1 & 0 & 1 & 1\end{matrix}$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}1 & 1 & 1 & 1 \\ 1 & 0 & 1 ⌉ & 0 \\ 1 & ⌊ 1 & 0 & 0 \\ 1 & 0 & 0 & 1\end{matrix} )$ | $( \begin{matrix}1 & 1 & 1 & 1 \\ 1 & 0 & 1 ⌉ & 0 \\ 1 & ⌊ 1 & 0 & 0 \\ 1 & 0 & 0 & 1\end{matrix} )$ |
| $\begin{matrix}1 & 1 & 0 & 0 \\ 1 & 1 & 0 & 1 \\ 1 & 1 & 1 & 0 \\ 1 & 1 & 1 & 1\end{matrix}$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ | $( \begin{matrix}1 & 1 & 1 & 1 \\ 1 & 0 & 1 ⌉ & 0 \\ 1 & ⌊ 1 & 0 & 0 \\ 1 & 0 & 0 & 1\end{matrix} )$ | $( \begin{matrix}1 & 1 & 1 & 1 \\ 1 & 0 & 1 ⌉ & 0 \\ 1 & ⌊ 1 & 0 & 0 \\ 1 & 0 & 0 & 1\end{matrix} )$ | $( \begin{matrix}0 & 0 & 0 & 0 \\ 0 & ⌈ 1 & 0 & 1 \\ 0 & 0 & 1 ⌋ & 1 \\ 0 & 1 & 1 & 0\end{matrix} )$ |

The table for IPₐ is well-balanced in terms of the numbers of 0's and 1's, but quite unbalanced for EQₐ. The natural consequence is that there should be intermediate oracles between those extreme cases for which the query complexity is also intermediate between Θ(√\overline{N}) and O(1). Furthermore, these intermediate oracles can be characterized by some parameter in such a way that the query complexity depends upon this parameter value and both EQₐ and IPₐ are obtained as special cases.

For these two oracles, the EQ-oracle (defined as f (a, x)=1 iff x=a) and the IP-oracle (defined as ƒ(a,x)=a·x mod2 ), the query complexity is Θ(√\overline{N}) for the EQ-oracle while only O(1) for the IP-oracle. To investigate what causes this large difference, the parameter K can be introduced as the maximum number of 1's in a single column of T_{ƒ} where T_{ƒ} is the N×N truth-table of the oracle ƒ(a, x). The quantum complexity is strongly related to this parameter K.

To develop models and estimation of quantum lower/upper bounds, let T_{ƒ} be the truth-table of an oracle ƒ(a,x) like the oracles given in Tables 5.2 and 5.3. Assume without loss of generality that the number of 1's is less than or equal to the number of 0's in each column of T_{ƒ}. Let #ᵢ(T_{ƒ}) denote the number of 1's

$$( \leq \frac{N}{2} )$$

in the i-th column of T_{ƒ} and #(T_{ƒ})=max₁ #ᵢ(T_{ƒ}). This single parameter #(T_{ƒ}) plays a key role, namely: (i) Let ƒ(a, x) be any oracle and K=#(T_{ƒ}). Then the query complexity of the search problem for ƒ(a,x) is

$$Ω ( \sqrt{\frac{N}{K}} ) ;$$

This lower bound is tight in the sense that it is possible to construct an explicit oracle whose query complexity is

$$O ( \sqrt{\frac{N}{K}} ) .$$

This oracle again includes both EQ and IP oracles as special cases; (iii) The tight complexity,

$$Θ ( \frac{N}{K} + log K ) ,$$

is also obtained for the classical case. Thus, the QA needs a quadratically fewer number of oracle calls when K is small and this merit become larger when K is large, e.g., log K versus a constant when K=cN.

The quantum oracle models and reduction of query number problems frame the context for the discussion for the database search problem, that is, to identify a specific record in a large database. Formally, records are labeled [symbol] 0,1, . . . , N−1 [symbol] where, for convenience when writing the numbers in binary, it is convenient to take N=2ⁿ where n is a positive integer. In one embodiment, a quantum database search involves a database in which, when queried about a specific number, the oracle responds only that the guess is correct or not. On a classical reversible computer, one can implement a query by a pair of register (x,b), where x is an n-bit string representing the guess, and b is a single bit which the database will use to respond to the query. If the guess is correct, the database responds by adding 1(mod2) to b ; if it is incorrect, it adds 0 to b. That is, the response of the database is the operation: |x>|b>→|x>|b⊕ƒₐ(x)>, where ƒₐ(x)=1 when x=a, 0 otherwise. Thus, if b changes, one knows that the guess is correct. Classically, it takes N−1 queries to solve this problem with probability 1.

The following oracles are defined in Table 5.4 for a general function ƒ: [symbol] 0,l [symbol] ^{m} → [symbol] 0,1 [symbol] ⁿ. Here x and b are strings of m and n bits respectively, |x> and |b> the corresponding computational basis states, and ⊕ is addition modulo 2ⁿ. The oracles P_{ƒ} and S_{ƒ} are equivalent in power: each can be constructed by a quantum circuit containing just one copy of the other. Assuming m=n and assuming ƒ is a known permutation on the set [symbol] 0,1 [symbol] ⁿ then M_{ƒ} is a simple invertible quantum map associated to ƒ. Intuitively, erasing oracles seem at least as strong as standard ones, though it is not clear how to simulate the latter with the former without also having access to an oracle that map |x> to |ƒ⁻¹(x)>. One-way functions provide a clue: if ƒ is one-way, then (by assumption) |x>|ƒ(x)> can be computed efficiently, but if |ƒ(x)> could be computed efficiently given |x> then so could |x> given |ƒ(x)>, and hence ƒ could be inverted. For some problems, an exponential gap between query complexity given a standard oracle and query complexity given an erasing oracle.

QAs work by supposing that they will be realized in a quantum system, which can be in a superposition of “classical” states. These states form a basis for the Hilbert space whose elements represent states of the quantum system. More generally, Grover's QSA works with quantum queries which are linear combinations Σc_{x,b}|x,b>, where c_{x,b} are complex numbers satisfying Σ|c_{x,b}|²=1. The operations in QAs are unitary transformations, the quantum mechanical generalization of reversible classical operations. Thus, the operation of the database that Grover considered is implemented on superpositions of queries by a unitary transformation, which takes |x,b> to |x>|b⊕ƒₐ(x)>. By using

$$⌊ \frac{π}{4} \sqrt{N} ⌋$$

quantum queries, it identifies the answer with probability close to 1: The final vectors for the N possible answers a are nearly orthogonal.

Consider one of the guessing game type that uses Grover's QSA for guessing of any number between 0 and N−1 and to discuss the role of different quantum oracle models in the reduction of query number. Assume, in PQ-game, the player Q boasts that if P picks any number between 0 and N−1, inclusive, he can guess it. P knows the Grover's QSA and realizes that for N=2ⁿ, the player Q can determine the number he picks with high probability by playing the following strategy:

TABLE 5.4

| | | | | |
|---|---|---|---|---|
| $\vert 0 …0 , 0 〉$ | ${⟶}_{{H}^{⊗ n} ⊗ H {σ}_{x}}^{Q}$ | $\frac{1}{\sqrt{N}} {\sum }_{x 00}^{n - 1} \vert x 〉 ⊗ \frac{1}{\sqrt{2}} ( \vert 0 〉 - \vert 1 〉 )$ | $⇒$ | (u₁) |
| | ${⟶}_{s ( {f}_{a} )}^{P}$ | $\begin{matrix}\frac{1}{\sqrt{N}} {\sum }_{x = 0}^{n - 1} {( - 1 )}^{{δ}_{xa}} \\ \\ \vert x 〉 ⊗ \frac{1}{\sqrt{2}} ( \vert 0 〉 - \vert 1 〉 )\end{matrix}$ | $⇒$ | (s₁) |
| | ${⟶}_{{H}^{⊗ n} ⊗ {I}_{2} ∘ s ( {f}_{0} ) ∘ {H}^{⊗ n} ⊗ {I}_{2}}^{Q}$ | . . . , | $⇒$ | (u₂) |

using the following quantum game gate:
G=[H^{\textcircled{×}n}\textcircled{×}I₂∘s(ƒ₀)∘H^{\textcircled{×}n}\textcircled{×}I₂]∘s(ƒₐ)∘[H^{\textcircled{×}n}\textcircled{×}Hσₓ]
which can be efficiently simulated using classical computer. Where a ε[0,N−1] is P's chosen number, moves (s₁) and (u₂) are repeated a total of

$$k = ⌊ \frac{π}{4} \sqrt{N} ⌋$$

times, i.e., (sₖ= . . . =s₁) and (uₖ= . . . =u₂). For ƒ:Z₂ⁿ→Z₂, the oracle s(ƒ) is the permutation (and hence unitary transformation) defined by (see Table 5.4) s(ƒ)|x,b>=|x,b⊕ƒ(x)>. Each P's moves sᵢ can be thought of as the response of an oracle, which computes ƒₓ(x):=δₓₐ to respond to the quantum query defined by the state after the action of quantum strategy (uᵢ). After O(√\overline{N}) such queries, a measurement by Π=|a><a|\textcircled{×}I₂ returns a win for Q with probability bounded above

$$\frac{1}{2} ,$$

i.e., Grover's QSA determines a with high probability.

If Q were to play classically, he could query P about a specific number at each time, but on the average it would take

$$\frac{N}{2}$$

turns to guess a. A classical equilibrium is for P to choose a random, and for Q to choose a permutation of N=2ⁿ uniformly at random and guess numbers in the corresponding order. Even when P plays such a mixed strategy, Q's quantum strategy is optimal; together they define a mixed / quantum equilibrium.

Knowing all this, P responds that he will play, but that Q should only get one guess, not

$$k = ⌊ \frac{π}{4} \sqrt{N} ⌋ .$$

Q protests that this is hardly fair, but he will play, as long as P tells how close his guess is to the chosen number. P agrees, and they play. Q wins every step.

In this case, Q uses a slightly improved Berstein-Vazirani algorithm: Guess x and answer a are vectors in Z₂ⁿ, so x·a depends on the cosine of the angle between these vectors. Thus, it seems reasonable to define the oracle “how close a guess is to the answer” to be the oracle response ƒₐ(x) [symbol] gₐ(x):=x·a. Then Q plays as follows:

| | | | | |
|---|---|---|---|---|
| $\vert 0 …0 , 0 〉$ | ${⟶}_{{H}^{⊗ n} ⊗ H {σ}_{x}}^{Q}$ | $\frac{1}{\sqrt{N}} {\sum }_{x 00}^{n - 1} \vert x 〉 ⊗ \frac{1}{\sqrt{2}} ( \vert 0 〉 - \vert 1 〉 )$ | $⇒$ | (u₁) |
| | ${⟶}_{s ( {g}_{a} )}^{P}$ | $\frac{1}{\sqrt{N}} {\sum }_{x = 0}^{n - 1} {( - 1 )}^{x \cdot a} \vert x 〉 ⊗ \frac{1}{\sqrt{2}} ( \vert 0 〉 - \vert 1 〉 )$ | $⇒$ | (s₁) |
| | ${⟶}_{{H}^{⊗ n} ⊗ {I}_{2}}^{Q}$ | $\vert a 〉 ⊗ \frac{1}{\sqrt{2}} ( \vert 0 〉 - \vert 1 〉 )$ | $⇒$ | (u₂) |

using the following (more simple) quantum game gate: G=[H^{e,crc ×}n\textcircled{×}I₂]∘gₐ(x)∘[H^{\textcircled{×}n}\textcircled{×}Hσₓ]. For Π=|a><a|\textcircled{×}I₂ again, Q wins with probability 1, having queried P only once.

The oracle, which responds in the Berstein-Vazirani algorithm with x·a (mod2), is a “sophisticated database” by comparison with Grover's oracle in QSA, which only responds that a guess is correct or incorrect. And finally, entanglement is not required in the Berstein-Vazirani QA for quantum-over-classical improvement. The improved version of the Berstein-Vazirani algorithm does not create entanglement at any time step, but still solves this oracle problem with fewer queries than is possible classically.

Quantum computing manipulates quantum information by means of unitary transformations, such as superpositions. For instance, a single-qubit Walsh-Hadamard operation H transforms a qubit from |0> to |+> and from |1> to |−>. When H is applied to a superposition such as |+>, it follows by the linearity of quantum mechanics that the resulting state is ½ [symbol] (|0>+|1>)+(|0>−|1>) [symbol] =0. This illustrates the phenomenon of destructive interference, by which component |1> of the state is erased. Consider now an n-qubit quantum register initialized to |0ⁿ>. Applying a Walsh-Hadamard transform to each of these qubits yields an equal superposition of all n-bit classical states:

$$\vert {0}^{n} 〉 {\to }^{H} \frac{1}{\sqrt{{2}^{n}}} {\sum }_{x = 0}^{{2}^{n} - 1} \vert x 〉 .$$

Consider now a function ƒ: [symbol] 0,1 [symbol] ⁿ→ [symbol] 0,1 [symbol] , that maps n-bit strings to a single bit. On a quantum computer, because unitary transformations are reversible, it is natural to implement it as a unitary transformation U_{ƒ} that maps |x>|b> to |x>|b⊕ƒ(x)>, where x is an n-bit string, b is a single bit, and “⊕” denotes the Exclusive −OR (XOR). Schematically,

$$\vert x 〉 \vert b 〉 {\to }^{{U}_{f}} \vert x 〉 \vert b ⊕ f ( x ) 〉 .$$

Quantum computers can solve some problems exponentially faster than any classical computer provided the input is given as an oracle, even if bounded errors are allowed. In this model, some function ƒ: [symbol] 0,1 [symbol] ⁿ→ [symbol] 0,1 [symbol] is given as a black-box, which means that the only way to obtain knowledge about ƒ is to query the black-box on chosen inputs. In the corresponding quantum oracle model, a function ƒ is provided by a black-box that applies unitary transformation U_{ƒ} to any chosen quantum state, as described by:

$$\vert x 〉 \vert b 〉 {\to }^{{U}_{f}} \vert x 〉 \vert b ⊕ f ( x ) 〉 .$$

The goal of the algorithm is to learn some property of the function ƒ.

The linearity of quantum mechanics gives rise to quantum parallelism and two important phenomena, the first of which is quantum parallelism. It is possible to compute ƒ on arbitrarily many classical inputs by a single application of U_{ƒ} to a suitable superposition:

$${\sum }_{x} {α}_{x} \vert x 〉 \vert b 〉 {\to }^{{U}_{f}} {\sum }_{x} {α}_{x} \vert x 〉 \vert f ( x ) ⊕ b 〉 .$$

When this is done, the additional output qubit may become entangled with the input register;

The second phenomena is phase kick-back: The outcome of ƒ can be recorded in the phase of the input register rather than being XOR-ed to the additional output qubit:

$$\vert x 〉 \vert - 〉 {\to }^{{U}_{f}} {( - 1 )}^{f ( x )} \vert x 〉 \vert - 〉 ;$$

$${\sum }_{x} {α}_{x} \vert x 〉 \vert - 〉 {\to }^{{U}_{f}} {\sum }_{x} {{α}_{x} ( - 1 )}^{f ( x )} \vert x 〉 \vert - 〉 .$$

The fundamental questions in quantum computing are following:

The common measure of efficiency for computer algorithms is the amount of time required to obtain the solution as function of the input size. In the oracle context, this usually means the number of queries needed to gain a predefined amount of information about the solution. In contrast, one can fix a maximum number of oracle calls and to try to obtain as much Shannon information as possible about the correct answer. In this model, when a single oracle query is performed, the probability of obtaining the correct answer is better for the QA than for the optimal classical algorithm, and the information gained by that single query is higher. This is true even when no entanglement is ever present throughout the quantum computation and even when the state of the quantum computer is arbitrarily close to being totally mixed. QAs can be better than classical algorithms even when the state of the computer is almost totally mixed, which means that it contains an arbitrary small amount of information. It means that QAs can be better than classical algorithms even when no entanglement is present.

It is often believed that entanglement is essential for quantum computing. However, in many cases, quantum computing without entanglement is better than anything classically achievable, in terms the reliability of the outcome after a fixed number of oracle calls. It means that: (i) entanglement is not essential for all QAs; and (ii) some advantage of QAs over classical algorithms persists even when the quantum state contains an arbitrary small amount of information—that is, even when the state is arbitrarily close to being totally mixed.

A special quantum state known as a pseudo-pure state (PPS) can be used to describe entanglement-free quantum computation. PPS occurs naturally in the framework of Nuclear Magnetic Resonance (NMR) quantum computing. Consider any pure state |ψ> on n-qubits and some real number 0≦ε≦1. PPS has the following form:
ρ_{PPS}ⁿ≡ε|ψ><ψ|+(1−ε)I.

It is a mixture of a pure state |ψ> with the totally mixed state

$$I = \frac{1}{{2}^{n}} {I}_{{2}^{n}}$$

(where I₂_{ⁿ} denotes the identity matrix of order 2ⁿ). For example, the Werner state is a special case of PPS.

To understand why these states are called pseudo-pure, consider what happens if a unitary operation U is performed on state ρ=ρ_{PPS}ⁿ.

First, the purity parameter ε of the PPS is conserved under a unitary transformation, since

$$ρ {\to }^{U} U ρ {U}^{†}$$

and UI U^{†}=I , and
UρU^{†}=εU|ψ><ψ|U^{†}+(1−ε)UI U^{†=ε|φ><φ|+(}1−ε)I,
where |φ>=U|ψ>. In other words, unitary operations affect only the pure part of these states, leaving the totally mixed part unchanged and leaving the pure proportion ε intact.

For a PPS there exists some bias ε below which these states are never entangled. Thus, for any number n of qubits, a state ρ_{PPS}ⁿ is separable whenever

$$ɛ < \frac{1}{1 + {2}^{2 n - 1}} ,$$

regardless of its pure part |ψ>.

Consider the density matrix ρ_{PPS}ⁿ≡ε|ψ><ψ|+(1−ε)I. Its candidate ensemble probability satisfies

$$w ( {\vec{n}}_{1} , … , {\vec{n}}_{N} ) = \frac{1 - ɛ}{{( 4 π )}^{N}} + ɛ w ( {\vec{n}}_{1} , … , {\vec{n}}_{N} ) \geq \frac{1 - ɛ ( 1 + {2}^{2 N - 1} )}{{( 4 π )}^{N}} .$$

Therefore, ρ_{ε} is separable if

$$ɛ \leq \frac{1}{1 + {2}^{2 N - 1}} {\approx }_{N \to ∞} \frac{2}{{4}^{N}} .$$

Here again, the density matrices in the neighborhood of the maximally mixed matrices are separable, and one obtains a lower bound on the size of the separable neighborhood. For N≧4 the bound is better than the bound

$$ɛ \leq \frac{1}{{( 1 + {2}^{N - 1} )}^{N - 1}} .$$

One illustrative example is the Greenberger-Horne-Zeilinger (GHZ) state, a state of three qubits with density matrix

$$\begin{matrix}{ρ}_{GHZ} = \frac{1}{2} ( \vert 111 〉 + \vert 222 〉 ) ( 〈 111 \vert + 〈 222 \vert ) = \\ = \frac{1}{8} ( {1}_{2} ⊗ {1}_{2} ⊗ {1}_{2} + {1}_{2} ⊗ {σ}_{3} ⊗ {σ}_{3} + {σ}_{3} ⊗ {1}_{2} ⊗ {σ}_{3} + \\ {σ}_{3} ⊗ {σ}_{3} ⊗ {1}_{2} + {σ}_{1} ⊗ {σ}_{1} ⊗ {σ}_{1} - {σ}_{1} ⊗ {σ}_{2} ⊗ {σ}_{2} - \\ {σ}_{2} ⊗ {σ}_{1} ⊗ {σ}_{2} - {σ}_{2} ⊗ {σ}_{2} ⊗ {σ}_{1} ,\end{matrix}$$

which gives a representation

$$\begin{matrix}{w}_{GHZ} ( {\vec{n}}_{1} , … , {\vec{n}}_{N} ) = \frac{1}{{( 4 π )}^{3}} [ 1 + 9 ( {c}_{ 1} {c}_{ 2} + {c}_{ 2} {c}_{ 3} + {c}_{ 1} {c}_{ 3} ) + \\ 27 {s}_{1} {s}_{2} {s}_{3} cos ( {φ}_{1} + {φ}_{2} + {φ}_{3} ] \geq - \frac{26}{{( 4 π )}^{3}} .\end{matrix}$$

Here cⱼ≡cos θⱼ and sⱼ≡sin θⱼ, and the minimum occurs at θ₁=θ₂=θ₃=π/2 and φ₁+φ₂+φ₃=π. Thus, the mixed state ρ_{ε}=(1−ε)M₈+ερ_{GHZ} is separable if ε≦1/27, in which case, no measurement can reveal evidence of quantum entanglement.

Up to this point it has been assumed that the number of qubits is being fixed, and the boundary between separability and non-separability has been described as the amount of noise, specified by ε, changes. Now, the discussion shifts to thinking of the qubits as particles with spin and asking what happens as the number of particles or their dimension changes, while ε is held fixed. In general, going to more particles or higher spins, allows the system to tolerate more mixing with the maximally mixed state and still have states that are not separable. In other words, for a given ε, one can find states of sufficiently large numbers of particles or sufficiently high spin for which ρ_{ε} is non-separable. This yields an upper bound on the size of separable neighborhood around the maximally mixed state.

Consider now two spin-(d-1)/2 particles, each living in a d-dimensional Hilbert space. Each of these particles is an aggregate of N/2 spin-1/2 particles (qubits), in which case d=2^{N/2}. Consider a specific joint density matrix of the two particles,
ρ_{ε}=(1−ε)M_{d}_{²}+ε|ψ [symbol] [symbol] ψ|,
where |ψ [symbol] is a maximally entangled state of the two particles,

$$\vert ψ 〉 = \frac{1}{\sqrt{d}} ( \vert 1 〉 \vert 1 〉 + \vert 2 〉 \vert 2 〉 + … + \vert d 〉 \vert d 〉 ) .$$

Now project each particle onto the subspace spanned by 1 [symbol] and |2 [symbol] . The state after projection is

$$\begin{matrix}\tilde{ρ} = \frac{1}{A} ( \frac{1 - ɛ}{{d}^{2}} {1}_{4} + \frac{ɛ}{d} ( \vert 1 〉 \vert 1 〉 + \vert 2 〉 \vert 2 〉 ) ( 〈 1 \vert 〈 1 \vert + 〈 2 \vert 〈 2 \vert ) ) \\ = ( 1 - {ɛ}^{′} ) {M}_{4} + {ɛ}^{′} \vert ϕ 〉 〈 ϕ \vert ,\end{matrix}$$

$$where$$

$$A = \frac{4}{{d}^{2}} [ 1 + ɛ ( \frac{d}{2} - 1 ) ]$$

is the normalization factor,

$$\vert ϕ 〉 = \frac{1}{\sqrt{2}} ( \vert 1 〉 \vert 1 〉 + \vert 2 〉 \vert 2 〉 )$$

is a maximally entangle state of two qubits, and

$${ɛ}^{′} = \frac{2 ɛ / d}{A} = \frac{ɛ d / 2}{1 + ɛ ( d / 2 - 1 )} .$$

The projected state \tilde{p} is a Werner state, a mixture of the maximally mixed state for two qubits, M₄, and the maximally entangled state |φ [symbol] . The proportion ε′ of maximally entangled state increases linearly with d. Thus, as d increases for fixed ε, there is a critical dimension beyond which p becomes entangled. Indeed, the Werner state is non-separable for ε′>⅓ which is equivalent to d>ε⁻¹−1. Moreover, since the local projections on the two particles cannot create entanglement from a separable state, one can conclude that the state (14) of N qubits is non-separable under the same conditions, i.e., if

$$ɛ > \frac{1}{1 + d} = \frac{1}{1 + {2}^{N / 2}} .$$

This result establishes an upper bound, scaling as 2^{-N/2} on the size of the separable neighborhood around the maximally mixed state. The general effect of noise on the computation, then the relationship between separability and noise is disclosed below.

Consider a pure-state computational protocol in which the computer starts in the state |ψ₀ [symbol] and ends in the state |ψ_{ƒ=U|ψ}₀ [symbol] , where U is the unitary time evolution operator which describes the computation. The corresponding computation starting with pseudo-pure state
ρ=(1−ε)M+ε|ψ₀ [symbol] [symbol] ψ₀|
ends up in the state
ρ=(1−ε)M+ε|ψ_{ƒ} [symbol] [symbol] ψ_{ƒ}|.

Upon reaching the final state, a measurement is carried out and the result of the computation is inferred from the result of the measurement.

In the most favorable case, that the pure-state protocol gives the correct answer with certainty with a single repetition of the protocol and that if the result of computation is found, one can check it with polynomial overhead. The Pseudo Pure State (PPS) protocol uses the order of 1/ε repetitions. Thus, if ε becomes exponentially small with N. the number governing the scaling of the classical problem (in other words, the noise becomes exponentially large with N), the protocol requires an exponential number of repetitions to get the correct answer. So, for this amount of noise, the quantum protocol with a PPS cannot transform an exponential problem into a polynomial one: even in the best possible case that the pure-state protocol takes one computational step, the protocol with noise takes exponentially many steps. This conclusion applies quite generally to pseudo-state quantum computing and is independent of the discussion of separability, which follows later.

In the PPS there is a probability ε of finding the computer in the “correct” final state |ψ_{ƒ} [symbol] arising from the term ε|ψ_{η} [symbol] |ψ_{ƒ} [symbol] . As stated above, assume here the most favorable case, that if the state is |ψ_{ƒ then, from the outcome of the final measurement, one can infer the solution to the computational problem with certainty with one repetition. In general protocols, such as Shor's algorithm, for example, a single repetition of the protocol is not sufficient to find the correct answer.}

There is also the probability (1−ε) of finding the computer in the maximally mixed state M. In this case, there is a possibility that the correct answer will be found, since the noise term contains all possible outcomes with some probability. However, the probability of finding the correct answer from the noise term must be at least exponentially small with N. Otherwise, there would be no need to prepare the computer at all: one could find the correct answer from the noise term simply by repeating the computation a polynomial number of times. In fact, if the probability of finding the correct answer from the noise term did not become exponentially small with N, one could dispense with the computer altogether. For using a classical probabilistic protocol, which selected from all the possibilities at random, one would get the correct answer with probability of the order of one with only a polynomial number of trials.

Thus, the probability of finding the correct answer from the pseudo-pure state is essentially ε and so the computation must be repeated 1/ε times on average to find the correct answer with probability of order one.

Now consider whether reaching entangled states during the computation is a necessary condition for exponential speed-up. This is addressed by investigating what can be achieved with separable states. Specifically, impose the condition that the pseudo-pure state remains separable during the entire computation. For an important class of computational protocols, it is shown that this condition implies an exponential amount of noise.

The example protocols shown herein use n=n₁+n₂ qubits of which n₁ are considered to be the input registers, and the remaining n₂ are the output registers. Assume that n₁ and n₂ are polynomial in the number N which describes how the classical problem scales. As stated earlier, the problems in which the quantum protocol gives an exponential speed-up over the classical protocol is to be considered, specifically the classical protocol is exponential in N whereas, the quantum protocol is polynomial in N. (For example, in the factorization problem, the aim is to factor a number of the order of 2^{N}. The classical protocol is exponential in N and, in Shor's algorithm, n₁ and n₂ are linear in N.)

In describing the protocols as applied to pure states, the first steps are as follows:

Prepare the system in the initial state:
|ψ₀ [symbol] =|00 . . . 0 [symbol] ⊕|00 . . . 0

[symbol]

Perform a Hadamard transform on the input register, so that the state becomes

$$\vert {ψ}_{1} 〉 = \frac{1}{{2}^{{n}_{1} / 2}} {\sum }_{x = 0}^{{2}^{{n}_{1}} - 1} \vert x 〉 ⊗ \vert 00 … 0 〉$$

Evaluate the function ƒ: [symbol] 0,1 [symbol] ⁿ^{₁}→ [symbol] 0, 1 [symbol] ⁿ^{₂}. The state becomes

$$\vert {ψ}_{2} 〉 = \frac{1}{{2}^{{n}_{1} / 2}} {\sum }_{x = 0}^{{2}^{{n}_{1}} - 1} \vert x 〉 ⊗ \vert f ( x ) 〉 .$$

Now consider the protocol when applied to a mixed state input. Thus, the initial state ρ₀ is
ρ=(1−ε)M₂_{ⁿ}+ε|ψ₀ [symbol] [symbol] ψ₀|,
where M₂_{ⁿ} is the maximally mixed state in the 2ⁿ dimensional Hilbert space. After the second computational step the state is
ρ=(1−ε)M₂_{ⁿ}+ε|ψ₂ [symbol] [symbol] ψ₂|.

Consider now protocols in which the function ƒ(x) is not constant. Let x₁ and x₂ values of x such that ƒ(x₁)≠ƒ(x₂). Thus the state |ψ₂ [symbol] can be written as

$$\vert {ψ}_{2} 〉 = \frac{1}{{2}^{{n}_{1} / 2}} \{ \vert {x}_{1} 〉 \vert f ( {x}_{1} ) 〉 + \vert {x}_{2} 〉 \vert f ( {x}_{2} ) 〉 + \vert {ψ}_{r} 〉 \} ,$$

where |ψᵣ [symbol] has no components in the subspace spanned by |x₁ [symbol] |ƒ(x₁) [symbol] , |x₁ [symbol] |ƒ(x₂) [symbol] , |x₂ [symbol] |ƒf(x₁) [symbol] , |x₂ [symbol] |ƒ(x₂) [symbol] . It is convenient to relabel these states and write

$$\vert {ψ}_{2} 〉 = \frac{1}{{2}^{{n}_{1} / 2}} \{ \vert 1 〉 \vert 1 〉 + \vert 2 〉 \vert 2 〉 + \vert {ψ}_{r} 〉 \} ,$$

where |ψᵣ [symbol] has no components in the subspace spanned by |1 [symbol] |1 [symbol] , |1 [symbol] , |2 [symbol] , |2 [symbol] |1 [symbol] , |2 [symbol] |1 [symbol] .

A necessary condition on ε for the state of the system to be separable throughout the computation is obtained by considering projecting each particle onto the subspace spanned by |1 [symbol] and |2 [symbol] . The state after projection is

$$\begin{matrix}{ρ}_{2}^{′} = \frac{1}{A} [ \frac{4 ( 1 - ɛ )}{{2}^{{n}_{1} + {n}_{2}}} {M}_{4} + \frac{2 ɛ}{{2}^{{n}_{1}}} ( \frac{\vert 1 〉 \vert 1 〉 + \vert 2 〉 \vert 2 〉}{\sqrt{2}} ) ( \frac{〈 1 \vert 〈 1 \vert + 〈 2 \vert 〈 2 \vert}{\sqrt{2}} ) ] = \\ = ( 1 - {ɛ}^{′} ) {M}_{4} + {ɛ}^{′} ( \frac{\vert 1 〉 \vert 1 〉 + \vert 2 〉 \vert 2 〉}{\sqrt{2}} ) ( \frac{〈 1 \vert 〈 1 \vert + 〈 2 \vert 〈 2 \vert}{\sqrt{2}} )\end{matrix} , \\ where$$

$$A = ( \frac{4 ( 1 - ɛ )}{{2}^{{n}_{1} + {n}_{2}}} + \frac{2 ɛ}{{2}^{{n}_{1}}} )$$

is the normalization factor, M₄ is the maximally mixed state in the four-dimensional Hilbert space spanned by |1 [symbol] |1 [symbol] , |1 [symbol] |2 [symbol] , |2 [symbol] , |1 [symbol] , |2 [symbol] |2 [symbol] , and

$${ɛ}^{′} = \frac{2 ɛ}{{2}^{{n}_{1}} A} = \frac{ɛ}{( 1 - ɛ ) {2}^{- {n}_{2} + 1} + ɛ} .$$

Now a two qubit state of the form

$$( 1 - δ ) {M}_{4} + δ ( \frac{\vert 1 〉 \vert 1 〉 + \vert 2 〉 \vert 2 〉}{\sqrt{2}} ) ( \frac{〈 1 \vert 〈 1 \vert + 〈 2 \vert 〈 2 \vert}{\sqrt{2}} )$$

is entangled for δ>⅓. Therefore, the original state must have been entangled unless

$${ɛ}^{′} \leq 1 / 3 ⇒ ɛ \leq \frac{1}{1 + {2}^{{n}_{2}}} ,$$

since local projections cannot create entangled states from un-entangled ones.

Therefore, a computational protocol (for non-constant ƒ) involves starting with a mixed state and, if the state remains separable throughout the protocol, then

$$ɛ \leq \frac{1}{1 + {2}^{{n}_{2}}} .$$

However, even in favorable circumstances, a computation with noise ε takes of the order of 1/ε repetitions to get the correct answer with probability of the order of one.

Thus, computational protocols of the sort considered require exponentially-many repetitions. So no matter how efficient the original pure-state protocol is, the mixed-state protocol, which is sufficiently noisy that it remains separable for all N, will not transform an exponential classical problem into a polynomial one.

When |ψ [symbol] is entangled but ρ_{PPS}ⁿ is separable, the PPS exhibits pseudo-entanglement. The condition

$$ɛ < \frac{1}{1 + {2}^{2 n - 1}}$$

is sufficient for separability but not necessary. Thus, entanglement will not appear in a quantum unitary computation that starts in a separable PPS whose purity parameter ε obeys

$$ɛ < \frac{1}{1 + {2}^{2 n - 1}} .$$

A final measurement in the computational basis will not make entanglement appear either.

Two examples: the solutions of Deutsch-Jozsa and Simon's problems are now shown without entanglement.

For the Deutsch-Jozsa problem, given a function ƒ: [symbol] 0,1 [symbol] ⁿ→ [symbol] 0,1 [symbol] in the form of an oracle (or black-box), assume that either this function is promised to be either constant, ƒ(x)=ƒ(y), or that it is balanced, ƒ(x)=0, on exactly half the n-bit strings x. The task is to decide which is the case. A single oracle call (in which the input is given in superposition) suffices for a quantum computing to determine the answer with certainty, whereas no classical computing can be sure of the answer before it has asked 2ⁿ⁻¹+1 questions. More to the point, no information at all can be derived from the answer to a single classical oracle call.

The QA of Deutsch-Jozsa (DJ) solves this problem with a single query to the oracle by starting with state |0ⁿ [symbol] |1 [symbol] and performing a Walsh-Hadamard transform on all n+1 qubits before and after the application entanglement operator (quantum oracle) U_{ƒ}. A measurement of the first n qubits is made at the end (in computational basis), yielding classical n-bit string z.

By virtue of phase kick-back, the initial Walsh-Hadamard transforms and the application of U_{ƒ}results in the following state:

$$\vert {0}^{n} 〉 \vert 1 〉 {\to }^{H} ( \frac{1}{\sqrt{{2}^{n}}} {\sum }_{x} \vert x 〉 ) \vert - 〉 {\to }^{{U}_{f}} ( \frac{1}{\sqrt{{2}^{n}}} {\sum }_{x} {( - 1 )}^{f ( x )} \vert x 〉 ) \vert - 〉 .$$

Then, if ƒ is constant, the final Walsh-Hadamard reverts the state back to ±|0ⁿ [symbol] |1 [symbol] , in which the overall phase is “+” if ƒ(x)=0 for all x and “−” if ƒ(x)=1 for all x. In either case, the result of the final measurement is necessarily z=0. On the other hand, if ƒ is balanced, the phase of half the |x [symbol] in the above expression is + and the phase of the other half is −. As a result, the amplitude of |0ⁿ [symbol] is zero after the final Walsh-Hadamard transforms because each |x [symbol] is sent to

$$+ \frac{1}{\sqrt{{2}^{n}}} \vert {0}^{n} 〉 + …$$

by those transforms.

Therefore, the final measurement cannot produce z=0. It follows from the promise that if z=0 it can be concluded that ƒ is constant and if z≠0, then it can be concluded that ƒ is balanced. Either way, the probability of success is 1 and the QA provides full information on the desired answer.

On the other hand, due to the special nature of the DJ-problem, a single query does not change the probability of guessing correctly whether the function is balanced or constant. Therefore, the following proposition holds: When restricted to a single DJ-oracle call, a classical computing algorithm learns no information about type of ƒ. In sharp contrast, the advantage of quantum computing even without entanglement: When restricted to a single DJ-oracle call, a quantum computing whose state is never entangled can learn a positive amount of information about the type of ƒ.

In this case, starting with a PPS in which the pure part is |0ⁿ [symbol] |1 [symbol] and its probability is ε, one can still follow the DJ-strategy, but now it becomes a guessing game. One can obtain the correct answer with different probabilities depending on whether ƒ is constant or balanced: If ƒ is constant, then z=0 with the probability

$$P ( z = 0 \vert f is constant ) = ɛ + \frac{1 - ɛ}{{2}^{n}}$$

because the algorithm started with state |0ⁿ [symbol] |1 [symbol] with probability ε, in which case DJ-QA is guaranteed to produce z=0 since ƒ is constant, or it started with a completely mixed state with complementary probability 1−ε, in which case DJ-QA produces a completely random z whose probability of being zero is 2⁻ⁿ.

Similarly,

$$P \text{(} z \neq 0 \vert f is constant ) = ( 1 - ɛ ) \frac{{2}^{n} - 1}{{2}^{n}} .$$

If ƒ is balanced one obtains a non-zero z with probability

$$P \text{(} z \neq 0 \vert f is balanced ) = ɛ + ( 1 - ɛ ) \frac{{2}^{n} - 1}{{2}^{n}} ,$$

and z=0 is obtained with probability

$$P \text{(} z = 0 \vert f is balanced ) = \frac{1 - ɛ}{{2}^{n}} .$$

Therefore, for all positive ε and all n, an advantage is observed over classical computing.

In particular, this is true for

$$ɛ < \frac{1}{1 + {2}^{2 n - 1}} ,$$

in which case the state remains separable throughout the entire computation in

$$ɛ < \frac{1}{1 + {2}^{2 n - 1}}$$

with n+1 qubits.

An information analysis of the DJ problem without entanglement begins by assuming the a priori probability of ƒ being constant is p (and therefore, the probability that it is balanced is 1−p). The following diagrams describe the probability that zero (or non-zero) is measured, given a constant (or balanced) function, in pure and the totally mixed cases.

The case of pseudo-pure state is the weighted sum of the previous cases. The details of the pseudo-pure case are summarized in the joint probability Table 5.5.

TABLE 5.5
Joint probability of function type (X) and measurement (Y)

| X | y = zero | y = non-zero |
|---|---|---|
| constant | $p ( ɛ + \frac{1 - ɛ}{{2}^{n}} )$ | $p ( 1 - ɛ ) ( 1 - \frac{1}{{2}^{n}} )$ |
| balanced | $( 1 - p ) \frac{1 - ɛ}{{2}^{n}}$ | $( 1 - p ) ( 1 - \frac{1 - ɛ}{{2}^{n}} )$ |
| P(Y = y) | ${p}_{0} = p ɛ + \frac{1 - ɛ}{{2}^{n}}$ | 1 − p₀ |

Thus, the probability p₀ of obtaining z=0 is

$$ɛ \cdot p + \frac{1 - ɛ}{{2}^{n}} .$$

To quantify the amount of information gained about the function, given the outcome of the measurement, calculate the mutual information between X and Y, where X is a random variable signifying whether ƒ is constant or balanced, and Y is a random variable signifying whether z=0 or not. Let the entropy function of a probability q be h(q)≡−q log q−(1−q)log(1−q). The marginal probability of Y and X may be calculated from that table, and using Bayes rule,

$$P \text{(} X \vert Y ) = \frac{P ( Y \vert X ) P ( X )}{P ( Y )} ,$$

the conditional probabilities are

$$P \text{(} X = constant \vert Y = zero ) = \frac{p}{{P}_{0}} ( ɛ + \frac{1 - ɛ}{{2}^{n}} ) , \\ P \text{(} X = constant \vert Y = non \text{-} zero ) = \frac{p ( 1 - ɛ )}{1 - {P}_{0}} ( 1 - \frac{1}{{2}^{n}} )$$

$$where$$

$${p}_{0} = P ( Y = zero ) = p ɛ + \frac{1 - ɛ}{{2}^{n}} .$$

The conditional entropy is

$$\begin{matrix}H \text{(} X \vert Y ) = {\sum }_{y} P ( Y = y ) h ( P ( X = constant \vert Y = y ) ) \\ = {p}_{0} h ( \frac{p}{{p}_{0}} [ ɛ + \frac{1 - ɛ}{{2}^{n}} ] ) + ( 1 - {p}_{0} ) h ( \frac{p ( 1 - ɛ )}{1 - {p}_{0}} [ 1 - \frac{1}{{2}^{n}} ] ) .\end{matrix}$$

Then, the mutual information gained by a single quantum query is

$$\begin{matrix}I ( X ; Y ) = H ( X ) - H ( X \vert Y ) \\ = h ( p ) - {p}_{0} h ( \frac{p}{{p}_{0}} [ ɛ + \frac{1 - ɛ}{{2}^{n}} ] ) - \\ ( 1 - {p}_{ 0} ) h ( \frac{p ( 1 - ɛ )}{1 - {p}_{0}} [ 1 - \frac{1}{ {2}^{ n}} ] ) .\end{matrix}$$

The mutual information is positive for every ε>0, unless p=0 or p=1. This is more than the zero amount of information gained by a single classical query. For p=1/2 this reduced into

$$1 - \frac{1 + ɛ ( {2}^{n - 1} - 1 )}{{2}^{n}} h ( \frac{1 + ɛ ( {2}^{n} - 1 )}{2 ( 1 + ɛ ( {2}^{n} - 1 ) )} ) - \frac{{2}^{n} - 1 - ɛ ( {2}^{n - 1} - 1 )}{{2}^{n}} h ( \frac{( ɛ - 1 ) ( {2}^{n} - 1 )}{2 ( 1 + ɛ ( {2}^{n} - 1 ) - {2}^{n} )} )$$

and, for very small

$$ɛ ( ɛ• \frac{1}{{2}^{n}} ) ,$$

using the fact that

$$h ( \frac{1}{2} + x ) = 1 - \frac{2 {x}^{2}}{ln 2} + O ( {x}^{4} ) ,$$

this expression may be approximate by

$$\begin{matrix}I ( X \text{;} Y ) = 1 - {p}_{0} h ( \frac{1}{2} + \frac{{2}^{n} ɛ}{4} + O ( {2}^{n} {ɛ}^{2} ) ) - ( 1 - {p}_{0} ) h \\ ( \frac{1}{2} + \frac{ɛ}{1 - \frac{4}{{2}^{n}}} + O ( {2}^{n} {ɛ}^{2} ) ) \\ = \frac{{2}^{2 n} {ɛ}^{2}}{8 ( {2}^{n} - 1 ) ln 2} + O ( {2}^{n} {ɛ}^{2} ) > 0\end{matrix}$$

Consider, for example, the case when

$$p = \frac{1}{2} , n = 3 and ɛ = \frac{1}{1 + {2}^{2 n + 1}} = \frac{1}{129} .$$

In this case, I(X; Y)=0.0000972 bits of information are gained. Therefore, some information is gained even for separable PPSs, in contrast to the classical case where the mutual information is always zero. Furthermore, some information is gained even when ε is arbitrarily small.

It is possible to improve the expected amount of information that is obtained by a single call to the oracle by measuring the (n+1)-st qubit and take it into account. Indeed, this qubit should be |1 [symbol] if the configuration comes from the pure part. Therefore, if that extra bit is |0 [symbol] , which happens with probability

$$\frac{1 - ɛ}{2} ,$$

it is known that the PPS contributes the fully mixed part, hence no useful information is provided by z and the situation is better than in the classical case. Indeed, when that extra bit is |1 [symbol] , which happens with probability

$$\frac{1 + ɛ}{2} ,$$

the probability of the pure part is enlarged from ε to

$$\hat{ɛ} = \frac{2 ɛ}{1 + ɛ} ,$$

and the probability of the mixed part is reduced from

$$1 - ɛ to 1 - \hat{ɛ} = \frac{1 - ɛ}{1 + ɛ} .$$

The probability of z=0 changes to

$${\hat{p}}_{0} = p \hat{ɛ} + \frac{1 - \hat{ɛ}}{{2}^{n}}$$

and mutual information to

$$I ( X ; Y ) = \frac{1 + ɛ}{2} [ h ( p ) - {\hat{p}}_{0} h ( \frac{p}{{\hat{p}}_{0}} [ \hat{ɛ} + \frac{1 - \hat{ɛ}}{{2}^{n}} ] ) - ( 1 - {\hat{p}}_{0} ) h ( \frac{p ( 1 - \hat{ɛ} )}{1 - {\hat{p}}_{0}} [ 1 - \frac{1}{{2}^{n}} ] ) ]$$

which, for

$$p = \frac{1}{2}$$

and very small ε, gives:

$$I ( X ; Y ) = \frac{{2}^{2 n} {ɛ}^{2}}{4 ( {2}^{n} - 1 ) ln 2} + O ( {2}^{n} {ɛ}^{3} ) > 0.$$

This is essentially twice as much information as in the above case.

For the specific example of

$$p = \frac{1}{2} , n = 3 and ɛ = \frac{1}{129} ,$$

this is 0.000189 bits of information.

In the Simon algorithm, an oracle calculates a function ƒ(x) from n bits to n bits under the promise that ƒ is a two-to-one function, so that for any x there exists a unique y≠x such that ƒ(x)=ƒ(y). Furthermore, the existence of an s≠0 is promised such that ƒ(x)=ƒ(y) for y≠x iff y=x⊕s. The goal is to find s, while minimizing the number of times ƒ is calculated. Classically, even if one calls function ƒ exponentially many times, say ⁴\sqrt{2ⁿ} times, the probability of finding s is still exponentially small with n that is less than

$$\frac{1}{\sqrt{{2}^{n}}} .$$

However, there exists a QA that requires only O(n) computations of ƒ. The algorithm, due to Simon, is initialized with |0ⁿ [symbol] |0ⁿ [symbol] . It performs a Walsh-Hadamard transform on the first register and calculates ƒ for all inputs to obtain

$$\vert {0}^{n} 〉 \vert {0}^{n} 〉 {\to }^{H} \frac{1}{\sqrt{{2}^{n}}} {\sum }_{x} \vert x 〉 \vert {0}^{n} 〉 {\to }^{{U}_{f}} \frac{1}{\sqrt{{2}^{n}}} {\sum }_{x} \vert x 〉 \vert f ( x ) 〉 ,$$

which can be written as

$$\frac{1}{\sqrt{{2}^{n}}} {\sum }_{x} \vert x 〉 \vert f ( x ) 〉 = \frac{1}{\sqrt{{2}^{n}}} {\sum }_{x < x ⊕ s} ( \vert x 〉 + \vert x ⊕ s 〉 ) f ( x ) \text{〉} .$$

Then, the Walsh-Hadamard transform is performed again on the first register (the one holding the superposition of all |x [symbol] ), which produces state

$$\frac{1}{\sqrt{{2}^{n}}} {\sum }_{x < x ⊕ s} {\sum }_{j} ( {( - 1 )}^{j \cdot x} + {( - 1 )}^{j \cdot x ⊕ j \cdot s} ) \vert j 〉 \vert f ( x ) 〉 .$$

Finally, the first register is measured.

The outcome j is guaranteed to be orthogonal to s (j·s=0) since otherwise, |j [symbol] 's amplitude (−1)^{j·x}(1+(1−)^{j·s}) is zero. After an expected number of such queries in O(n), one obtains n linearly independent j s that uniquely define s.

For example, let S be the random variable that describe parameter s, and let J be a random variable that describes the outcome of a single measurement. To quantify how much information about S is gained by a single query, assume that S is distributed uniformly in the range [1 . . . 2ⁿ−1], its entropy before the first query is H(S)=1g(2ⁿ−1)≈n. In the classical case, a single evaluation of ƒ gives no information about S: the value of ƒ(x) on any specific x says nothing about its value in different places, and therefore, nothing about s. However, in the case of the QA, one is assured that s and j are orthogonal. If the measured j is zero, s could still be any one of the (2ⁿ−1) non-zero values and no information is gained. But in the overwhelmingly more probable case that j is non-zero, only (2ⁿ⁻¹−1) values for s are still possible. Thus, given the outcome of the measurement, the entropy of S drops to approximately n−1 bits and the expected information gain is nearly one bit.

In order to estimate the entropy, let S be a random variable that represents the sought-after parameter of Simon's function, so that ∀x: ƒ(x)=ƒ(x⊕s). Assume that S is distributed uniformly in the range [1 . . . 2ⁿ−1]. Given that S=s, and starting with a PPS whose purity is ε, one can find the distribution of the measurement after a single query. With probability ε, one starts with the pure part and measures a j that is orthogonal to s. With probability 1−ε one starts with the totally mixed state and measures a random j . Thus, for j so that

$$j \cdot s = 0 , P ( J = j \vert S = s ) = ɛ \frac{2}{{2}^{n}} + \frac{( 1 - ɛ )}{{2}^{n }} ,$$

and for j so that

$$j \cdot s = 1 , P ( J = j \vert S = s ) = \frac{( 1 - ɛ )}{{2}^{n }} . \\ P ( J = j \vert S = s ) = \{ \begin{matrix}\frac{1 + ɛ}{{2}^{n}} & if j \cdot s = 0 \\ \frac{1 - ɛ}{{2}^{n}} & if j \cdot s = 1\end{matrix} .$$

Putting this together,

The marginal probability of J for any j≠0 is

$$\begin{matrix}P ( J = j ) = {\sum }_{s} P ( s ) P ( j \vert s ) \\ = \frac{1}{ {2}^{ n - 1}} ( {\sum }_{s ⊥ j} P ( j \vert s ) + {\sum }_{s ⫬ ⊥ j} P ( j \vert s ) ) \\ = \frac{( {2}^{ n - 1} - 1 ) \frac{1 + ɛ}{ {2}^{ n}} + {2}^{ n - 1} \frac{1 - ɛ}{ {2}^{ n}}}{ {2}^{ n} - 1} \\ = \frac{1 - \frac{1 + ɛ}{ {2}^{ n}}}{ {2}^{ n} - 1}\end{matrix} ,$$

while for J=0, all values of s are orthogonal, and

$$\begin{matrix}P ( J = 0 ) = {\sum }_{s} P ( s ) P ( J = 0 \vert s ) \\ = \frac{1}{{2}^{n} - 1} {\sum }_{s ⊥ j} P ( J = 0 \vert s ) \\ = \frac{1}{{2}^{n} - 1} ( {2}^{n - 1} - 1 ) \frac{1 + ɛ}{{2}^{n}} \\ = \frac{1 + ɛ}{{2}^{n}}\end{matrix} .$$

By the definition, the entropy of the random variable J is

$$H ( J ) = - {\sum }_{j} P ( J = j ) 1 gP ( J = j ) = - ( 1 - \frac{1 + ɛ}{{2}^{n}} ) 1 g ( \frac{1 - \frac{1 + ɛ}{{2}^{n}}}{{2}^{n} - 1} ) - \frac{1 + ɛ}{{2}^{n}} 1 g \frac{1 + ɛ}{{2}^{n}} ,$$

and the conditional entropy of J given S=s is

$$\begin{matrix}H ( J \vert S = s ) = - {\sum }_{j} P ( J = j \vert S = s ) 1 gP ( J = j \vert S = s ) \\ = - {2}^{n - 1} \frac{1 + ɛ}{{2}^{n}} 1 g ( \frac{1 + ɛ}{{2}^{n}} ) - {2}^{n - 1} \frac{1 - ɛ}{{2}^{n}} 1 g ( \frac{1 - ɛ}{{2}^{n}} ) \\ = - \frac{1 + ɛ}{2} 1 g ( \frac{1 + ɛ}{{2}^{n}} ) - \frac{1 - ɛ}{2} 1 g ( \frac{1 - ɛ}{{2}^{n}} )\end{matrix}$$

Since the above mentioned expression is independent of the specific values s, it also equals to H(S|J), which is

$${\sum }_{s} P ( S = s ) H ( J \vert S = s ) .$$

Finally, the amount of knowledge about S that is gained by knowing J is their mutual information:

$$\begin{matrix}I ( S ; J ) = I ( J ; S ) \\ = H ( J ) - H ( J \vert S ) \\ = - ( 1 - \frac{1 + ɛ}{{2}^{n}} ) 1 g ( \frac{1 - \frac{1 + ɛ}{{2}^{n}}}{{2}^{n} - 1} ) + ( {2}^{n - 1} - 1 ) \frac{1 + ɛ}{{2}^{n}} 1 g \\ \frac{1 + ɛ}{{2}^{n}} + \frac{1 - ɛ}{2} 1 g ( \frac{1 - ɛ}{{2}^{n}} ) ,\end{matrix}$$

Consider two extremes: in the pure case (=1), I(S;J)=1−O(2⁻ⁿ) and in the totally mixed case (ε=0), I(S;J)=0.

Finally, it can be shown that for small ε the value

$$I ( S ; J ) = \frac{( {2}^{n} - 2 ) {ɛ}^{2}}{2 ( {2}^{n} - 1 ) 1 n 2} + O ( {ɛ}^{3} ) .$$

More formally, based on the conditional probability

$$P ( J = j \vert S = s ) = \{ \begin{matrix}\frac{2}{{2}^{n}} & if j \cdot s = 0 \\ 0 & if j \cdot s = 1\end{matrix} ,$$

it follows that the conditional entropy H(J|S=s)=n−1, which does not depend on the specific s and, therefore, H(J|S)=n−1 as well. In order to find the a proiri entropy of J, calculate its marginal probability

$$P ( J = j ) = {\sum }_{s} P ( s ) P ( j \vert s ) = \{ \begin{matrix}\frac{1 - \frac{2}{{2}^{n}}}{{2}^{n} - 1} & if j \neq 0 \\ \frac{2}{{2}^{n}} & if j = 0\end{matrix} .$$

Thus,

$$\begin{matrix}H ( J ) = - {\sum }_{j} P ( J = j ) 1 gP ( J = j ) \\ = - ( 1 - \frac{2}{{2}^{n}} ) 1 g \frac{1 - \frac{2}{{2}^{n}}}{{2}^{n} - 1} - \frac{2}{{2}^{n}} 1 g \frac{2}{{2}^{n}} \\ = ( 1 - \frac{2}{{2}^{n}} ) ( n + 1 g \frac{{2}^{n} - 1}{{2}^{n} - 2} ) + \frac{n - 1}{{2}^{n - 1}}\end{matrix}$$

and the mutual information

$$I ( S ; J ) = 1 - \frac{2 - ( {2}^{n} - 2 ) {ɛ}^{2}}{{2}^{n}} 1 g \frac{{2}^{n} - 1}{{2}^{n} - 2} = 1 - O ( 2 - n )$$

is almost one bit.

In contrast, a single query to a classical oracle provides no information about s. When restricted to a single oracle call, a classical computing algorithm learns no information about Simon's parameter s. Again in sharp contrast, the following result shows the advantage of quantum computing without entanglement, compared to classical computing. When restricted to a single oracle call, a quantum computing algorithm whose state is never entangled can learn a positive amount of information about Simon's parameter s.

For example, starting with a PPS in which the pure part is |0ⁿ [symbol] |0ⁿ [symbol] , and its probability is ε, the acquired j is no longer guaranteed to be orthogonal to s. In fact, an orthogonal j is obtained with probability

$$\frac{1 + ɛ}{2}$$

only. For any value of S, the conditional distribution of J as above mentioned is

$$P ( J = j \vert S = s ) = \{ \begin{matrix}\frac{1 + ɛ}{{2}^{n}} & if j \cdot s = 0 \\ \frac{1 - ɛ}{{2}^{n}} & if j \cdot s = 1\end{matrix}$$

from which it is calculated that the information gained about S given the value of J is

$$I ( S ; J ) = - ( 1 - \frac{1 + ɛ}{{2}^{n}} ) 1 g ( \frac{1 - \frac{1 + ɛ}{{2}^{n}}}{{2}^{n} - 1} ) + ( {2}^{n - 1} - 1 ) \frac{1 + ɛ}{{2}^{n}} 1 g \frac{1 + ɛ}{{2}^{n}} + \frac{1 - ɛ}{2} 1 g ( \frac{1 - ɛ}{{2}^{n}} ) .$$

The amount of information is larger than the classical zero for every ε>0. This result is true even for ε as small as

$$\frac{1}{1 + {2}^{2 ( 2 n ) - 1}} ,$$

in which case the state of the computing is never entangled throughout the computation.

When n=3 and

$$ɛ = \frac{1}{1 + {2}^{4 \cdot 3 - 1}} = \frac{1}{2049} ,$$

147×10⁻⁹ bits of information are gained.
5.3. Quantum Computing for Design of Robust Wise Control

Decomposition of the optimization process in design of a robust KB for an intelligent control system is separated in two steps: (1) global optimization based on a Quantum Genetic Search Algorithm (QGSA); and (2) a learning process based on a QNN for robust approximation of the teaching signal from a QGSA.

FIG. 40 shows the interrelations between Soft Computing and Quantum Soft Computing for simulation, global optimization, quantum learning and the optimal design of a robust KB in intelligent control systems. The main problem of KB-optimization based on soft computing lies in the design process using one solution space for global optimization. As an example, consider a design of a KB for a fixed class of stochastic excitations on a control object. If the design process is based on many solution spaces with different statistical characteristics of stochastic excitations of the control object, then the GA cannot necessarily find a global solution for an optimal KB. In this case, for global optimization, a QGSA is used to find the KB. In one embodiment, optimization methods of intelligent control system structures (based on quantum soft computing) use a modification of simulation methods for quantum computing.

Quantum Control Algorithm for Robust KB-FC Design.

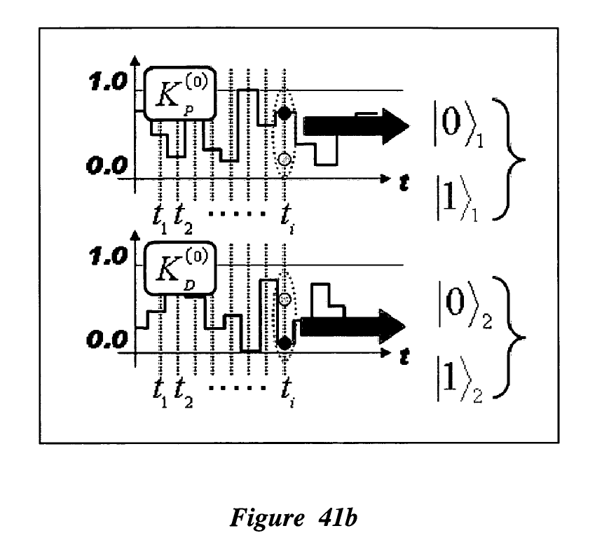

FIG. 41a is a block diagram of the structure of an intelligent control system based on a PD-fuzzy controller (PD-FC). In FIG. 41a, a conventional PD (or PID) controller 4102 controls a plant 4103. A control output from the controller 4102 and an output from the plant 4103 are provided to a QGSA 4101. A globally optimized KB from the QGSA 4101 is provided to a Fuzzy Controller (FC) 4104. Gain schedules from the FC 4104 are provided to the PD controller 4102. An error signal, computed as a difference between an output of the plant 4103 and an input signal is provided to the FC 4104 and to the PD controller 4102.

Using a soft computing optimizer, it is possible to design partial KB(i) for the FC 4104 from simulation of control object behaviour using different classes of stochastic excitations. For many cases this KB(i) is not robust if another type of stochastic excitations is applied to the control object (plant) 4103 or if the reference signal is changed. The problem lies in design of a unified robust KB from a number of finite number KB(i) look-up tables created by soft computing and finding a globally optimized KB for intelligent fuzzy control under stochastic excitations.

The KB can be considered as an ordered DB containing control laws of coefficient gains for a traditional PID controller. The superposition operator is used for design of relations between coefficient gains of the PID-FC. Grover's QSA is used for searching of solutions and max operation between decoding states is analogy of the measurement process of solution search.

As described above, in an entanglement-free quantum computation no resource increases exponentially. The concrete example below shows that it is possible to design a robust intelligent globally-optimzed KB using a superposition of non-robust KBs. In this case, the quality of control based on the globally-optimized KB is more effective than the non-robust KBs obtained by local optimization. In this case, wise robust control is introduced, where wise≡intelligent⊕smart. This situation is similar to the Parrondo Paradox in a quantum game. In design process of wise control, entanglement is not used and thus, it is different from Parrondo Paradox.

For an entanglement-free quantum control algorithm for design of a robust wise KB-FC, consider one of the examples of quantum computing approach to design robust wise quantum control. As described, FIG. 41a shows the structure of an intelligent control system based on a fuzzy PD-controller (PD-FC). A soft computing optimizer is used to a group of partial knowledge bases KB(i) for the PD-FC from fuzzy simulation of behavior of the plant 4103 using different class of stochastic excitations. For many cases, these KB( i) are not robust used with different type of stochastic excitations, changing initial states, or changing the type of reference signals. The problem lies in design of a unified robust globally optimized KB from the KB(i) look-up tables created by soft computing.

The entropy of an orthogonal matrix provides a new interpretation of Hadamard matrices as those that saturate the bound for entropy. This definition plays a role in QAs simulation, while the Hadamard matrix is used for preparation of superposition states and in entanglement-free QAs. The entropy of orthogonal matrices and Hadamard matrices (appropriately normalized) saturate the bound for the maximum of the entropy. The maxima (and other saddle points of the entropy function have an intriguing structure and yield generalizations of Hadamard matrices.)

Consider n random variables with a set of possible outcomes i=1, . . . , n having probabilities pᵢ, i=1, . . . , n. Then

$${\sum }_{i = 1}^{n} {p}_{i} = 1$$

and the Shannon entropy

$${S}^{Sh} ( {p}_{i} ) = - {\sum }_{i = 1}^{n} {p}_{i} ln {p}_{i} .$$

Now define entropy of an orthogonal matrix Oⁱₙ, i, j=1, . . . , n. Here Oⁱⱼ are real numbers with the constraint

$${\sum }_{i = 1}^{n} {O}_{j}^{i} {O}_{k}^{i} = {δ}_{jk} .$$

In particular, the j th row of the matrix is a normalized vector for each i=1, . . . , n. It is possible to associate probabilities pⱼ⁽ⁱ⁾=(Oⁱⱼ)² with the i th row, as

$${\sum }_{j = 1}^{n} {p}_{j}^{( i )} = 1$$

for each i. Define the Shannon entropy for the orthogonal matrix as the sum of the entropies for each row:

$${S}^{Sh} ( {O}_{j}^{i} ) = - {\sum }_{i , j = 1}^{n} {( {O}_{j}^{i} )}^{2} ln {( {O}_{j}^{i} )}^{2} .$$

The minimum value zero is attained by the identity matrix Oⁱⱼ=δⱼⁱ and related matrices obtained by interchanging rows or changing the signs of the elements. The entropy of the i th row can have the maximum value In n, which is attained when each element of the row is

$$\pm \frac{1}{\sqrt{n}} .$$

This gives the bound, S^{Sh}(Oⁱⱼ)≦n 1n n.

In general the entropy of an orthogonal matrix cannot attain this bound because of the orthogonality constraint

$${\sum }_{i = 1}^{n} {O}_{j}^{i} {O}_{k}^{i} = {δ}_{jk}$$

which constraints pⱼ⁽ⁱ⁾ for different rows. In fact the bound is obtained only by the Hadamard matrices (rescaled by

$$\frac{1}{\sqrt{n}} ) .$$

This yields the criterion for the Hadamard matrices (appropriately normalized): those orthogonal matrices which saturate the bound for entropy.

The entropy is large when each element is as close to

$$\pm \frac{1}{\sqrt{n}} s$$

possible, i.e., to a main diagonal. Thus, maximum entropy is similar to the maximum determinant condition of the Hadamard. The peaks of the entropy are isolated and sharp in contrast to the determinant.

For, example, a matrix that maximizes the entropy for n=3 is

$$n = 3 ⇒ ( \begin{matrix}- \frac{1}{3} & \frac{2}{3} & \frac{2}{3} \\ \frac{2}{3} & - \frac{1}{3} & \frac{2}{3} \\ \frac{2}{3} & \frac{2}{3} & - \frac{1}{3}\end{matrix} ) ;$$

$$n = 5 ⇒ ( \begin{matrix}- \frac{3}{5} & \frac{2}{5} & \frac{2}{5} & \frac{2}{5} & \frac{2}{5} \\ \frac{2}{5} & - \frac{3}{5} & \frac{2}{5} & \frac{2}{5} & \frac{2}{5} \\ \frac{2}{5} & \frac{2}{5} & - \frac{3}{5} & \frac{2}{5} & \frac{2}{5} \\ \frac{2}{5} & \frac{2}{5} & \frac{2}{5} & - \frac{3}{5} & \frac{2}{5} \\ \frac{2}{5} & \frac{2}{5} & \frac{2}{5} & \frac{2}{5} & - \frac{3}{5}\end{matrix} ) .$$

For n =5, the result is similar as in the case n=3: the magnitudes of the elements in each row are

$$\frac{2}{5}$$

repeated 4 times and a diagonal element is as

$$( - \frac{3}{5} ) .$$

This set can be generalized for any n. The matrix with

$$- \frac{n - 2}{n}$$

along the diagonal and each off-diagonal as

$$\frac{2}{n}$$

is orthogonal. Each row is normalized as a consequence of the identity:
n²=(n−2)²+2²(n−1).

For each n, there are saddle points apart from maxima and minima.

For n=3 there is a saddle point and the corresponding matrix is

$$( \begin{matrix}\frac{1}{2} & \frac{1}{\sqrt{2}} & \frac{1}{2} \\ \frac{1}{\sqrt{2}} & 0 & - \frac{1}{\sqrt{2}} \\ \frac{1}{2} & - \frac{1}{\sqrt{2}} & \frac{1}{2}\end{matrix} ) .$$

The entropy peaks sharply at extrema. Thus, the entropy has a rich set of sharp extrema.

This result shows the role of the Hadamard operator in an entanglement-free QA: with the Hadamard transformation it is possible to introduce maximally-hidden information about classical basis independent states, and the superposition includes this maximal information. Thus, with superposition operator, it is possible to create a new QA without entanglement, while the superposition includes information about the property of the function ƒ.

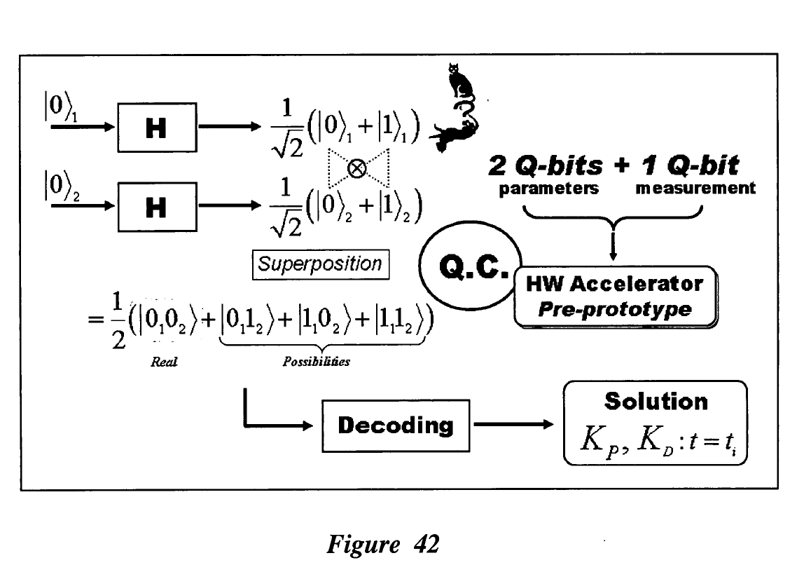

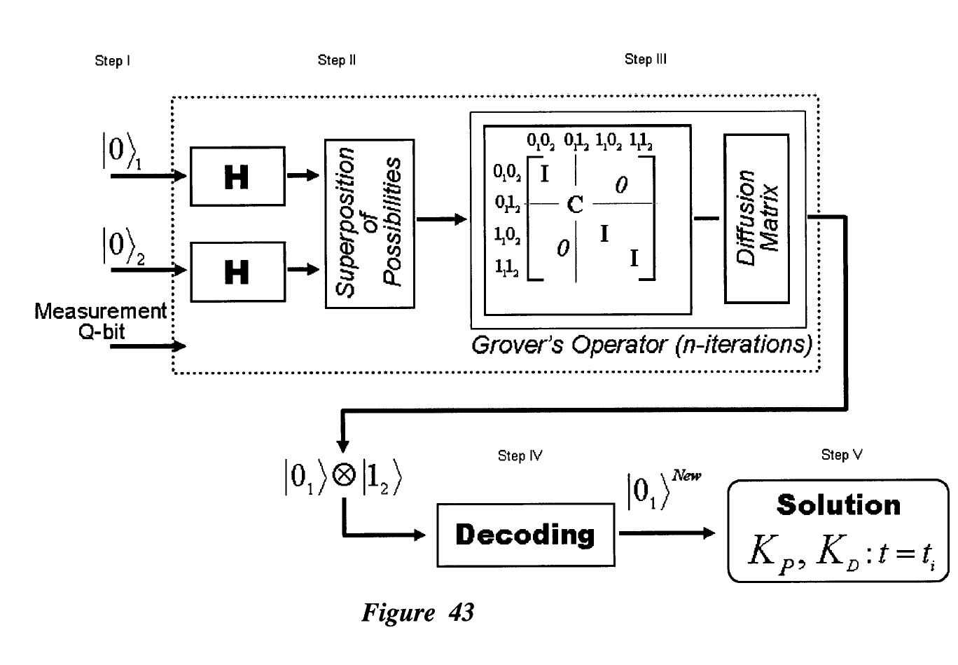

FIG. 42 shows the structure of the design process for using the above approach in design of a robust KB for fuzzy controllers. The superposition operator used is the particular case of a QFT—the Walsh-Hadamard transform. The KB(i) of the PD-FC includes the set of coefficient gains K= [symbol] kₚ(t), k_{D}(t) [symbol] laws received from soft computing simulation using different types of random excitations on the plant 4103. FIG. 43 shows the structure of a quantum control algorithm for design of a robust unified KB-FC from two KBs created by soft computing optimizer for Gaussian (KB(1)) and non-Gaussian (with Rayleigh probability density function)—KB(2) noises.

The algorithm includes the following operations:
1. Prepare two registers of n qubits in the state |0 . . . 0 [symbol] εH_{N}.
2. Apply H over the first register.
3. Apply diffusion (interference) operator G over the whole quantum state.
4. Apply max operation over the first register.
5. Measure the first register and output the measured value.

Normalized real simulated coefficient gains [symbol] Kₚ(t),K_{D}(t) [symbol] can be calculated using the values of virtual coefficient gains [symbol] k_{P}^{Q}(t),k_{D}^{Q}(t) [symbol] as logical negation: [symbol] k_{P}^{Q}(t),k_{D}^{Q}(t) [symbol] =1− [symbol] kₚ(t), k_{D}(t) [symbol] . For example, if the value of the proportional coefficient gain, kₚ(tᵢ), is kₚ(tᵢ)=0,2, then k_{P}^{Q}(tᵢ)=1−0,2=0,8.

FIG. 41b shows the geometrical interpretation of this computational process.

FIG. 42 shows the logical description of superposition between real and virtual values of coefficient gains created by soft computing simulation. For this case four classical states are joint in one non-classical superposition state with amplitude probability

$$\frac{1}{2} .$$

For the above described example, the following coding result: |0₁ [symbol] →0.2, |1₁ [symbol] →0.8 is obtained.

In one embodiment, the computational control algorithm includes the following operations:
1. The current values (for fixed time tᵢ) of the coefficient gains are coded as real values.
2. Hadamard matrices are created for superposition between real simulated and virtual classical states. The virtual classical state is calculated from the normalized scale [0,1] (the complementary quantum law is the logical negation of the real simulated value). The Hadamard transform joins two classical states in one non-classical state as a superposition:

$$\frac{1}{\sqrt{2}} [ \vert {0}_{1} 〉 + \vert {1}_{1} \text{〉} \text{]} = \frac{1}{\sqrt{2}} [ \vert Yes 〉 + \vert No \text{〉} \text{]}$$

that it is not found in classical mechanics. This operation creates the possibility of extraction of hidden quantum information from classical contradictory states.
3. Grover's diffusion operator is used to provide an interference operation search for the solution.
4. The Max operation is applied to the classical states in the superposition after the decoding of results.

The results of the quantum computation are used in new control laws (new coefficient gains) from two KB(i), i=1,2 created from soft computing technology
\ddot{x}+(x²−1)\dot{x}+x=kₚ(t)e+k_{D}(t)\dot{e}+ξ(t) (4.1)
under Gaussian random white noise ξ(t).

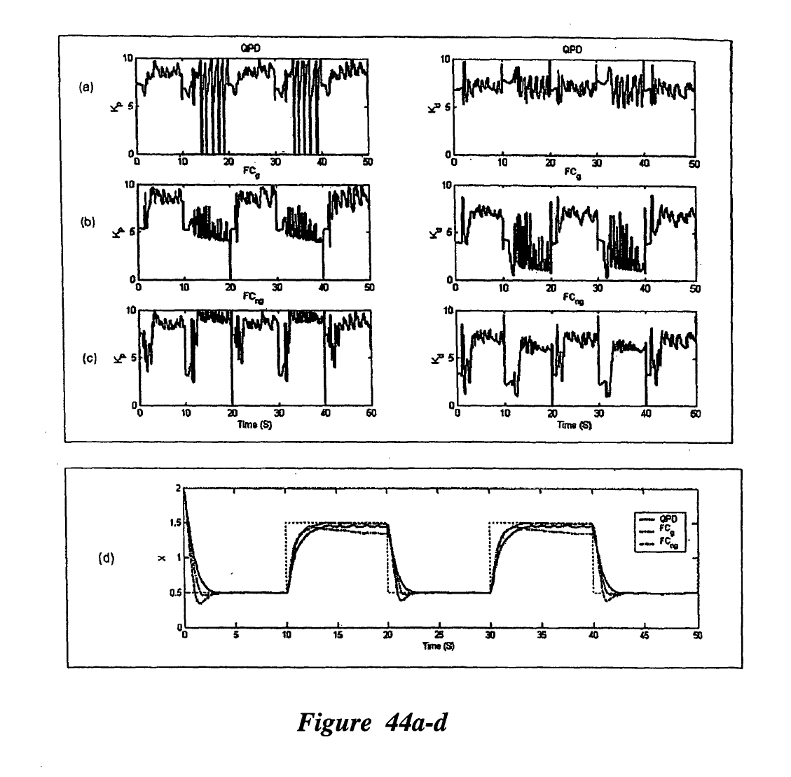

FIG. 44b shows the initial control laws of the coefficient gains [symbol] k_{P}(t),k_{D}(t) [symbol] in a PD-FC created from soft computing technology for similar essentially non-linear control object such as a Van der Pol oscillator under non-Gaussian random noise with Rayleigh probability distribution.

FIG. 44c shows the computational results of new coefficient gains of PD-FC based on the quantum control algorithm for similar essentially non-linear control objects such as the Van der Pol oscillator using KB's created from soft computing technology. FIG. 44d shows the results of simulation of the dynamic behavior of the Van der Pol oscillator using PD-FC with different KBs.

The comparison of simulation results represented in FIG. 44d shows the more robustness degree of quantum PD-FC than in similar classical soft computing cases as a new effect in intelligent control system design. From two non-robust KBs of PD-FCs, one robust KB of PD-FC with quantum computation approach can be designed. This effect is similar to the effect in the above mentioned quantum Parrondo Paradox in quantum game theory, but without using of entanglement.

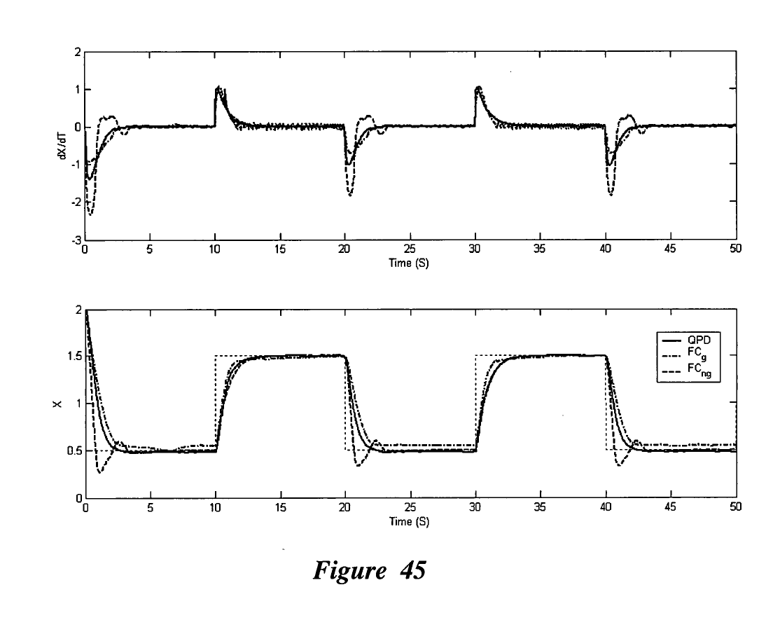

The comparison of simulation results represented in FIG. 45 shows the higher degree of robustness in quantum PD-FC than in similar classical soft computing cases as a new effect in intelligent control system design.

6. Model Representations of Quantum Operators in Fast QAs

In some cases, the speed of the QA simulation can be improved by using a model representation of the quantum operators. This approach is based on using new operations or adding to existing quantum operators in the QSA structure, and/or structural modifications of the quantum operators in QSA. Grover's algorithm is used as an example herein. One of ordinary skill in the art will recognize that the model representation technique is not limited to Grover's algorithm.

6.1 Grover's QSA Structure with New Additional Quantum Operators

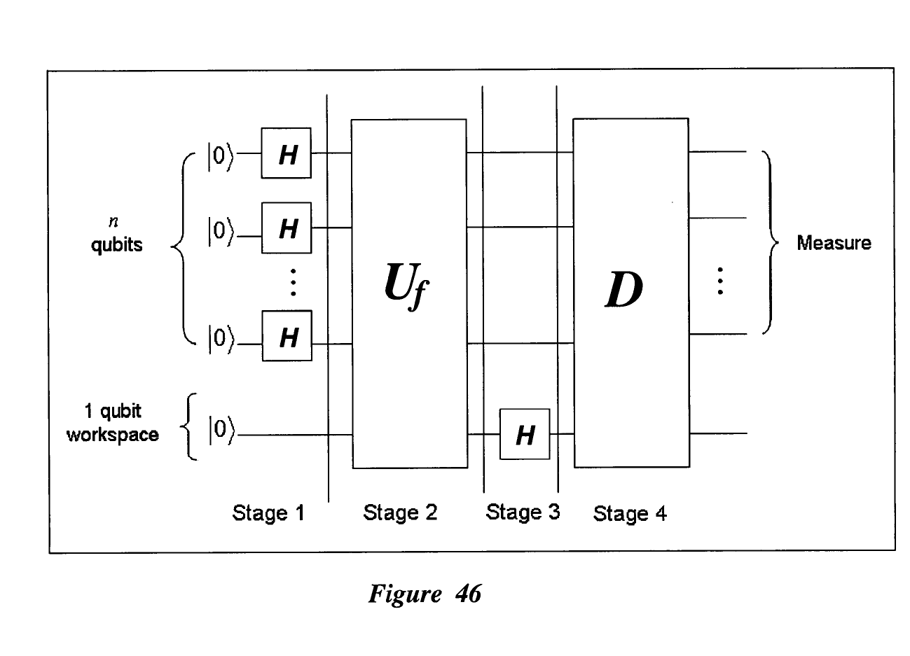

FIG. 46 shows the addition of a new Hadamard operator, for example, between the oracle (entanglement) and the diffusion operators in Grover's QSA. The new Hadamard operator is applied on a workspace qubit (for complementing superposition and changing sign) to produce an algorithm labeled QSA1. Let M denote the number of matches within the search space such that 1≦M≦N, and for simplicity, and without loss of generality, assume that N=2ⁿ. For this case one can describe the steps of the algorithm as follows.

| Step | Computational operation |
|---|---|
| 1 | $\begin{matrix}Register preparation : Prepare a quantum register of n + 1 qubits \\ all in state \vert 0 〉 , where the extra qubit is used as a workspace for \\ {evaluating the oracle {U}_{f} : \vert {W}_{0} 〉 = \vert 0 〉}^{⊗ n} \vert 0 〉 .\end{matrix}$ |
| 2 | Register initialization: Apply Hadamard gate on each of the first n |
| | qubits in parallel, so they contain the 2ⁿ states, where i is the |
| | integer representation of items in the list: |
| | $\vert {W}_{1} 〉 = ( {H}^{⊗ n} ⊗ I ) \vert {W}_{0} 〉 = \\ ( \frac{1}{\sqrt{N}} {\sum }_{i = 0}^{N - 1} \vert i 〉 ) ⊗ \vert 0 〉 , N = {2}^{n} .$ |
| 3 | Applying oracle: Apply the oracle U_{f} to map the items in the list to |
| | either 0 or 1 simultaneously and store the result in the extra |
| | workspace qubit: |
| | $\vert {W}_{2} 〉 = {U}_{f} \vert {W}_{1} 〉 = \frac{1}{\sqrt{N}} {\sum }_{i = 0}^{N - 1} ( \vert i 〉 ⊗ \vert 0 ⊕ f ( i ) 〉 ) = \frac{1}{\sqrt{N}} {\sum }_{i = 0}^{N - 1} ( \vert i 〉 ⊗ \vert f ( i ) 〉 ) .$ |
| 4 | Completing superposition and changing sign: Apply a Hadamard |
| | gate on the workspace qubit. This will extend the superposition |
| | for the n + 1 qubits with the amplitudes of the desired states with |
| | negative sign as follows: |
| | $\begin{matrix}\vert {W}_{3} 〉 = ( {I}^{⊗ n} ⊗ H ) \vert {W}_{2} 〉 = \\ \frac{1}{\sqrt{N}} {\sum }_{i = 0}^{N - 1} ( \vert i 〉 ⊗ \vert [ \frac{\vert 0 〉 + {( - 1 )}^{f ( i )} \vert 1 〉}{\sqrt{2}} ] ) , P = 2 N = {2}^{n + 1} .\end{matrix}$ |
| 5 | Inversion about the mean: |
| | $D = {H}^{⊗ n + 1} ( 2 \vert 0 〉 〈 0 \vert - I ) {H}^{⊗ n + 1} = 2 \vert ψ \vert 〉 〈 ψ \vert - I , \vert ψ 〉 = \frac{1}{\sqrt{P}} {\sum }_{k = 0}^{P - 1} \vert k 〉 ,$ |
| | $\begin{matrix}\vert {W}_{4} 〉 = D \vert {W}_{3} 〉 = b {{\sum }_{i = 0}^{N - 1}}_{1} ( \vert i 〉 ⊗ \vert 0 〉 ) + a {{\sum }_{i = 0}^{N - 1}}_{1} ( \vert i 〉 ⊗ \vert 1 〉 ) + \\ b {{\sum }_{i = 0}^{N - 1}}_{2} ( \vert i 〉 ⊗ \vert 0 〉 ) + a {{\sum }_{i = 0}^{N - 1}}_{2} ( \vert i 〉 ⊗ \vert 1 〉 ) ,\end{matrix}$ |
| | $a = \frac{1}{\sqrt{P}} ( 3 - \frac{4 M}{P} ) ; b = \frac{1}{\sqrt{P}} ( 1 - \frac{4 M}{P} ) ; {Ma}^{2} + ( P - M ) {b}^{2} = 1.$ |
| 6 | Measurement: Measure the first n qubits, to obtain the desired |
| | solution after first iteration |
| | $\begin{matrix}with probability {P}_{s}^{( 1 )} to find a match out \\ of the M possible matches as follows :\end{matrix}$ |
| | ${P}_{s} = M ( {a}^{2} + {b}^{2} ) = 5 r - 8 {r}^{2} + 4 {r}^{3} , r = \frac{M}{N} ;$ |
| | with probability Pₙₛ to find undesired result out of the states as |
| | follows: |
| | Pₙₛ = (P − 2M)b², where Pₛ + Pₙₛ = M(a² + b²) + (P − 2M)b² = 1. |

Consider the particular properties of QSA1. In Step 5 of QSA1 it is assumed that indicates a sum over all i, which are desired matches (2M states), and Σ₂ indicates a sum over all i, which are undesired items in the list. Thus, the state |W₃> of QSA1 can be rewritten as follows:

$$\begin{matrix}\vert {W}_{3} 〉 = \frac{1}{\sqrt{P}} {\sum }_{i = 0}^{N - 1} ( \vert i 〉 ⊗ \vert 0 〉 + {( - 1 )}^{f ( i )} \vert 1 〉 ) \\ = \frac{1}{\sqrt{P}} {\sum }_{i = 0}^{N - 1} ( \vert i 〉 ⊗ [ \vert 0 〉 - \vert 1 〉 ] ) + \frac{1}{\sqrt{P}} {\sum }_{i = 0}^{N - 1} {}_{2} ( \vert i 〉 ⊗ [ \vert 0 〉 + \vert 1 〉 ] ) \\ = \frac{1}{\sqrt{P}} {\sum }_{i = 0}^{N - 1} {}_{1} ( \vert i 〉 ⊗ \vert 0 〉 ) - \frac{1}{\sqrt{P}} {\sum }_{i = 0}^{N - 1} {}_{1} ( \vert i 〉 ⊗ \vert 1 \text{〉} ) + \\ \frac{1}{\sqrt{P}} {\sum }_{i = 0}^{N - 1} {}_{2} ( \vert i 〉 ⊗ \vert 0 〉 ) + \frac{1}{\sqrt{P}} {\sum }_{i = 0}^{N - 1} {}_{1} ( \vert i 〉 ⊗ \vert 1 \text{〉} )\end{matrix}$$

There are M states with amplitude

$$( - \frac{1}{\sqrt{P}} )$$

where f (i)=1, and (P−M) states with amplitude

$$( \frac{1}{\sqrt{P}} ) .$$

Applying the Hadamard gate on the extra qubit splits the |i> state (solution states), to M states

$$( {\sum }_{i = 0}^{N - 1} {}_{1} ( \vert i 〉 ⊗ \vert 0 〉 ) )$$

with positive amplitude

$$( \frac{1}{\sqrt{P}} )$$

and Mstates

$$( {\sum }_{i = 0}^{N - 1} {}_{1} ( \vert i 〉 ⊗ \vert 1 〉 ) )$$

with negative amplitude

$$( - \frac{1}{\sqrt{P}} ) .$$

In step 5, the effect of applying the (Grover's) diffusion operator D on the general state

$${\sum }_{k = 0}^{P - 1} {α}_{k} \vert k 〉 produces {\sum }_{k = 0}^{P - 1} [ - {α}_{k} + 2 〈 α 〉 ] \vert k 〉 , \\ where$$

$$〈 α 〉 = \frac{1}{P} {\sum }_{k = 0}^{P - 1} {α}_{k}$$

(operation of inversion about the mean) is the mean of the amplitudes of all states in the superposition; i.e., the amplitudes αₖ will be transformed according to the following relation: αₖ→[−αₖ+2<α>]. In the discussed case, there are M states with amplitude

$$( - \frac{1}{\sqrt{P}} )$$

and (P−M) states with amplitude

$$( \frac{1}{\sqrt{P}} ) ,$$

so the mean <α> is as follows:

$$〈 α 〉 = \frac{1}{P} ( M ( - \frac{1}{\sqrt{P}} ) ) + ( P - M ) ( \frac{1}{\sqrt{P}} ) .$$

So, applying D on the system |W₃>, described in step 5 of QSA1, can be understood as follows:
(i) The M negative sign amplitudes (solutions) will be transformed from

$$( - \frac{1}{\sqrt{P}} )$$

to α, where α is calculated as follows:

$$\begin{matrix}a = - ( - \frac{1}{\sqrt{P}} ) + \frac{2}{P} [ M ( - \frac{1}{\sqrt{P}} ) + ( P - M ) ( \frac{1}{\sqrt{P}} ) ] \\ = \frac{1}{\sqrt{P}} ( 3 - \frac{4 M}{P} ) .\end{matrix}$$
(ii) The (P−M) positive sign amplitudes will be transformed from

$$( \frac{1}{\sqrt{P}} )$$

to b, where b is calculated as follows:

$$\begin{matrix}b = - ( \frac{1}{\sqrt{P}} ) + \frac{2}{P} [ M ( - \frac{1}{\sqrt{P}} ) + ( P - M ) ( \frac{1}{\sqrt{P}} ) ] \\ = \frac{1}{\sqrt{P}} ( 1 - \frac{4 M}{P} ) .\end{matrix}$$
Then, a>b after applying D, and the new system state |W₄> can be written as step 5 of QSA1. If no matches exist within the superposition (i.e., M=0), then all the amplitudes will have a positive sign and applying the diffusion operator D will not change the amplitudes of the states as follows:
Substituting

$${α}_{k} = \frac{1}{\sqrt{P}} and$$

$$〈 α 〉 = \frac{1}{P} ( P ( \frac{1}{\sqrt{P}} ) )$$

in the relation αₖ→[−αₖ+2<α>] gives

$${α}_{k} + 2 〈 α 〉 \to \frac{1}{\sqrt{P}} + \frac{2}{P} ( P ( \frac{1}{\sqrt{P}} ) ) = \frac{1}{\sqrt{P}} = {α}_{k} .$$

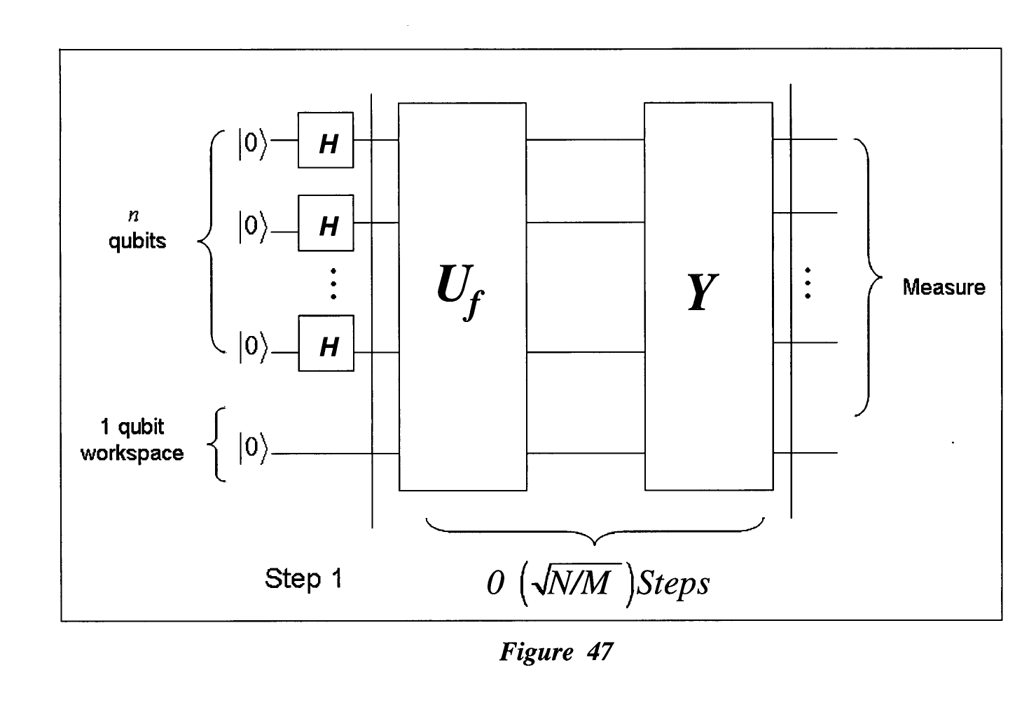

It is possible to produce a second quantum algorithm QSA2 by modifying the structure of the diffusion operator D→Dₚₐᵣₜ in step 5 of the modified QSA1 on the partial diffusion operator Dₚₐᵣₜ which can work similar to the well-known Grover's operator D except that it performs the inversion about the mean operation only on a subspace of the system. The diagonal representation of the partial diffusion operator Dₚₐᵣₜ, when applied on n+1 qubits system, can take this form: D→Dₚₐᵣₜ=H^{\textcircled{×}n+1}\textcircled{×}I(2|0><0|−I)H^{\textcircled{×}n+1}\textcircled{×}I, where the vector |0> used in this operation is a vector of length P=2N=2ⁿ⁺¹. FIG. 47 shows the steps of QSA2.

The steps of the modified QSA2 can be understood as follows:

| Step | Computational operation |
|---|---|
| 1 | $\begin{matrix}Register preparation : Prepare a quantum register of n + 1 qubits \\ all in state \vert 0 〉 , where the extra qubit is used as a workspace for \\ {evaluating the oracle {U}_{f} : \vert {W}_{0} 〉 = \vert 0 〉}^{⊗ n} \vert 0 〉 .\end{matrix}$ |
| 2 | Register initialization: Apply Hadamard gate on each of the first n |
| | qubits in parallel, so they contain the 2ⁿ states, where i is the |
| | integer representation of items in the list: |
| | $\vert {W}_{1} 〉 = ( {H}^{⊗ n} ⊗ I ) \vert {W}_{0} 〉 = \\ ( \frac{1}{\sqrt{N}} {\sum }_{i = 0}^{N - 1} \vert i 〉 ) ⊗ \vert 0 〉 , N = {2}^{n} .$ |
| 3 | Applying oracle: Apply the oracle U_{f} to map the items in the list to |
| | either 0 or 1 simultaneously and store the result in the extra |
| | workspace qubit: |
| | $\begin{matrix}\vert {W}_{2} 〉 = {U}_{f} \vert {W}_{1} 〉 = \frac{1}{\sqrt{N}} {\sum }_{i = 0}^{N - 1} ( \vert i 〉 ⊗ \vert 0 ⊕ f ( i ) 〉 ) = \\ \frac{1}{\sqrt{N}} {{\sum }_{i = 0}^{N - 1}}_{2} ( \vert i 〉 ⊗ \vert 0 〉 ) + \frac{1}{\sqrt{N}} {{\sum }_{i = 0}^{N - 1}}_{1} ( \vert i 〉 ⊗ \vert 1 〉 )\end{matrix}$ |
| 4 | $\begin{matrix}Partial diffusion : Applying {D}_{part } on \vert {W}_{2} 〉 will result in a \\ new system described as follows :\end{matrix}$ |
| | $\begin{matrix}\vert {W}_{3} 〉 = {D}_{part} \vert {W}_{2} 〉 = {a}_{1} {{\sum }_{i = 0}^{N - 1}}_{2} ( \vert i 〉 ⊗ \vert 0 〉 ) + \\ {b}_{1} {{\sum }_{i = 0}^{N - 1}}_{1} ( \vert i 〉 ⊗ \vert 0 〉 ) + {c}_{1} {{\sum }_{i = 0}^{N - 1}}_{1} ( \vert i 〉 ⊗ \vert 1 〉 ) ,\end{matrix}$ |
| | ${a}_{1} = 2 〈 {α}_{1} 〉 - \frac{1}{\sqrt{N}} ; {b}_{1} = 2 〈 {α}_{1} 〉 ;$ ${c}_{1} = - \frac{1}{\sqrt{N}} ; 〈 {α}_{1} 〉 = ( \frac{N - M}{N \sqrt{N}} ) , and$ |
| | $( N - M ) {a}_{1}^{2} + {Mb}_{1}^{2} + {Mc}_{1}^{2} = 1$ |
| 5 | Measurement: Measure the first n qubits, to obtain the desired |
| | solution after the iteration |
| | $\begin{matrix}1. with probability {P}_{s}^{( 1 )} to find a match out \\ of the M possible matches as follows :\end{matrix}$ |
| | ${P}_{s}^{( 1 )} = M ( {b}_{1}^{2} + {c}_{1}^{2} ) = 5 r - 8 {r}^{2} + 4 {r}^{3} , r = \frac{M}{N} ;$ |
| | 2. with probability Pₙₛ to find undesired result out of the states |
| | as follows: |
| | ${P}_{ns}^{( 1 )} = ( N - M ) {a}_{1}^{2} , where {P}_{s}^{( 1 )} + {P}_{ns}^{( s )} = 1.$ |

One aspect of using the partial diffusion operator in searching is to apply the inversion about the mean operation only on the subspace of the system that includes all the states which represent the non-matches and half the number of the states which represent the matches, while the other half will have the sign of their amplitudes inverted. This inversion to the negative sign prepars them to be involved in the partial diffusion operation in the next iteration so that the amplitudes of the matching states get amplified partially in each iteration. The benefit of this is to keep half the number of the states, which represent the matches as a stock each iteration to resist the de-amplification behavior of the diffusion operation when reaching the turning points as seen when examining the performance of the modified QSA2. In step 5 of modified QSA2 applying Dₚₐᵣₜ can be understood as follows: without loss of generality, the general system

$${\sum }_{k = 0}^{P - 1} {δ}_{k} \vert k 〉 , \vert {δ}_{k} {\vert}^{2} = 1$$

can be rewritten as

$${\sum }_{k = 0}^{P - 1} {δ}_{k} \vert k 〉 = {\sum }_{j = 0}^{N - 1} {α}_{j} ( \vert j 〉 ⊗ \vert 0 〉 ) + {\sum }_{j = 0}^{N - 1} {β}_{j} ( \vert j 〉 ⊗ \vert 1 〉 ) ,$$

where [symbol] αⱼ=δₖ:k even [symbol] and [symbol] βⱼ=δₖ:k odd [symbol] , and then applying Dₚₐᵣₜ on the system gives

$$\begin{matrix}{D}_{part} ( {\sum }_{k = 0}^{P - 1} {δ}_{k} \vert k 〉 ) = [ {H}^{⊗ n + 1} ⊗ I ( 2 \vert 0 〉 〈 0 \vert - I ) {H}^{⊗ n + 1} ⊗ I ] ( {\sum }_{k = 0}^{P - 1} {δ}_{k} \vert k 〉 ) \\ = 2 [ {H}^{⊗ n + 1} ⊗ I ( 2 \vert 0 〉 〈 0 \vert ) {H}^{⊗ n + 1} ⊗ I ] ( {\sum }_{k = 0}^{P - 1} {δ}_{k} \vert k 〉 ) - ( {\sum }_{k = 0}^{P - 1} {δ}_{k} \vert k 〉 ) \\ = {\sum }_{j = 0}^{N - 1} [ 2 〈 α 〉 - {α}_{j} ] ( \vert j 〉 ⊗ \vert 0 \text{〉} \text{)} - {\sum }_{j = 0}^{N - 1} {β}_{j} ( \vert j 〉 ⊕ \vert 1 〉 ) ,\end{matrix}$$

where

$$〈 α 〉 = \frac{1}{N} {\sum }_{j = 0}^{N - 1} {α}_{i}$$

is the mean of the amplitudes of the subspace

$${\sum }_{j = 0}^{N - 1} {α}_{j} ( \vert j 〉 ⊗ \text{\textbar} 0 \text{〉} \text{)} ;$$

i.e., applying the operator Dₚₐᵣₜ will perform the version about the mean only on the subspace

$${\sum }_{j = 0}^{N - 1} {α}_{j} ( \vert j 〉 ⊗ \text{\textbar} 0 \text{〉} \text{)}$$

and will only change the sign of the amplitudes for the rest of the system as

$${\sum }_{j = 0}^{N - 1} {β}_{j} ( \vert j 〉 ⊗ \text{\textbar} 1 \text{〉} \text{)} .$$

FIG. 48 shows one embodiment of a circuit implementation using elementary gates. The probability of finding a solution varies according to the number of matches M≠0 in the superposition.

Consider the performance of the modified QSA1 and QSA2 after iterating the algorithm once. Table 6.1 shows the results of probability calculations. The maximum probability is always 1, and minimum probability (worst case) decreases as the size of the list increases, which is expected for small M≠0 because the number of states will increase, and the probability is distributed over more states, while the average probability increases as the size of the list increases.

TABLE 6.1
Algorithm performance with different size search space

| n, N = 2ⁿ | Max probability | Min probability | Average probability |
|---|---|---|---|
| 2 | 1 | 0.8125 | 0.875 |
| 3 | 1 | 0.507812 | 0.93750 |
| 4 | 1 | 0.282227 | 0.96875 |
| 5 | 1 | 0.148560 | 0.984375 |
| 6 | 1 | 0.076187 | 0.992187 |

In the measurement process in step 6 of QSA1, for the first iteration,

$$\begin{matrix}{P}_{s 1}^{( 1 )} = M ( {a}_{1}^{2} + {b}_{1}^{2} ) \\ = \frac{M}{2 N} ( 10 - 16 ( \frac{M}{N} ) + 8 {( \frac{M}{N} )}^{2} ) \\ = 5 r - 8 {r}^{2} + 4 {r}^{3} , r \\ = \frac{M}{N} .\end{matrix}$$

The above equation implies that the average performance of the algorithm to find a solution increases as the size of the list increases. Taking into account that the oracle U_{f} is taken as a black, box, one can define the average probability of success average(Pₛ) of the algorithm as follows:

$$\begin{matrix}average ( {P}_{s} ) = \frac{1}{{2}^{N}} {\sum }_{M = 1}^{N} {}_{}^{N}{C}{}_{M}^{} {P}_{s} = \frac{1}{{2}^{N}} {\sum }_{M = 1}^{N} \frac{N !}{M ! ( N - M ) !} \cdot M ( {a}^{2} + {b}^{2} ) \\ = \frac{1}{{2}^{N + 1} {N}^{3}} {\sum }_{M = 1}^{N} \frac{N !}{( M - 1 ) ! ( N - M ) !} \cdot \\ ( 10 {N}^{2} - 16 MN + 8 {M}^{2} ) = 1 - \frac{1}{2 N} .\end{matrix}$$

$$where$$

$${}_{}^{N}{C}{}_{M}^{} = \frac{N !}{M ! ( N - M ) !}$$

is the number of possible cases for M matches. As the size of the list increases (N→∞), average (Pₛ) tends to 1.

For QSA2 in step 5, the following relations hold:

$$\begin{matrix}average ( {P}_{s 2}^{( 1 )} ) = \frac{1}{{2}^{N}} {\sum }_{M = 1}^{N} {}_{}^{N}{C}{}_{M}^{} {P}_{s} = \frac{1}{{2}^{N}} {\sum }_{M = 1}^{N} \frac{N !}{M ! ( N - M ) !} \cdot M ( {b}_{1}^{2} + {c}_{1}^{2} ) \\ = \frac{1}{{2}^{N + 1} {N}^{3}} {\sum }_{M = 1}^{N} \frac{N !}{( M - 1 ) ! ( N - M ) !} \cdot \\ ( 10 {N}^{2} - 16 MN + 8 {M}^{2} ) = 1 - \frac{1}{2 N}\end{matrix}$$

$$where$$

$${}_{}^{N}{C}{}_{M}^{} = \frac{N !}{M ! ( N - M ) !}$$

is the number of possible cases for M matches. As the size of the list increases (N→∞), average (Pₛ) for both QSA ½ tends to 1.

Classically, one can try to find a random guess of the item, which represents the solution (one trial guess), and succeed to find a solution with probability

$${P}_{s}^{( Classical )} = \frac{M}{N} .$$

The average probability can be calculated as follows:

$$\begin{matrix}average ( {P}_{s}^{( Classical )} ) = \frac{1}{{2}^{N}} {{\sum }^{N}}_{M = 1}^{N} {C}_{M} {P}_{s}^{( Classical )} \\ = \frac{1}{{2}^{N}} {\sum }_{M = 1}^{N} \frac{M \cdot N}{M ! ( N - M ) !} \\ = \frac{1}{2} .\end{matrix}$$

This means that there is an average probability of one-half to find (or not to find) a solution by a single random guess, even with the increase in the number of matches.

Grover's QSA has an average probability one-half after an arbitrary number of iterations. The probability of success of Grover's QSA after l iterations is given by:

$${P}_{s}^{( Gr [ l ] )} = {sin}^{2} ( ( 2 l + 1 ) θ ) , where 0 < θ < \frac{π}{2} and sin θ = \sqrt{\frac{M}{N}} .$$

The average probability of success of Grover's QSA after an arbitrary number of iteration can be calculated as follows:

$$\begin{matrix}average ( {P}_{s}^{( Gr [ l ] )} ) = \frac{1}{{2}^{N}} {{\sum }^{N}}_{M = 1}^{N} {C}_{M} {sin}^{2} ( ( 2 l + 1 ) θ ) \\ = \frac{1}{2} .\end{matrix}$$

FIG. 49 shows the probability of success of the three algorithms as a function of the ratio

$$r = \frac{M}{N}$$

for the first iteration of Grover's QSA. FIG. 49 shows that the probability of success of the modified QSA1 is always above that of the classical guess technique. Grover's QSA solves the case where

$$M = \frac{N}{4}$$

with certainty, and the modified QSA1 solves the case where

$$M = \frac{N}{2}$$

with certainty. The probability of success of Grover's QSA will start to go below one-half for

$$M > \frac{N}{2} ,$$

while the probability of success of the modified QSA1 will stay more reliable with a probability of at least 92.6%.

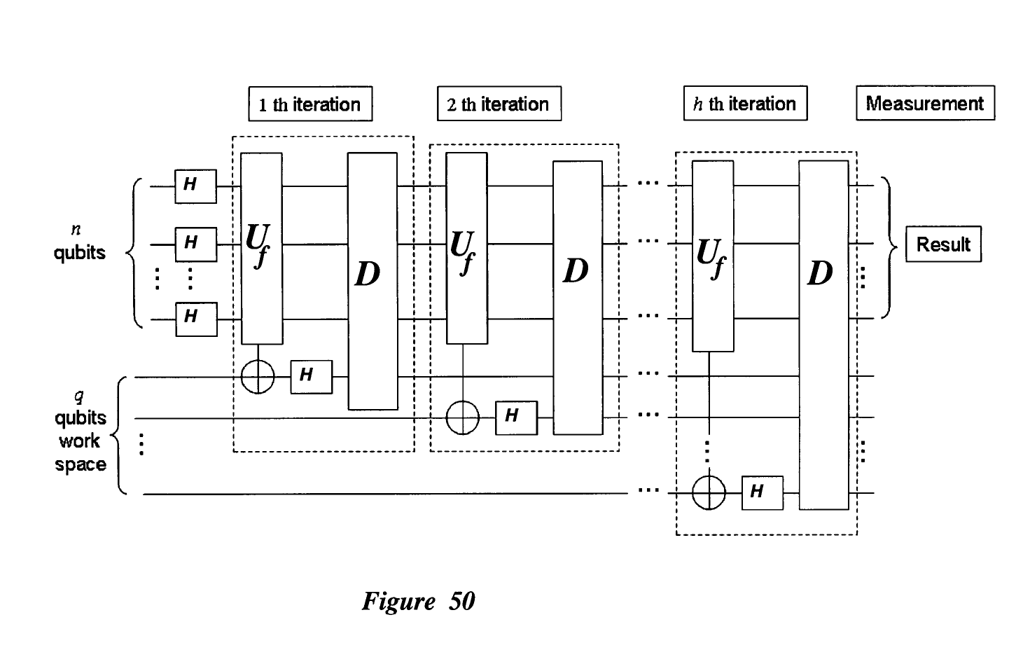

FIG. 50 shows the iterating version of the algorithm QSA1 that works as follows:

| Step | Computational algorithm |
|---|---|
| 1 | Initialize the whole n + 1 qubits system to the state \|0>. |
| 2 | (i) Apply Hadamard gate on each of the first n qubits in parallel. |
| 3 | Iterate the following, for iteration k: |
| | Apply the oracle U_{f} taking the first n qubits as control qubits |
| | and the k th qubit workspace as the target qubit exclusively |
| | (ii) Apply Hadamard gate on the k th qubit workspace |
| | (iii) Apply diffusion operator on the whole n + k qubit system |
| | inclusively |
| 4 | Apply measurement on the first n qubits |

The second iteration modifies the system as follows:

| Step | Results after second QSA1-iteration |
|---|---|
| 1 | Append second qubit workspace to the system: |
| | $\begin{matrix}\vert {W}_{1}^{( 2 )} 〉 = {b}_{0}^{( 1 )} {{\sum }_{i = 0}^{N - 1}}_{1} ( \vert i 〉 ⊗ \vert 0 〉 ) ⊗ \vert 0 〉 + {a}_{0}^{( 1 )} {{\sum }_{i = 0}^{N - 1}}_{1} ( \vert i 〉 ⊗ \vert 1 〉 ) ⊗ \vert 0 〉 + \\ {b}_{0}^{( 1 )} {{\sum }_{i = 0}^{N - 1}}_{2} ( \vert i 〉 ⊗ \vert 0 〉 ) ⊗ \vert 0 〉 + {b}_{0}^{( 1 )} {{\sum }_{i = 0}^{N - 1}}_{2} ( \vert i 〉 ⊗ \vert 1 〉 ) ⊗ \vert 0 〉\end{matrix}$ |
| 2 | Apply U_{f} as shown in Step 3-(i) of QSA1: |
| | $\begin{matrix}\vert {W}_{2}^{( 2 )} 〉 = {b}_{0}^{( 1 )} {{\sum }_{i = 0}^{N - 1}}_{1} ( \vert i 〉 ⊗ \vert 0 〉 ) ⊗ \vert 1 〉 + {a}_{0}^{( 1 )} {{\sum }_{i = 0}^{N - 1}}_{1} ( \vert i 〉 ⊗ \vert 1 〉 ) ⊗ \vert 1 〉 + \\ {b}_{0}^{( 1 )} {{\sum }_{i = 0}^{N - 1}}_{2} ( \vert i 〉 ⊗ \vert 0 〉 ) ⊗ \vert 0 〉 + {b}_{0}^{( 1 )} {{\sum }_{i = 0}^{N - 1}}_{2} ( \vert i 〉 ⊗ \vert 1 〉 ) ⊗ \vert 0 〉\end{matrix}$ |
| 3 | $Apply Hadamard gate on second qubit workspace ( {I}^{⊗ n + 1} ⊗ H ) :$ |
| | $\begin{matrix}\vert {W}_{3}^{( 2 )} 〉 = \\ \frac{1}{\sqrt{2}} {b}_{0}^{( 1 )} {{\sum }_{i = 0}^{N - 1}}_{1} ( \vert i 〉 ⊗ \vert 0 〉 ) ⊗ \vert 1 〉 - \frac{1}{\sqrt{2}} {b}_{0}^{( 1 )} {{\sum }_{i = 0}^{N - 1}}_{1} ( \vert i 〉 ⊗ \vert 0 〉 ) ⊗ \vert 1 〉 + \\ \frac{1}{\sqrt{2}} {a}_{0}^{( 1 )} {{\sum }_{i = 0}^{N - 1}}_{1} ( \vert i 〉 ⊗ \vert 1 〉 ) ⊗ \vert 0 〉 - \frac{1}{\sqrt{2}} {a}_{0}^{( 1 )} {{\sum }_{i = 0}^{N - 1}}_{1} ( \vert i 〉 ⊗ \vert 1 〉 ) ⊗ \vert 1 〉 + \\ \frac{1}{\sqrt{2}} {b}_{0}^{( 1 )} {{\sum }_{i = 0}^{N - 1}}_{2} ( \vert i 〉 ⊗ \vert 0 〉 ) ⊗ \vert 0 〉 + \frac{1}{\sqrt{2}} {b}_{0}^{( 1 )} {{\sum }_{i = 0}^{N - 1}}_{2} ( \vert i 〉 ⊗ \vert 0 〉 ) ⊗ \vert 1 〉 + \\ \frac{1}{\sqrt{2}} {b}_{0}^{( 1 )} {{\sum }_{i = 0}^{N - 1}}_{2} ( \vert i 〉 ⊗ \vert 1 〉 ) ⊗ \vert 0 〉 + \frac{1}{\sqrt{2}} {b}_{0}^{( 1 )} {{\sum }_{i = 0}^{N - 1}}_{2} ( \vert i 〉 ⊗ \vert 1 〉 ) ⊗ \vert 1 〉\end{matrix}$ |
| 4. | Apply diffusion operator as shown in Step 3-(iii) of QSA1: |
| | $\begin{matrix}\vert {W}_{4}^{( 2 )} 〉 = {b}_{0}^{( 2 )} {{\sum }_{i = 0}^{N - 1}}_{1} ( \vert i 〉 ⊗ \vert 0 〉 ) ⊗ \vert 0 〉 + {b}_{1}^{( 2 )} {{\sum }_{i = 0}^{N - 1}}_{1} ( \vert i 〉 ⊗ \vert 0 〉 ) ⊗ \vert 1 〉 + \\ {a}_{0}^{( 2 )} {{\sum }_{i = 0}^{N - 1}}_{1} ( \vert i 〉 ⊗ \vert 1 〉 ) ⊗ \vert 0 〉 + {a}_{0}^{( 2 )} {{\sum }_{i = 0}^{N - 1}}_{1} ( \vert i 〉 ⊗ \vert 1 〉 ) ⊗ \vert 1 〉 + \\ {b}_{0}^{( 2 )} {{\sum }_{i = 0}^{N - 1}}_{2} ( \vert i 〉 ⊗ \vert 0 〉 ) ⊗ \vert 0 〉 + {b}_{0}^{( 2 )} {{\sum }_{i = 0}^{N - 1}}_{2} ( \vert i 〉 ⊗ \vert 0 〉 ) ⊗ \vert 1 〉 + \\ {b}_{0}^{( 1 )} {{\sum }_{i = 0}^{N - 1}}_{2} ( \vert i 〉 ⊗ \vert 1 〉 ) ⊗ \vert 0 〉 + {b}_{0}^{( 2 )} {{\sum }_{i = 0}^{N - 1}}_{2} ( \vert i 〉 ⊗ \vert 1 〉 ) ⊗ \vert 1 〉\end{matrix}$ |

Where the mean of the amplitudes to be used in the diffusion operator is calculated as follows:

$$〈 {α}_{2} 〉 = \frac{1}{{2}^{n + 2}} [ ( {2}^{n + 2} - 4 M ) \frac{{b}_{0}^{( 1 )}}{\sqrt{2}} ] = \frac{{b}_{0}^{( 1 )}}{\sqrt{2}} ( 1 - 4 M ) .$$

To clear ambiguity, a and b used in the above section for first iteration are denoted as a₀⁽¹⁾ and b₀⁽¹⁾ respectively, where the superscript index denotes the iteration and subscript index is used to distinguish amplitudes.

The new amplitudes a₀⁽²⁾, a₁⁽²⁾ b₀⁽²⁾, b₁⁽²⁾ are calculated as follows:

$${a}_{0}^{( 2 )} = 2 〈 {α}_{2} 〉 - \frac{1}{\sqrt{2}} {a}_{0}^{( 1 )} ; {a}_{1}^{( 2 )} = 2 〈 {α}_{2} 〉 + \frac{1}{\sqrt{2}} {a}_{0}^{( 1 )}$$

$${b}_{0}^{( 2 )} = 2 〈 {α}_{2} 〉 - \frac{1}{\sqrt{2}} {b}_{0}^{( 1 )} ; {b}_{1}^{( 2 )} = 2 〈 {α}_{2} 〉 + \frac{1}{\sqrt{2}} {b}_{0}^{( 1 )} .$$

The probability of success is: Pₛ⁽²⁾=M[(a₀⁽²⁾)²+(a₁⁽²⁾)²+(b₀⁽²⁾)²+(b₁⁽²⁾)²].

In general, after e iterations, the recurrent relations representing the iteration can be written as follows: for the initial conditions

$${a}_{0}^{( 0 )} = {b}_{0}^{( 0 )} = \frac{1}{\sqrt{N}} ,$$

1. The mean to be used in the diffusion operator is:

$$〈 {α}_{2} 〉 = \frac{{b}_{0}^{( l - 1 )}}{\sqrt{2}} ( 1 - 4 M ) ; l \geq 1$$
2. The new amplitudes of the system are:

$${a}_{0}^{( 1 )} = 2 〈 {α}_{2} 〉 + \frac{1}{\sqrt{2}} {a}_{0}^{( 0 )} ; {a}_{0 -> {2}^{l - 1} - 1}^{( 2 )} = 2 〈 {α}_{l} 〉 ∓ \frac{1}{\sqrt{2}} {a}_{0 -> {2}^{l - 2} - 1}^{( l - 1 )} ; l \geq 2$$

$${b}_{0}^{( 1 )} = 2 〈 {α}_{2} 〉 - \frac{1}{\sqrt{2}} {b}_{0}^{( 0 )} ; {b}_{0 -> {2}^{l - 1} - 1}^{( 2 )} = 2 〈 {α}_{l} 〉 ∓ \frac{1}{\sqrt{2}} {b}_{0 -> {2}^{l - 2} - 1}^{( l - 1 )} ; l \geq 2$$
3. The probability of success for l≧2 is:
Pₛ^{(l)}=M[(aᵢ^{(l)})²+(bᵢ^{(l)})²];i=0,1,2, . . . ,2⁻¹−1
or, using mathematical induction, the probability of success can take the following form:

$${P}_{s}^{( l )} = ( \frac{M}{N} - 1 ) {( 1 - \frac{M}{N} )}^{2 l} + 1 , l \geq 1.$$

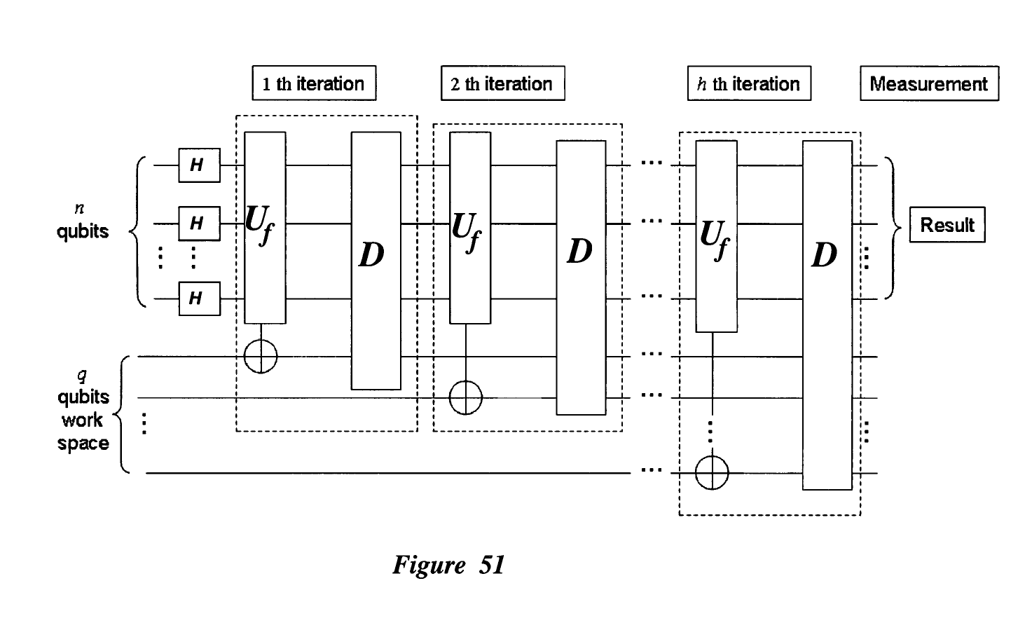

FIG. 51 shows the iterating version of the QSA2 algorithm. The iterating block applies the oracle U_{f} and the operator Dₚₐᵣₜ on the system in sequence. Consider the system after the first iteration, a second iteration modifies the system as follows:

| Step | Results after second QSA2-iteration |
|---|---|
| 1 | Apply the oracle U1 will swap the amplitudes of the states which |
| | represent only the matches; i.e., states with amplitudes b₁ will be |
| | with amplitudes c₁, and states with amplitudes c₁ will be with |
| | amplitudes b₁, so the system can be described as: |
| | $\vert {W}_{4} 〉 = {a}_{1} {{\sum }_{i = 0}^{N - 1}}_{2} ( \vert i 〉 ⊗ \vert 0 〉 ) + {c}_{1} {{\sum }_{i = 0}^{N - 1}}_{1} ( \vert i 〉 ⊗ \vert 0 〉 ) + {b}_{1} {{\sum }_{i = 0}^{N - 1}}_{1} ( \vert i 〉 ⊗ \vert 1 〉 )$ |
| 2 | Applying the operator Dₚₐᵣₜ will change the system as follows: |
| | $\vert {W}_{5} 〉 = {a}_{2} {{\sum }_{i = 0}^{N - 1}}_{2} ( \vert i 〉 ⊗ \vert 0 〉 ) + {b}_{2} {{\sum }_{i = 0}^{N - 1}}_{1} ( \vert i 〉 ⊗ \vert 0 〉 ) + {c}_{2} {{\sum }_{i = 0}^{N - 1}}_{1} ( \vert i 〉 ⊗ \vert 1 〉 ) ,$ |
| | where the mean used in the definition of partial diffusion operator |
| | Dₚₐᵣₜ is: a: |
| | $〈 {α}_{2} 〉 = \frac{1}{N} [ ( N - M ) {a}_{1} + {Mc}_{1} ]$ |
| | and a₂, b₂, c₂ used in this Step 2 of the second iteration are |
| | calculated as follows: |
| | ${a}_{2} = 2 〈 {α}_{2} 〉 - {a}_{1} ; {b}_{2} = 2 〈 {α}_{2} 〉 - {c}_{1} ; {c}_{2} = - {b}_{1}$ |

And for the third iteration

| Step | Results after third QSA2-iteration |
|---|---|
| 1 | Apply the oracle U_{f} will swap the amplitudes of the states which |
| | represent only the matches as: |
| | $\begin{matrix}{U}_{f} \vert {W}_{5} 〉 = \vert {W}_{6} 〉 = {a}_{2} {{\sum }_{i = 0}^{N - 1}}_{2} ( \vert i 〉 ⊗ \vert 0 〉 ) + {c}_{2} {{\sum }_{i = 0}^{N - 1}}_{1} ( \vert i 〉 ⊗ \vert 0 〉 ) + \\ {b}_{2} {{\sum }_{i = 0}^{N - 1}}_{1} ( \vert i 〉 ⊗ \vert 1 〉 )\end{matrix}$ |
| 2 | Applying the operator Dₚₐᵣₜ will change the system as follows: |
| | $\begin{matrix}{D}_{part } \vert {W}_{6} 〉 = \vert {W}_{7} 〉 = {a}_{3} {{\sum }_{i = 0}^{N - 1}}_{2} ( \vert i 〉 ⊗ \vert 0 〉 ) + {b}_{3} {{\sum }_{i = 0}^{N - 1}}_{1} ( \vert i 〉 ⊗ \vert 0 〉 ) + \\ {c}_{3} {{\sum }_{i = 0}^{N - 1}}_{1} ( \vert i 〉 ⊗ \vert 1 〉 ) ,\end{matrix}$ |
| | where the mean used in the definition of partial diffusion operator |
| | Dₚₐᵣₜ is as: |
| | $〈 {α}_{3} 〉 = \frac{1}{N} [ ( N - M ) {a}_{2} + {Mc}_{2} ] ,$ |
| | and a₃, b₃, c₃ in this Step 2 of the third iteration are calculated as |
| | follows: |
| | ${a}_{3} = 2 〈 {α}_{3} 〉 - {a}_{2} ; {b}_{3} = 2 〈 {α}_{3} 〉 - {c}_{2} ; {c}_{3} = - {b}_{2}$ |

In general, the system of QSA2 after l≧2 iterations can be described using the following recurrence relations:

$$\vert {W}^{( l )} \text{〉} = {a}_{l} {{\sum }_{2}}_{i = 0}^{N - 1} ( \vert i \text{〉} ⊗ \vert 0 \text{〉} ) + {b}_{l} {{\sum }_{1}}_{i = 0}^{N - 1} ( \vert i \text{〉} ⊗ \vert 0 \text{〉} ) + {c}_{l} {{\sum }_{1}}_{i = 0}^{N - 1} ( \vert i \text{〉} ⊗ \vert 1 \text{〉} ) ,$$

where the mean to be used in the definition of the partial diffusion operator Dₚₐᵣₜ is as follows:

$$〈 {α}_{l} 〉 = [ {ya}_{l - 1} + ( 1 - y ) {c}_{l - 1} ] , y = 1 - r , r - \frac{M}{N} , \\ and {a}_{l} = s ( {F}_{l} - {F}_{l - 1} ) , {b}_{l} = {sF}_{l} , {c}_{l} = - {sF}_{l - 1} and {F}_{l} ( y ) = \frac{sin ( [ l + 1 ] θ )}{sin ( θ )} , s = \frac{1}{\sqrt{N}} ,$$

where Fₗ(y) is the Chebyshev polynomials of the second kind.

The probabilities of the system are:

$${P}_{s}^{( l )} = ( 1 - cos ( θ ) ) [ {F}_{l}^{2} + {F}_{l - 1}^{2} ] , {P}_{n s}^{( l )} = {cos ( θ ) [ {F}_{l} - {F}_{l - 1} ]}^{2} , y = cos ( θ ) , 0 \leq θ \leq \frac{π}{2} ,$$

such that Pₛ^{(l)}+Pₙₛ^{(l)}=1.

It is instructive to calculate how many iterations, l, are required to find the matches with certainty or near certainty for different cases of 1≦M≦N. To find a match with certainty on any measurement, then Pₛ^{(l)} must be as close as possible to certainty.

For interations of the algorithm QSA1, consider the following cases using equation

$${P}_{s}^{( l )} = ( \frac{M}{N} - 1 ) {( 1 - \frac{M}{N} )}^{2 l} + 1 , l \geq 1.$$

The number of iterations W in terms of the ratio

$$r = \frac{M}{N}$$

is represented using Taylor's expansion as follows:

$$l \geq \frac{{P}_{S}^{( l )} - r}{4 r ( 1 - r )} , \\ r = \frac{M}{N} .$$

The cases where multiple instances of a match exist within the search space are listed as follows:

| | |
|---|---|
| 1 | $\begin{matrix}The case where M = \frac{1}{2} N : The algorithm can find a solution \\ with certainty after arbitrary number of iterations \\ ( one iteration is enough )\end{matrix}$ |
| 2 | $\begin{matrix}The case where M > \frac{1}{2} N : The probability of success is , \\ for instance , at least 92.6 \% after the first iteration , 95.9 \% after \\ second iteration , and 97.2 \% after third iteration\end{matrix}$ |
| 3 | $\begin{matrix}For iterating the algorithm once ( ℓ = 1 ) and to get a probability \\ of at least one \text{-} half , so , M must satisfy the condition M > \frac{1}{8} N\end{matrix}$ |

For the case where l≧1, the following conditions must be satisfied: n≧4 and

$$1 \leq M \leq \frac{1}{8} N .$$

This means that the first iteration will cover approximately 87.5% of the problem with a probability of at least one-half; two iterations will cover approximately 91.84% and three iterations will cover 94.2%. The rate of increase of the coverage range will decrease as the number of iterations increases.

For the algorithm QSA2 to find a match with certainty on any measurement, then Pₛ^{(l)} must be as close as possible to certainty. In this case, consider the following relation: Pₛ^{(l)}=1=(1−cos(θ))[Fₗ²+Fₗ₋₁²],

$$y = cos ( θ ) , 0 \leq θ \leq \frac{π}{2} . \\ Then , l = \frac{π - θ}{ 2 θ} or θ = \frac{π}{ 2} .$$

Using this result, and since the number of iterations must be an integer, then the required number of iterations is

$$l = ⌊ \frac{π}{2 \sqrt{2}} \sqrt{\frac{N}{M}} ⌋ ,$$

where └ ┘ is the floor operation. The algorithm runs in

$$O ( \sqrt{\frac{N}{M}} ) .$$

The probability of success of Grover's QSA is as follows: P_{S}^{(l-Gr)}=sin²[(2l_{Gr}+1)θ], where

$${sin}^{2} ( θ ) = \frac{M}{N} ; 0 \leq θ \leq \frac{π}{2}$$

and the required l_{Gr} is

$${l}_{Gr} = ⌊ \frac{π}{4} \sqrt{\frac{N}{M}} ⌋ .$$

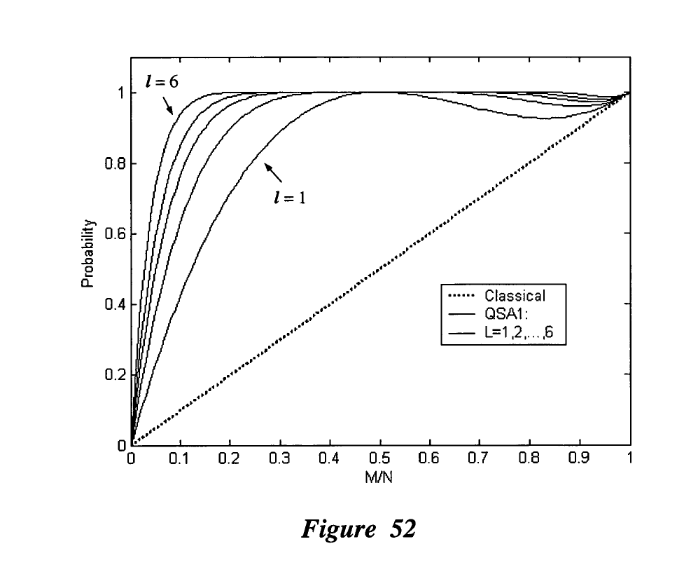

FIG. 52 shows the probability of success of the iterative version of the algorithm QSA1 where l=1, 2, . . . , 6. This algorithm needs

$$O ( \frac{N}{M} )$$

iterations for n≧4 and

$$1 \leq M \leq \frac{1}{8} N ,$$

which is similar to classical algorithms behavior. This leads to the conclusion that the first few iterations of the algorithm will provide the best performance and that there will be no substantial gain from continuing to iterate the algorithm.

By contrast, Grover's QSA needs

$$O ( \sqrt{\frac{N}{M}} )$$

to solve the problem, but its performance decreases for

$$M \geq \frac{1}{2} N .$$

Thus, for the case when the number of solutions M is known in advance, for

$$1 \leq M \leq \frac{1}{8} N ,$$

one can use Grover's QSA with

$$O ( \sqrt{\frac{N}{M}} ) ;$$

and if

$$\frac{1}{8} N \leq M \leq N$$

use QSA1 with O(1).

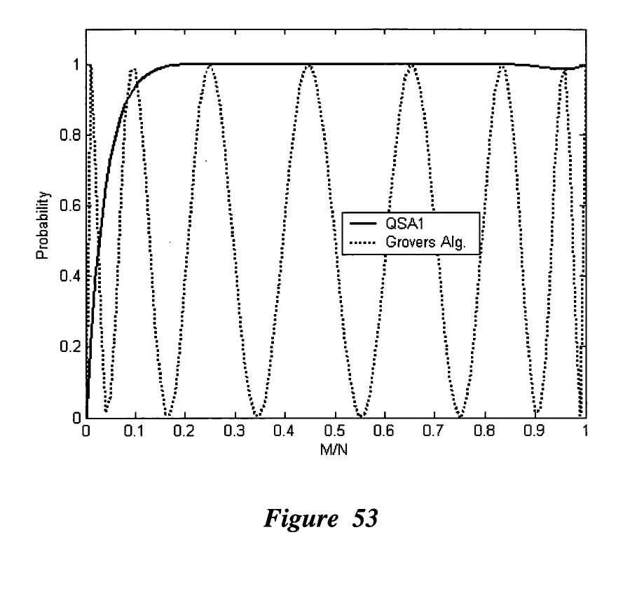

FIG. 53 shows that Grover's QSA is faster in the case of fewer instances of the solution

$$( ratio r = \frac{M}{N} is small )$$

and the algorithm QSA1 is more stable and reliable in case of multiple instances of the solution.

Thus, Grover's QSA performs well in the case of fewer instances of the solution, and the performance decreases as the number of solutions increase within the search space; the algorithm QSA1 in general performs better than any pure classical or QSA and still has O\sqrt{N} for the hardest case and approximately O(1) for

$$M \geq \frac{1}{8} N .$$

For QSA2, the probability of success is as follows:

$$\begin{matrix}{P}_{s}^{( l )} = ( 1 - cos ( θ ) ) [ {F}_{l}^{2} + {F}_{l - 1}^{2} ] , {F}_{l} ( y ) \\ = \frac{sin ( [ l + 1 ] θ )}{sin ( θ )} ,\end{matrix}$$

$$and$$

$$\begin{matrix}{P}_{s}^{( l )} = ( 1 - cos ( θ ) ) [ {F}_{l}^{2} + {F}_{l - 1}^{2} ] \\ = ( 1 - cos ( θ ) ) [ \frac{{sin}^{2} ( [ l + 1 ] θ ) + {sin}^{2} ( l θ )}{{sin}^{2} ( θ )} ] ,\end{matrix}$$

where

$$cos ( θ ) = 1 - \frac{M}{N} ; 0 \leq θ \leq \frac{π}{2}$$

and the required l is

$$l = ⌊ \frac{π}{2 \sqrt{2}} \sqrt{\frac{N}{M}} ⌋ .$$

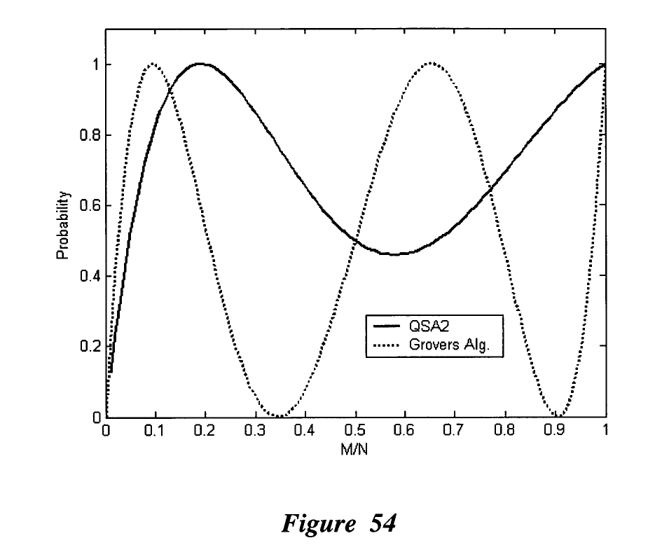

FIG. 54 shows the probability of success as a function of the ratio

$$r = \frac{M}{N}$$

for both algorithms. For QSA2 the probability will never return to zero once started, and the minimum probability will increase as M increases because of the use of the partial diffusion operator Dₚₐᵣₜ, which will resist the de-amplification when reaching the turning points as explained in the definition of the partial diffusion operator Dₚₐᵣₜ; i.e., the problem becomes easier for multiple matches, whereas for Grover's QSA, the number of cases (points) to be solved with certainty is equal to the number of cases with zero-probability after arbitrary number of iterations.

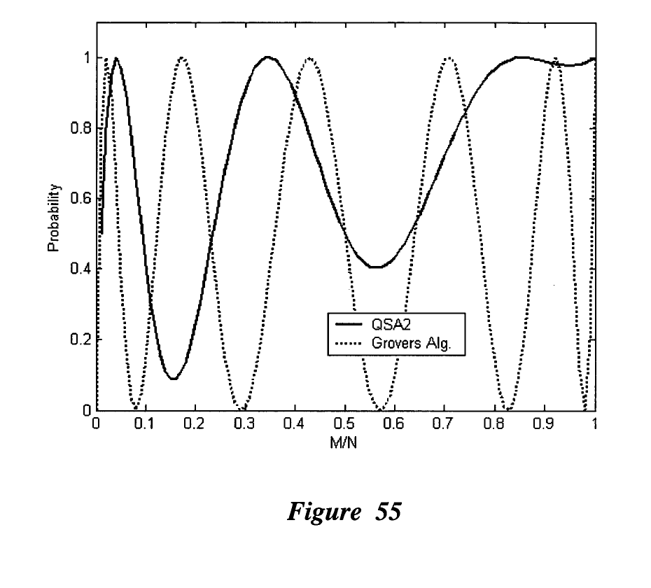

FIG. 55 shows the probability of success as a function of the ratio

$$r = \frac{M}{N}$$

for both algorithms by inserting the calculated number of iterations l_{Gr} and l in P_{S}^{(l-Gr)} and P_{S}^{(l)}, respectively. The minimum probability that Grover's QSA can reach is approximately 17.5% when

$$r = \frac{M}{N} = 0.617 ,$$

while for QSA2, the minimum probability is 87.7% when

$$r = \frac{M}{N} = 0.31 .$$

The behavior of QSA2 is similar in this case to the behavior of this algorithm of the first iteration shown in FIG. 55 for

$$r = \frac{M}{N} > 0.31 ,$$

which implies that if

$$r = \frac{M}{N} > 0.31 ,$$

then QSA2 runs in O(1), i.e.; the problem is easier for multiple matches.

Thus, using modifications in the quantum operators of Grover's QSA structure, both QSA1 and QSA2, based on QAG-approach, perform more reliably than Grover's QSA in the case of fewer matches (e.g., relatively hard cases) and runs in O(1) in the case of multiple matches (e.g., relatively easy cases).

6.2. Modification of the Superposition Operator in Grover's QSA: Wavelet QSA with Partial Information.

Before applying of Grover's QSA, a bisection between a database and quantum states is necessary. If a superposition of N states is initially prepared, the Grover's QSA amplifies the amplitude of the target state up to around one, while those of other states dwindle down to nearly zero. The amplitude amplification is perfomed by two inversion operations: inversion about the target by the oracle and inversion about the initial state by the Fourier transform. Two simultaneous reflections about two mirrors crossing by an angle α induces a 2α rotation. One can imagine that the inversion in the Grover's QSA rotates the initial state around the target state. If the target state and initial state are denoted by |w> and |ψ>, respectively (here the initial state is prepared by the Fourier transform of a state |k>, i.e.; |ψ>=(FT)|k>), the inversion operators are expressed as O_{|w>}=I−2|w><w|,J_{|w>}=I−2|ψ><ψ|. Since J_{|w>}=(FT)J_{|k>}(FT)^{†},the Grover operator is written as G=(FT)J_{|k>}(FT)^{†}O_{|w>}.Then, after applying the operator O(\sqrt{N}) times, the final state comes to |ψ_{fin}>=G^{O(\sqrt{N})}(FT)|k>. The probability to obtain the target state is Pr(w)=|<w||ψ_{fin}>>|², which is 1−ε², ε□1. The query complexity of this QSA, the number of callings of the oracle, is therefore O(\sqrt{N}). The running time has nothing to do with the choice of |k>.

When partial information is given in an unstructed database, one can replace the Fourier transform in Grover's QSA with the Haar wavelet transform. In this case, if a partial information L is given to an unstructed database of size N, then there is an improved speed-up of

$$O ( \sqrt{\frac{N}{L}} ) .$$

Grover's QSA cannot benefit from the partial information. The fast wavelet WQSA, which is a modification of Grover's QSA can solve this problem by replacing the Fourier transform with the Haar wavelet transform.

The state W^{†}|2^{λ-1}+j> is a superposition of

$$\frac{N}{L}$$

states, where L=2^{λ-1} (λ is given by k) is the partial information about an initial state, while the state (FT)|k> is a superposition of N states. Since the operator is composed of wavelet transforms, the initial state is prepared by applying the inverse wavelet transform W^{†} to a state |k>. The initial state is now |ψ>=W^{†}|k>. The power of the WQSA appears in the initialization procedure.

The Haar wavelet transform W is represented by the sequence of sparse matrices W=WₙWₙ₋₁ . . . W₁, where

$${W}_{k} = [ \begin{matrix}{H}_{{2}^{n - k + 1}} & {O}_{{2}^{n - k + 1} \times ( {2}^{n} - {2}^{n - k + 1} )} \\ {O}_{( {2}^{ n} - {2}^{ n - k + 1} ) \times {2}^{n - k + 1}} & {I}_{{2}^{n} - {2}^{n - k + 1}}\end{matrix} ] , \\ and$$

$${H}_{{2}^{n}} = {[ \begin{matrix}1 & 1 & 0 & 0 & ⋯ & 0 \\ 0 & 0 & 1 & 1 & 0 & ⋮ \\ ⋮ & ⋮ & & ⋰ & 0 & 0 \\ 0 & 0 & ⋯ & 0 & 1 & 1 \\ 1 & - 1 & 0 & 0 & ⋯ & 0 \\ 0 & 0 & 1 & - 1 & 0 & \\ ⋮ & ⋮ & & ⋰ & 0 & 0 \\ 0 & 0 & ⋯ & 0 & 1 & - 1\end{matrix} ]}_{{2}^{k} \times {2}^{k}} ,$$

where H₂_{ⁿ} is the Haar 1-level decomposition operator, Iₙ is used as the n×n unit matrix, and O_{n,m} as n×m zero matrix. The wavelet transform W is unitary, since the operator H₂_{ⁿ} is unitary.

One of ordinary skill in the art will recognize that other wavelet transforms can be applied to the WQSA. The Haar wavelet transform is described by sparse matrix, and it is observed that the first half of the Haar wavelet basis differs from the second half of the wavelet basis by the phase exp [symbol] iπ [symbol] . This implies that the destructive and constructive interference between states accepts a set of states containing the target and rejects the other states.

In this sense, other known wavelet bases, e.g., Daubechies's, the discrete Hartle transform as

$${A}_{N} = ( \frac{1 - i}{2} ) {( FT )}_{N} + ( \frac{1 + i}{2} ) {( FT )}_{N}^{3}$$

or the fractional discrete Fourier transform as an α-th root of (FT)_{N} is

$${F}_{N , α} = {a}_{0} ( α ) \cdot {1}_{N} + … + {a}_{3} ( α ) \cdot {( FT )}_{N}^{3} , \\ {a}_{0} ( α ) = \frac{1}{2} ( 1 + {ⅇ}^{ⅈ α} ) cos α , {a}_{1} ( α ) = \frac{1}{2} ( 1 - {ⅈⅇ}^{ⅈα} ) sin α , \\ {a}_{2} ( α ) = \frac{1}{2} ( - 1 + {ⅇ}^{ⅈα} ) cos α , {a}_{3} ( α ) = \frac{1}{2} ( - 1 - {ⅈⅇ}^{ⅈα} ) sin α$$

are not appropriate to play the role of selecting a subset of the N states.

The operator G^{(W)}=−W^{†}J_{|k>}WO_{|W>} is one iteration of the WQSA. The expected runing time is

$$O ( \sqrt{\frac{N}{L}} ) .$$

For example, consider the problem of finding a desired one in the set A= [symbol] |a>|a=1,2,3, . . . ,2ⁿ⁻¹ [symbol] . Given a partial information that the target state is in the subset A_{λ}^{j}= [symbol] |z>|(j−1)2^{n-λ}≦z≦j2^{n-λ}−1,1<j≦2^{λ} [symbol] , one can complete the search task in O(\sqrt{2^{n-λ+1}}) times by choosing the initial state as W^{†}|2^{λ-1}+j>. Only the λ-number is correctly labeled. The partial information may save this problem. Thus, the power of WQSA appears in the initialization procedure.

Consider the case of partial information about k as k≠0,1. Choosing the initial state as |ψ>=W^{†}|k>, k≠0,1 when the target state exists in the restricted domain of the

$$\frac{N}{L}$$

states gives an improved speed-up with the partial information.

Since kε [symbol] 2,3,4, . . . ,N(=2ⁿ)−1 [symbol] , by setting k=2^{λ-1}+j,1≦j≦2^{λ} and λ≧1, and

$${N}_{1} = \frac{N}{L} = {2}^{n - λ + 1} ,$$

the initial state |ψ>=W^{†}|k>, k≠0,1 is explicitly,

$${W}^{†} \vert k 〉 = {\sum }_{α = ( j - 1 ) {N}_{1}}^{( j - 1 ) {N}_{1} + \frac{{N}_{1}}{{N}_{2}} - 1} \vert α 〉 - {\sum }_{β = ( j - 1 ) {N}_{1} + \frac{{N}_{1}}{{N}_{2}}}^{{jN}_{1} - 1} \vert β 〉 .$$

Let the target state be |w>εA_{λ}^{j} and the initial state be W^{†}|2^{λ-1}+j>.It suffices to show that it takes O(\sqrt{2^{n-λ+1}}) times for the WQSA to find the target state with the following setting.

Let

$${N}_{1} = \frac{N}{L} = {2}^{n - λ + 1}$$

and the wavelet search operator is G^{(W)}=−W^{†}J_{|k>}WO_{|w>}, where W^{†} is the Haar wavelet transform.

| Step | Computational wavelet algorithm |
|---|---|
| 1 | $Applying the operator {W}^{†} to the \vert k 〉 , gives the initial state$ |
| | $\vert ψ 〉 = {W}^{†} \vert k 〉 = {\sum }_{α = ( j - 1 ) {N}_{1}}^{( j - 1 ) {N}_{1} + \frac{{N}_{1}}{2} - 1} \vert α 〉 - {\sum }_{β = ( j - 1 ) {N}_{1} + \frac{{N}_{1}}{2}}^{{jN}_{1} - 1} \vert β 〉 ,$ |
| | $\begin{matrix}which can be written as follows : \vert ψ 〉 = \\ \frac{{ɛ}_{w}}{\sqrt{{N}_{1}}} \vert w 〉 + {ɛ}_{r} \sqrt{\frac{{N}_{1} - 1}{{N}_{1}}} \vert r 〉 , where\end{matrix}$ |
| | $\begin{matrix}{ɛ}_{i} ε \{ \pm 1 \} and the state \vert r 〉 = \\ \sqrt{\frac{1}{{N}_{1} - 1}} {\sum }_{γ \neq w} {ɛ}_{γ} \vert γ 〉 is orthogonal complement of the target state .\end{matrix}$ |
| 2 | $\begin{matrix}The m iterations of the operator {G}^{( W )} = - {W}^{†} {J}_{\vert k 〉} {WO}_{\vert w 〉} create the \\ following state \text{:} \vert {ψ}_{m} 〉 = {G}_{m}^{( W )} \vert ψ 〉\end{matrix}$ |
| 3 | The probability to obtain the target state after the m iterations is |
| | ${P}_{m} = {\vert 〈 w \vert {ψ}_{m} 〉}^{2} = {cos}^{2} ( m θ - φ ) ,$ |
| | $where θ = {sin}^{- 1} ( 2 {ɛ}_{w} {ɛ}_{r} \frac{\sqrt{{N}_{1} - 1}}{{N}_{1}} ) and φ = {cos}^{- 1} ( \frac{{ɛ}_{w}}{{N}_{1}} ) .$ |

Thus, the total number of iterations is O(\sqrt{2^{n-λ+1}}). If we denote N=2ⁿ and L=2^{λ-1}, then the running time is written as

$$O ( \sqrt{\frac{N}{L}} ) .$$

The partial information that the λ-th number j is correctly labeled leads to the application of the WQSA so that the reference section is filled in time. However, note that there is no improvement in running time when the initial state is W^{†}|0> or W^{†}|1), since, in this case, the initial state is still a superposition of N states. Therefore, from the proposition, one can complete the submission in time if the λ is larger than 2.

The described construction provides a way for a quantum search to benefit from partial information. Since the running time of the Grover's QSA has nothing to do with the choice of the unitary operator, the complexity of the WQSA is the same as the Grover QSA. However, the speed-up obtained from the WQSA is

$$O ( \sqrt{\frac{N}{L}} )$$

and is obtained by preparing the initial state as follows: |ψ>=W^{†}|k>. The running time of the WQSA depends on the choice of k, while that the Grover's QSA does not. This is because the state |ψ>=W^{†}|k> is a superposition of states in the restricted domain of

$$\frac{N}{L}$$

states. Therefore, given a partial information L to a unstructured database of size N, there is an improved speed-up of

$$O ( \sqrt{\frac{N}{L}} ) .$$

7. Comparison of Different QA Simulation Approaches

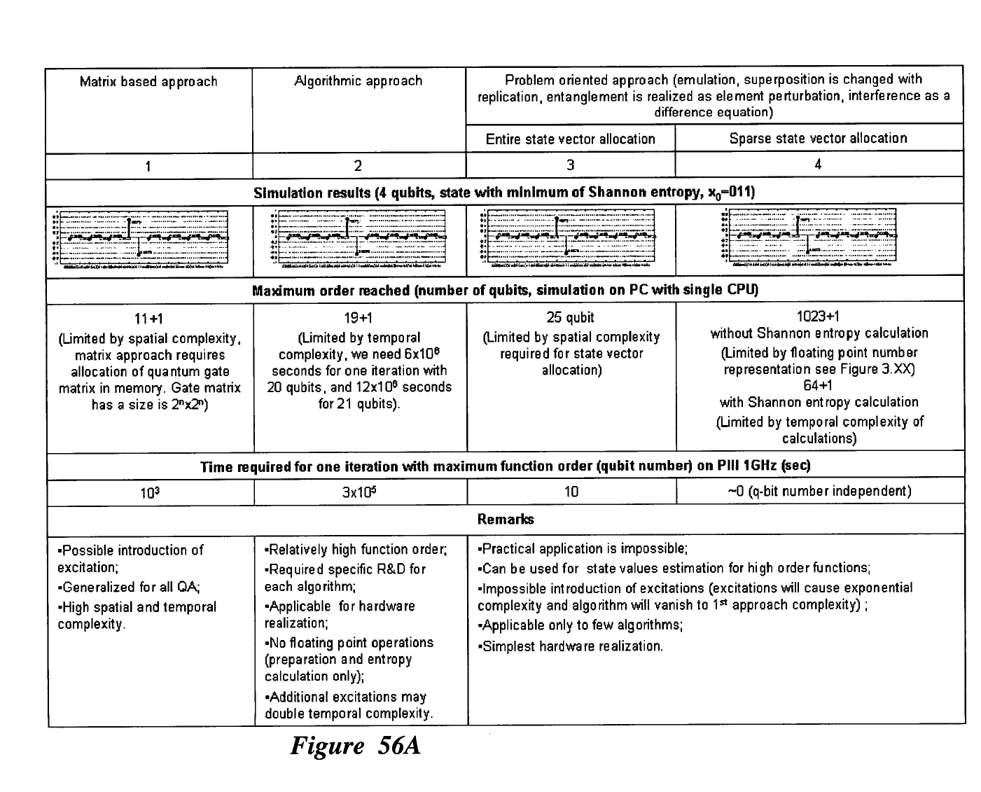

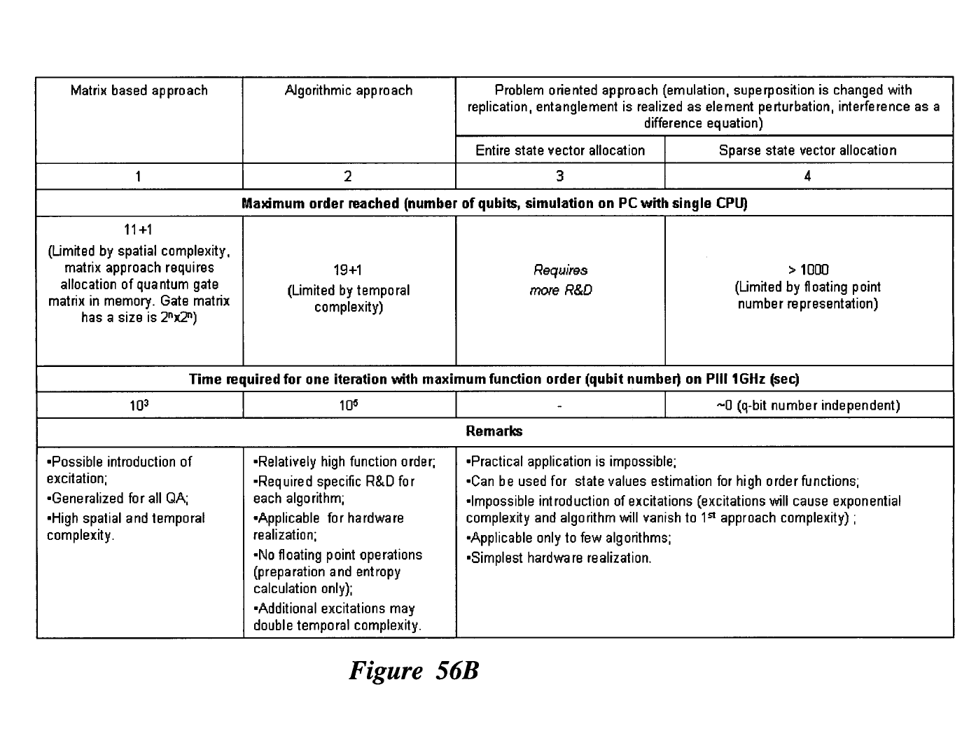

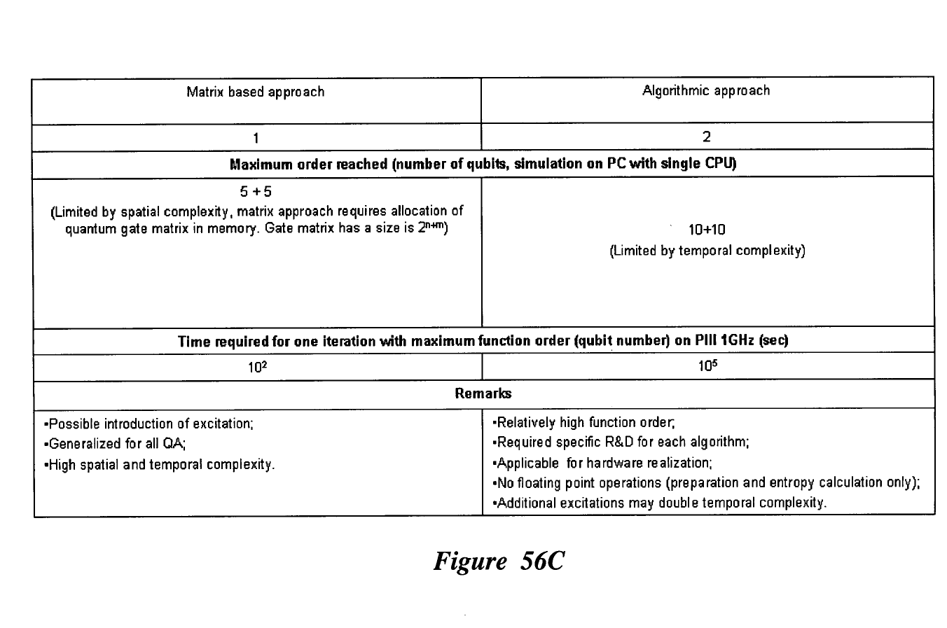

FIG. 56 shows comparison of the developed approaches of QA simulation. In case of Grover's QSA FIG. 56a, shows results from four simulation methods. It is clear that simulation results according with each method are same, but temporal complexity and size of the data base may vary depending on the approach. Direct matrix based approach is more simple, but the qubit number is limited to 12 qubits, since operator matrices are allocated in PC memory. The second approach with algorithmic replacement of the quantum gates permits an increase in the degree of the analyzed function (number of qubits) up to 20 or more. The problem-oriented approach permits quantum gate applications operating directly with the state vector. This permits an exponential decrease in the number of multiplications, and as a result, allows running of Grover's algorithm on a PC. With this approach, it is possible to allocate in PC memory a state vector containing 25-26 qubits. An extreme version of the Grover's QSA is an approach when the state vector is allocated as a sparse matrix, taking in consideration that with an absence of decoherence, most of the values of the probability amplitudes are equal, and as a result there is no need to store of all of the state vector, but only the different parts, which is equal to number of the searched elements +1. Thus, excluding memory limitations, one can simulate up to 1024 qubits or more, with only limitation caused by floating point number representations (with larger number of qubits, probability amplitudes after superposition approach to machine zero).

In the case of Deutsch-Jozsa's algorithm simulation, FIG. 56b shows three simulation approaches. In this case, the direct matrix based approach has the same limitations as in Grover's algorithm, and a PC permits an order up to 11 qubits. With the algorithmic approach, up to 20 qubits or more qubits is possible. The problem-oriented approach with compression gives the same result as in case of Grover's algorithm.

In case of Simon and Shor's quantum algorithms, FIG. 56c shows different algorithm structure. The matrix based approach and algorithmic approach are shown. The matrix based approach permits simulation up to 10 qubits, and the algorithmic approach permits simulation up to 20 qubits, or more.

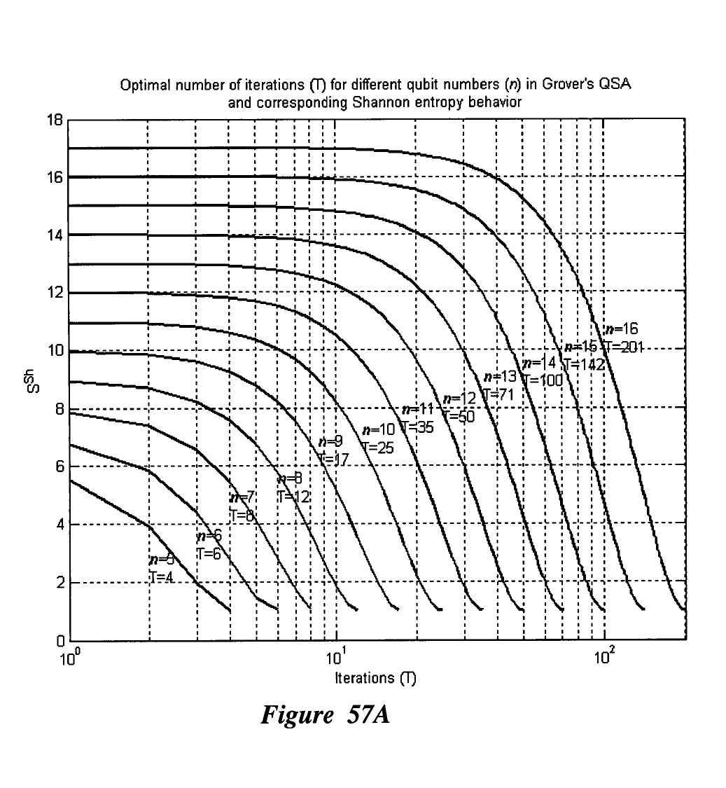

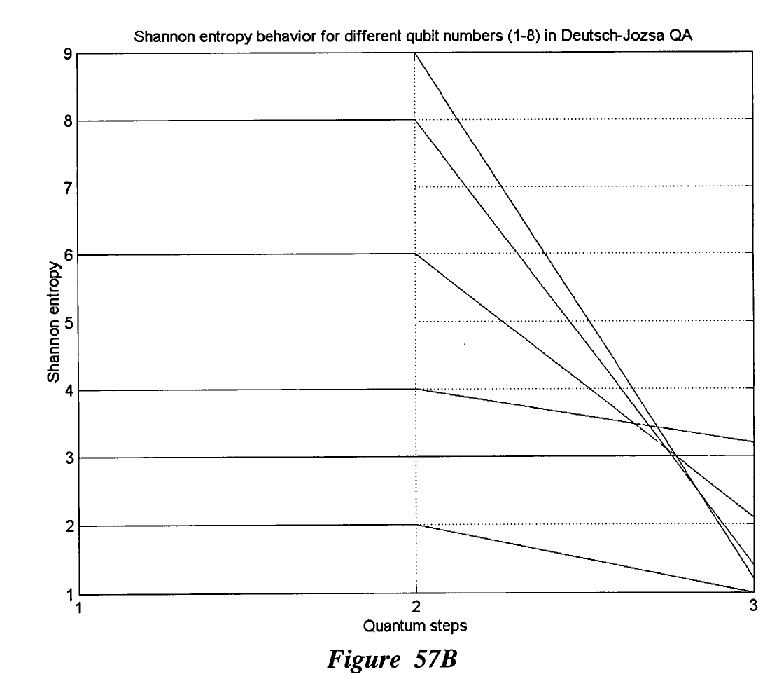

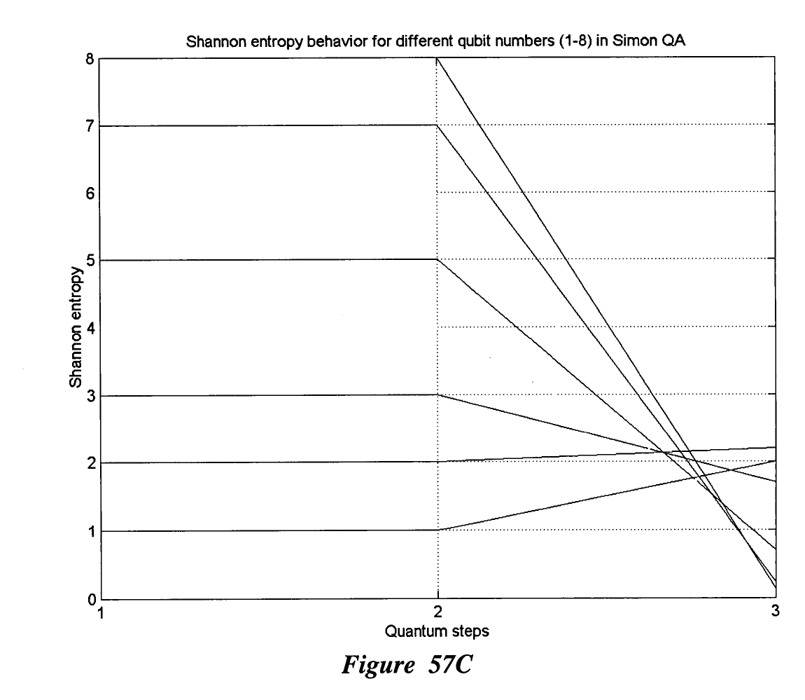

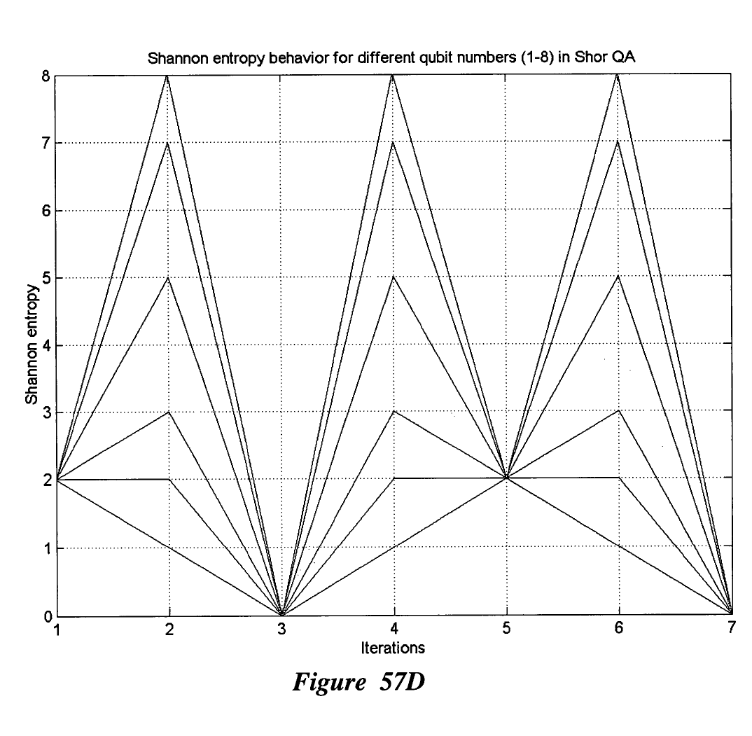

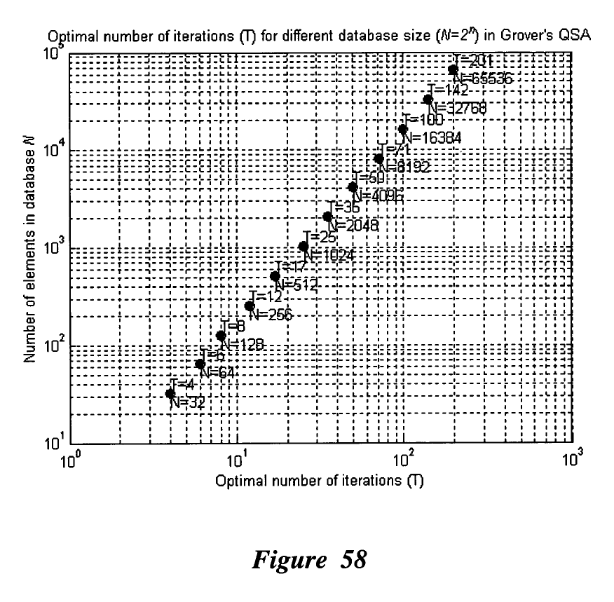

FIG. 57 shows analysis of the quantum algorithms dynamics from the Shannon information entropy viewpoint. FIG. 57a shows the relation between Shannon information entropy of the state vector of the Grover's QSA for different parameters of the data base. This analysis permits estimation of the number of algorithm iterations required for database search regarding database size. This estimation is shown in FIG. 58.

The results of Shannon entropy behavior are presented in the FIGS. 57b for Deutsch-Jozsa's algorithm, in FIG. 57c for Simon QA and in FIG. 57d for Shor's QA.

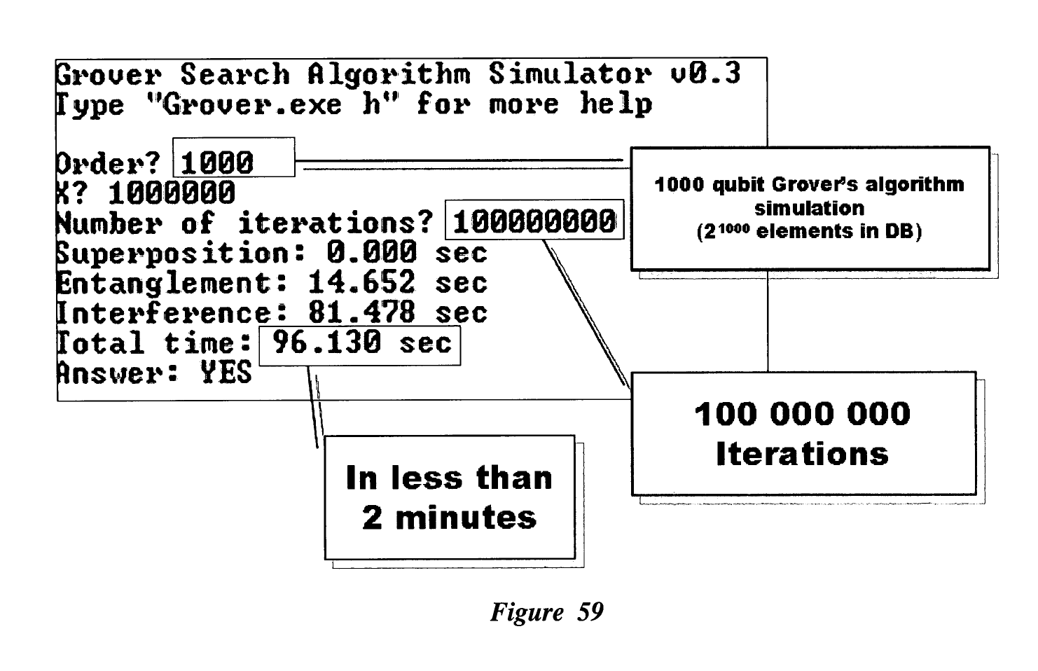

FIG. 59 shows the screen shot of the Grover's QSA problem oriented simulator with sparse allocation of the state vector. The result of the simulation for 1000 qubits is presented.

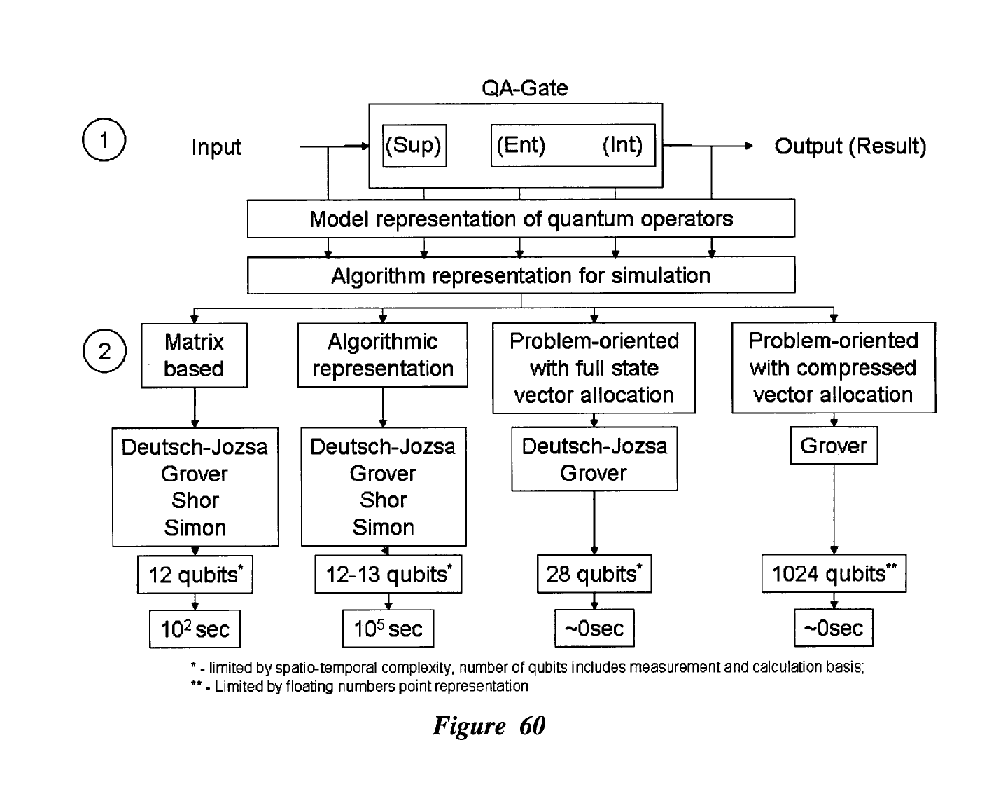

FIG. 60 summarizes the above approaches to QA simulation. The high level structure of the quantum algorithms can be represented as a combination of different superposition entanglement and interference operators. Then depending on algorithm, one can choose corresponding model and algorithm structure for simulation. Depending on the current problem, one can choose (if available) one of the simulation approaches, and depending on approach one can simulate different orders of quantum systems.

Although various embodiments have been described, other embodiments will be apparent to those of ordinary skill in the art. Thus, the present invention is limited only by the claims.

What is claimed is:

1. A method for simulating a quantum algorithm on a classical computer, comprising:
applying a unitary matrix quantum gate G to an initial vector to produce a basis vector;
measuring said basis vector, wherein elements of said quantum gate G are computed on an as-needed basis;
repeating said steps of applying and measuring k times, where k is selected to minimize Shannon entropy of said basis vector; and
decoding said basis vectors, said decoding including translating said basis vectors into an output vector.

2. The method of claim 1, wherein said quantum gate G describes an entanglement-free quantum algorithm.

3. The method of claim 1, wherein said elements of said basis vector comprise one of two pre-computed values.

4. An intelligent control system comprising a quantum search algorithm configured to minimize Shannon entropy comprising: a genetic optimizer configured to construct one or more local solutions using a fitness function configured to minimize a rate of entropy production of a controlled plant; and a quantum search algorithm configured to search said local solutions to find a global solution using a gate G expressing a fitness function configured to minimize Shannon entropy, said gate G corresponding to an entanglement-free quantum algorithm for efficient simulation, and wherein elements of said gate G are computed on an as-needed basis.

5. The intelligent control system of claim 4, wherein said global solution comprises weights for a fuzzy neural network.

6. The intelligent control system of claim 4, wherein said fuzzy neural network is configured to train a fuzzy controller, said fuzzy controller configured to provide control weights to a proportional-integral-differential controller, said proportional-integral-differential controller configured to control said controlled plant.

7. The intelligent control system of claim 4, wherein said fitness function is step-constrained.

8. The intelligent control system of claim 4, wherein each element of a state vector of said quantum search algorithm comprises one of a finite number of pre-computed values.

9. The intelligent control system of claim 4, wherein said quantum search algorithm operates on pseudo-pure states.

10. A method for global optimization to improve a quality of a sub-optimal solution comprising the steps of: selecting a first gate G corresponding to a first quantum process, modifying said first gate G into a second gate G corresponding to a second quantum process; having pseudo-pure states; applying a first transformation to an initial state to produce a coherent superposition of basis states; applying a second transformation to said coherent superposition using a reversible transformation according to said second gate G to produce coherent output states; applying a third transformation to said coherent output states to produce an interference of output states; and selecting a global solution from said interference of output states.

11. The method of claim 10, wherein said first transformation is a Hadamard rotation.

12. The method of claim 10, wherein each of said basis states is represented using qubits.

13. The method of claim 10, wherein said second transformation is a solution to Shrodinger's equation.

14. The method of claim 10, wherein said third transformation is a quantum fast Fourier transform.

15. The method of claim 10, wherein said pseudo-pure states are entanglement-free.

16. The method of claim 10, wherein said superposition of input states comprises a collection of local solutions to a global fitness function.

17. A method for terminating iterations of a quantum algorithm, comprising:
performing an interation of a quantum algorithm to produce a measurement vector;
computing a Shannon entropy of said measurement vector;
selecting a termination condition from at least one of: a first local Shannon entropy minimum, a lowest Shannon entropy within a predefined number of iterations; a predefined level of acceptable Shannon entropy; and
repeating said performing and computing until said termination condition is satisfied.

18. The method of claim 17, further comprising measuring a final output result.

19. The method of claim 17, further comprising measuring an output result at each iteration.

20. A method for intelligent control comprising a quantum search algorithm corresponding to a quantum system on entanglement-free states configured to minimize Shannon entropy comprising: optimizing one or more local solutions using a fitness function configured to minimize a rate of entropy production of a controlled plant; and searching, using a quantum search algorithm to search said local solutions to find a global solution using a fitness function to minimize Shannon entropy.

21. The method of claim 20, wherein said global solution comprises weights for a fuzzy neural network.

22. The method of claim 21 further comprising: training a fuzzy controller, providing control weights from said fuzzy controller to a proportional-integral-differential controller, and using said proportional-integral-differential controller to control said controlled plant.

23. The method of claim 20, wherein said quantum search algorithm iterates until a first local Shannon entropy minimum is found.

24. The method of claim 20, wherein said quantum search algorithm iterates until a lowest Shannon entropy is found within a predefined number of iterations.

25. A global optimizer to improve a quality of a sub-optimal solution, said optimizer comprising of a computer software loaded into a memory, said software comprising: a first module for applying a first transformation to an initial state to produce a coherent superposition of basis states; a second module for applying a second transformation to said coherent superposition using a reversible transformation to produce one or more entanglement-free output states; a third module for applying a third transformation to said one or more coherent output states to produce an interference of output states; and a fourth module for selecting a global solution from said interference of output states.

26. The optimizer of claim 25, wherein said first transformation is a Hadamard rotation.

27. The optimizer of claim 25, wherein each of said basis states is represented using qubits.

28. The optimizer of claim 25, wherein said second transformation is based on a solution to Shrodinger's equation.

29. The optimizer of claim 25, wherein said third transformation is a quantum fast Fourier transform.

30. The optimizer of claim 25, wherein said fourth module is configured to find a maximum probability.

31. The optimizer of claim 25, wherein said superposition of input states comprises a collection of local solutions to a global fitness function.

32. The optimizer of claim 25, wherein elements of a quantum gate are computed on an as-needed basis.

33. The optimizer of claim 25, wherein a state vector describing said output states is stored in a compressed format.
